(19) United States
(12) Patent Application Publication
(10) Pub. No.: US 2023/0075884 A1
(43) Pub. Date: Mar. 9, 2023

(54) Systems and Methods for Token Management in Social Media Environments

(71) Applicant: Artema Labs, Inc, Los Angeles, CA (US)

(72) Inventors: Bjorn Markus Jakobsson, Portola Valley, CA (US); Stephen C. Gerber, Austin, TX (US); Ajay Kapur, Valencia, CA (US); Rebecca Anne Fiebrink, London (GB); Sven Stefan Dufva, Stockholm (SE); Keir Finlow-Bates, Eura (FI)

(73) Assignee: Artema Labs, Inc, Los Angeles, CA (US)

(21) Appl. No.: 17/929,988

(22) Filed: Sep. 6, 2022

Related U.S. Application Data
(60) Provisional application No. 63/318,125, filed on Mar. 9, 2022.
(60) Provisional application No. 63/304,759, filed on Jan. 31, 2022.
(60) Provisional application No. 63/291,376, filed on Dec. 18, 2021.
(60) Provisional application No. 63/277,718, filed on Nov. 10, 2021.
(60) Provisional application No. 63/241,032, filed on Sep. 6, 2021.

(51) Int. Cl. G06Q 20/36; H04L 9/32

(52) U.S. Cl. CPC G06Q 20/3678; H04L 9/3213; G06Q 50/01

(57) ABSTRACT

Systems and techniques to enable token-related functionality within social media platforms are illustrated. One embodiment include a method for accessing tokens. The method derives characteristics of one or more tokens owned by a first account on a platform. The method reviews one or more external accounts on the platform for compatible tokens that share at least one of the characteristics. The method confirms a compatible token is owned by a second account of the one or more external accounts. The method accesses the compatible token.

### CROSS-REFERENCE TO RELATED APPLICATIONS

The current application claims the benefit of and priority under 35 U.S.C. § 119(e) to U.S. Provisional Patent Application No. 63/241,032 titled “Token Interaction using Social Network Communication” filed Sep. 6, 2021, U.S. Provisional Patent Application No. 63/277,718 titled “Intelligent Social Media Content Creation with Feedback Loop” filed Nov. 10, 2021, U.S. Provisional Patent Application No. 63/291,376 titled “Mechanisms for Social Media Integration of Non-Fungible Tokens Content” filed Dec. 18, 2021, U.S. Provisional Patent Application No. 63/304,759 titled “Al-Guided Content Style Feedback” filed Jan. 31, 2022, and U.S. Provisional Patent Application No. 63/318,125 titled “Influencer-based NFT Promotion and Economics” filed Mar. 9, 2022, the disclosures of which are hereby incorporated by reference in their entireties for all purposes.

### FIELD OF THE INVENTION

The present invention generally relates to systems and methods directed to the minting of non-fungible tokens, management of newly-created non-fungible tokens, and receipt of feedback related to consumption of non-fungible tokens. The present invention additionally relates to systems and methods directed to facilitating the application of non-fungible tokens to social media-directed environments.

### BACKGROUND

Within social media environments, posts on one platform can often show up on both competitor platforms and in other types of media, such as cable and television news. Many times, social media posts are plagiarized by others, without controlling the provenance of the content, especially the creative content and related feedback. Social media platforms would benefit from the ability to create and post provenance-controlled content. Additionally, social media platforms would benefit from an increased capacity to track and datamine likes, comments, content, and commenters across platforms.

### SUMMARY OF THE INVENTION

Systems and techniques to facilitate token-directed operations within social media platforms are illustrated. One embodiment includes a method for generating enhanced content. The method receives at least one input. The method assesses a history including at least one content element, at least one content modification descriptor, and at least one user action descriptor. The method determines at least one transformation based on the history. The method applies the at least one transformation to the at least one input, resulting in at least one output. The method generates a token, based on the at least one output. The generation is performed by at least one of minting and modification of data associated with the token.

In a further embodiment, an input includes at least one of an image, a video, an audio segment, and a text segment.

In another embodiment, an output includes at least one of an image, a video, an audio segment, and a text segment.

In another embodiment, one or more transformations is selected from the group consisting of a selection of a content element, an edit of a content element, and a generation of a content element.

In yet another embodiment, the history is stored as a set of one or more records, wherein a record includes at least one of a content element, a content modification descriptor, and a user action.

In a further embodiment the record includes a reference to an NFT.

In a further embodiment, a content descriptor is generated from a result of computational analysis of one or more inputs.

In a still further embodiment, the computational analysis of the input is a process selected from the group consisting of computer vision, machine listening, and text analysis.

In another further embodiment, a content modification descriptor is a description of a transformation.

In yet another further embodiment a user action is selected from a group consisting of a like, a dislike, and a use of content.

In another embodiment the determining is performed, at least in part, by an algorithm selected from the group consisting of an artificial intelligence (AI) algorithm, an optimization algorithm, a reinforcement learning algorithm, and a supervised learning algorithm.

In yet another embodiment, the transforming is performed at least in part using a process selected from the group consisting of an artificial intelligence (AI) method, a machine learning (ML) method, a generative adversarial network (GAN) method, a Style Transfer method, and a variational autoencoder method.

In a further embodiment, the machine learning method is selected from the group consisting of a deep neural network, a transformer, and a convolutional neural network.

In another embodiment, the at least one user action descriptor is determined for the at least one output, based on a user indication.

In a further embodiment, the user indication is received using a user interface.

In yet another embodiment, a user action descriptor is determined based on an action by one or more other users on a social media platform.

In a further embodiment, the action is selected from the group consisting of a like, a share, a follow, and a comment.

In another embodiment the token is a non-fungible token (NFT) including at least a portion of an output.

In another embodiment, at least a portion of the at least one output is conveyed to a social network.

In a further embodiment, the conveyance is performed using an application programming interface (API).

In another embodiment, the modification of data associated with the token includes an addition of content.

In a further embodiment, the addition of content is performed using a derived token.

One embodiment includes non-transitory computer-readable medium storing instructions that, when executed by a processor, are configured to cause the processor to perform operations for generating enhanced content. The processor receives at least one input. The processor assesses a history including at least one content element, at least one content modification descriptor, and at least one user action descriptor. The processor determines at least one transformation based on the history. The processor applies the at least one transformation to the at least one input, resulting in at least one output. The processor generates a token, based on the at least one output. The generation is performed by at least one of minting and modification of data associated with the token.

In a further embodiment, an input includes at least one of an image, a video, an audio segment, and a text segment.

In another embodiment, an output includes at least one of an image, a video, an audio segment, and a text segment.

In another embodiment, one or more transformations is selected from the group consisting of a selection of a content element, an edit of a content element, and a generation of a content element.

In yet another embodiment, the history is stored as a set of one or more records, wherein a record includes at least one of a content element, a content modification descriptor, and a user action.

In a further embodiment the record includes a reference to an NFT.

In a further embodiment, a content descriptor is generated from a result of computational analysis of one or more inputs.

In a still further embodiment, the computational analysis of the input is a process selected from the group consisting of computer vision, machine listening, and text analysis.

In another further embodiment, a content modification descriptor is a description of a transformation.

In yet another further embodiment a user action is selected from a group consisting of a like, a dislike, and a use of content.

In another embodiment the determining is performed, at least in part, by an algorithm selected from the group consisting of an artificial intelligence (AI) algorithm, an optimization algorithm, a reinforcement learning algorithm, and a supervised learning algorithm.

In yet another embodiment, the transforming is performed at least in part using a process selected from the group consisting of an artificial intelligence (AI) processor, a machine learning (ML) processor, a generative adversarial network (GAN) processor, a Style Transfer processor, and a variational autoencoder processor.

In a further embodiment, the machine learning processor is selected from the group consisting of a deep neural network, a transformer, and a convolutional neural network.

In another embodiment, the at least one user action descriptor is determined for the at least one output, based on a user indication.

In a further embodiment, the user indication is received using a user interface.

In yet another embodiment, a user action descriptor is determined based on an action by one or more other users on a social media platform.

In a further embodiment, the action is selected from the group consisting of a like, a share, a follow, and a comment.

In another embodiment the token is a non-fungible token (NFT) including at least a portion of an output.

In another embodiment, at least a portion of the at least one output is conveyed to a social network.

In a further embodiment, the conveyance is performed using an application programming interface (API).

In another embodiment, the modification of data associated with the token includes an addition of content.

In a further embodiment, the addition of content is performed using a derived token.

One embodiment includes a method for spawning new tokens. The method obtains a spawning request associated with an original token, wherein the original token includes one or more spawning rules. The method determines an identity of a requesting party. The method reviews the one or more spawning rules to confirm authorization to spawn new tokens. Authorization is determined based on: access rights of the requesting party; and policies of the original token. When authorization is confirmed, the method generates one or more spawned tokens from the original token. The spawned tokens have the policies of the original token; and content elements of the original token.

In a further embodiment the spawning request includes information identifying at least one of: a number indicating an amount of tokens to generate, the identity of the requesting party, and confirmation that the original token satisfies at least one condition for spawning.

In another embodiment, the spawning rules include information that is incorporated into the spawned token.

In another embodiment, the spawning request includes additional rules for generating spawned tokens; and wherein the spawning rules of the original token take precedence over the additional rules.

In still another embodiment, the spawning rules include: royalty information to be paid upon the generation of spawned tokens; and price information including at least one of: acceptable sale prices for which the spawned token may be sold; a percentage of the sale price owed to a creator of the original token; and a flat fee owed to the creator of the original token upon the sale of spawned tokens.

In another embodiment, the spawning rules include spawning information pertaining to at least one of: a maximum number of tokens that may be spawned from the original token; and a maximum number of generations of spawned tokens that may be spawned from the original token.

In still another embodiment, the original token is associated with a percentage of ownership of an item, wherein the item is at least one of a physical and a virtual object.

In a further embodiment, the spawned tokens gives their owners a right to a spawned percentage; and the spawned percentage is deducted from the percentage of the original token.

In another embodiment, the original token gives its owner a right to a percentage of a profit associated with a competition.

In yet another embodiment, the original token is associated with a lottery entry; the lottery entry includes one or more of an encrypted field and a unique identifier; and a winner of the lottery is determined based on the lottery entry.

In another embodiment, the original token is associated with a first blockchain and at least one spawned token is associated with a second blockchain.

In still yet another embodiment, the original token and the spawned tokens are NFTs.

One embodiment includes a machine-readable medium containing bytecode stored within an immutable ledger, where the bytecode encodes a spawning token. The spawning token includes one or more policies. The policies include spawning rules that indicate authorization to spawn new tokens from the spawning token. The spawning rules include spawning information pertaining to at least one of: a maximum number of tokens that may be spawned from the spawning token; and a maximum number of generations of spawned tokens that may be spawned from the spawning token. The spawning token also includes a set of access rights; and a record, including the number of spawned tokens that have been generated from the spawning token.

In a further embodiment, the spawning rules include royalty information to be paid upon the generation of spawned tokens. The spawning rules also include price information. The price information includes at least one of: acceptable sale prices for which the spawned token may be sold; a percentage of the sale price owed to a creator of the spawning token; and a flat fee owed to the creator of the spawning token upon the sale of spawned tokens. The royalty and price information is incorporated into tokens spawned from the spawning token.

In another embodiment, the spawning token is associated with one or more of: a percentage of ownership of an item, wherein the item is at least one of a physical and a virtual object; a right to a percentage of a profit associated with a competition; and a lottery entry. The lottery entry includes one or more of an encrypted field and unique identifier. A winner of the lottery is determined based on the lottery entry.

One embodiment includes a non-transitory computer-readable medium storing instructions that, when executed by a processor, are configured to cause the processor to perform operations for spawning new tokens. The processor obtains a spawning request associated with an original token, wherein the original token includes one or more spawning rules. The processor determines an identity of a requesting party. The processor reviews the one or more spawning rules to confirm authorization to spawn new tokens. Authorization is determined based on: access rights of the requesting party; and policies of the original token. When authorization is confirmed, the processor generates one or more spawned tokens from the original token. The spawned tokens have the policies of the original token; and content elements of the original token.

In a further embodiment the spawning request includes information identifying at least one of: a number indicating an amount of tokens to generate, the identity of the requesting party, and confirmation that the original token satisfies at least one condition for spawning.

In another embodiment, the spawning rules include information that is incorporated into the spawned token.

In another embodiment, the spawning request includes additional rules for generating spawned tokens; and wherein the spawning rules of the original token take precedence over the additional rules.

In still another embodiment, the spawning rules include: royalty information to be paid upon the generation of spawned tokens; and price information including at least one of: acceptable sale prices for which the spawned token may be sold; a percentage of the sale price owed to a creator of the original token; and a flat fee owed to the creator of the original token upon the sale of spawned tokens.

In another embodiment, the spawning rules include spawning information pertaining to at least one of: a maximum number of tokens that may be spawned from the original token; and a maximum number of generations of spawned tokens that may be spawned from the original token.

In still another embodiment, the original token is associated with a percentage of ownership of an item, wherein the item is at least one of a physical and a virtual object.

In another embodiment, the original token gives its owner a right to a percentage of a profit associated with a competition.

In a further embodiment, the spawned tokens gives their owners a right to a spawned percentage; and the spawned percentage is deducted from the percentage of the original token.

In yet another embodiment, the original token is associated with a lottery entry; the lottery entry includes one or more of an encrypted field and a unique identifier; and a winner of the lottery is determined based on the lottery entry.

In another embodiment, the original token is associated with a first blockchain and at least one spawned token is associated with a second blockchain.

In still yet another embodiment, the original token and the spawned tokens are NFTs.

One embodiment include a method for accessing tokens. The method derives characteristics of one or more tokens owned by a first account on a platform. The method reviews one or more external accounts on the platform for compatible tokens that share at least one of the characteristics. Compatibility indicates whether a token can decrypt input data obtained from output of another token. Obtaining input data is facilitated by the platform. The method confirms a compatible token is owned by a second account of the one or more external accounts. The compatible token is stored in an inventory associated with the second account. The method sends a request to access the compatible token. The method accesses the compatible token. Accessing the compatible token includes: receiving access rights to the inventory; and receiving token information associated with the compatible token through an output unit associated with the account.

In a further embodiment, the platform is a social media platform.

In another embodiment, the at least one token is a non-fungible token (NFT).

In another embodiment, the access is selected from the group consisting of a read access, a write access, and a transfer request of the at least one token.

In still another embodiment, the output unit is selected from the group consisting of a display and a speaker.

One embodiment includes a method for deriving content. The method obtains original content governed by a first policy. The method generates, from the original content, a derived content governed by a derived policy, wherein: a provider entity is associated with a provider policy; an owner of the first content is associated with an owner policy; and the derived policy is generated, at least in part, from the first policy, the owner policy, and the provider policy. The method provides, through the provider entity, the derived content to one or more consumers, wherein a process of providing the derived content satisfies the derived policy. The method generates a secure log entry, identifying the provision of the derived content to the one or more consumers.

In a further embodiment, the provider entity is at least one of a social media service provider and a content publisher.

In another embodiment, a non-fungible token (NFT) includes information associated with the original content.

In another embodiment, the owner policy states a royalty associated with rendering of the derived content by consumers, and wherein the royalty is paid to the owner.

In still another embodiment, the owner is a creator of the original content.

In yet another embodiment, the provider policy states a royalty associated with rendering of the derived content by consumers, and wherein the royalty is paid to the provider.

In still yet another embodiment, the derived content is at least one of a sticker and a meme; and information associated with the derived content is included, by a consumer, in a message.

In still another embodiment, the secure log is stored on at least one of a blockchain, a secure database, and a proprietary database with access control.

In another embodiment, the secure log includes at least one of an authenticated entry and an encrypted entry.

One embodiment includes a non-transitory computer-readable medium storing instructions that, when executed by a processor, are configured to cause the processor to perform operations for deriving content. The processor obtains original content governed by a first policy. The processor generates, from the original content, a derived content governed by a derived policy, wherein: a provider entity is associated with a provider policy; an owner of the first content is associated with an owner policy; and the derived policy is generated, at least in part, from the first policy, the owner policy, and the provider policy. The processor provides, through the provider entity, the derived content to one or more consumers, wherein a process of providing the derived content satisfies the derived policy. The processor generates a secure log entry, identifying the provision of the derived content to the one or more consumers.

In a further embodiment, the provider entity is at least one of a social media service provider and a content publisher.

In another embodiment, a non-fungible token (NFT) includes information associated with the original content.

In another embodiment, the owner policy states a royalty associated with rendering of the derived content by consumers, and wherein the royalty is paid to the owner.

In still another embodiment, the owner is a creator of the original content.

In yet another embodiment, the provider policy states a royalty associated with rendering of the derived content by consumers, and wherein the royalty is paid to the provider.

In still yet another embodiment, the derived content is at least one of a sticker and a meme; and information associated with the derived content is included, by a consumer, in a message.

In still another embodiment, the secure log is stored on at least one of a blockchain, a secure database, and a proprietary database with access control.

In another embodiment, the secure log includes at least one of an authenticated entry and an encrypted entry.

One embodiment includes a non-transitory computer-readable medium storing instructions that, when executed by a processor, are configured to cause the processor to perform operations for accessing tokens. The processor derives characteristics of one or more tokens owned by a first account on a platform. The processor reviews one or more external accounts on the platform for compatible tokens that share at least one of the characteristics. Compatibility indicates whether a token can decrypt input data obtained from output of another token. Obtaining input data is facilitated by the platform. The processor confirms a compatible token is owned by a second account of the one or more external accounts. The compatible token is stored in an inventory associated with the second account. The processor sends a request to access the compatible token. The processor accesses the compatible token. Accessing the compatible token includes: receiving access rights to the inventory; and receiving token information associated with the compatible token through an output unit associated with the account.

In a further embodiment, the platform is a social media platform.

In another embodiment, the at least one token is a non-fungible token (NFT).

In another embodiment, the access is selected from the group consisting of a read access, a write access, and a transfer request of the at least one token.

In still another embodiment, the output unit is selected from the group consisting of a display and a speaker.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier in accordance with several embodiments of the invention.

FIGS. 16A-16B illustrate an NFT arrangement relationship with corresponding physical content in accordance with some embodiments of the invention.

FIG. 17 illustrates a process for establishing a relationship between an NFT and corresponding physical content in accordance with a number of embodiments of the invention.

FIG. 18 depicts a conceptual diagram of a token configuration user interface in accordance with some embodiments of the invention.

FIG. 19 depicts a system to utilize policy structures, in accordance with several embodiments of the invention.

FIGS. 20A-20B illustrate example processes, through which strategies within systems operating in accordance with certain embodiments of the invention, may guide content editors to produce new artworks.

FIGS. 21A-21B illustrate example processes, through which intelligent content creation systems operating in accordance with various embodiments of the invention, can produce derivative artworks and self-update accordingly.

FIG. 22 illustrates a process by which strategies, operating in accordance with some embodiments of the invention, may employ machine learning to configure content generators.

FIG. 23A-23B conceptually illustrates an implementation of mobile device interfaces for viewing, selecting, and providing feedback on candidate artworks, in accordance with numerous embodiments of the invention.

FIG. 24 illustrates a system for NFTs spawning new additional NFTs, in accordance with various embodiments of the invention.

FIGS. 25A-25B conceptually illustrate NFT media wallet functionalities within social media mobile application systems operating in accordance with a number of embodiments of the invention.

FIG. 26 illustrates a check-out process for systems operating in accordance with several embodiments of the invention.

FIG. 27 illustrates an AI data-mining method operating in accordance with numerous embodiments of the invention.

FIG. 28 illustrates a system of identity and alias tokens alongside platforms operating in accordance with many embodiments of the invention.

FIG. 29 illustrates the import of NFT-associated content associated with marketplaces, operating in accordance with various embodiments of the invention.

FIG. 30 illustrates the derivation and usage of content in accordance with certain embodiments of the invention.

FIG. 31 conceptually illustrates a method for providing feedback to a content creator, in accordance with many embodiments of the invention.

FIG. 32 illustrates a user interface to receive NFT feedback in accordance with certain embodiments of the invention.

### DETAILED DESCRIPTION

Systems and methods for incorporating social media-directed functionalities into non-fungible token (NFT) platforms, in accordance with various embodiments of the invention, are described herein. Social media functionality may include, but is not limited to, posting, editing, and promoting tokens on social media sites; linking wallets over platforms to enable shared access to tokens; spawning new content; and auto-transmitting feedback to content creators.

NFT platforms in accordance with a number of embodiments of the invention may use intelligent content creation systems to iteratively improve the token generation process through the collection of external feedback. Systems and methods in accordance with such embodiments may be guided in the creation of new artworks through configurations that output slight variations on content. Such variations may, among other considerations, be targeted to consumer responses. NFT content may be analyzed based on attributes including (but not limited to) “personas” (i.e., output trends) that have been established by users.

Systems in accordance with various embodiments of the invention may utilize spawning functionality to create derivative NFTs. Spawning may be used to generate multiple “editions” of NFTs that reference the same assets. In accordance with a number of embodiments, spawned NFTs may be sold over marketplaces and/or social media networks. This may allow for interactions like limited edition song releases to a musician's followers and/or NFT-based lotteries. Spawned NFTs may, in some cases, spawn their own derivative NFTs, with the freedom to do so governed by rules and/or policies. Such rules may, among other features, control royalty income for the content being released and/or duplicated.

Systems configured in accordance with various embodiments of the invention may utilize functionality directed to sharing access to tokens. Specifically, transactions may facilitate shared token use through linking wallets. Shared NFT references may point to tokens representative of content like music, podcasts, video, and advertisements. The rights transferred through these transactions may be full use and/or partial rights (like read rights). In accordance with some embodiments, transactions may be facilitated through auctions.

Systems and methods operating in accordance with certain embodiments of the invention may enable the translation of items and policies over different social media networks, service providers, and marketplaces. Policies may be determined by entities including (but not limited to) the NFTs themselves, the owners, the creators, and the platforms on which the NFTs are placed.

NFT platforms in accordance with a number of embodiments of the invention may enable users to obtain NFT feedback over social media and/or NFT platforms. Systems operating over such platforms may be configured to automatically transmit feedback from target groups to content creators. Feedback may come in multiple additional forms beyond direct feedback, such as actions by people on social media, including (but not limited to) the contents of highly-shared posts. In accordance with some embodiments, machine learning and/or artificial intelligence algorithms may infer likely feedback for the benefit of creators based on comparisons to the reception of similar posts/content. While various token and wallet configurations are discussed above, reporting functionalities that can be utilized within NFT platforms in accordance with various embodiments of the invention are discussed further below.

NFT platforms in accordance with a number of embodiments of the invention may use particular digital wallet configurations to manage and classify wallet contents for use by wallet owners as well as third parties. Systems and methods in accordance with such embodiments may incorporate user configurations to represent NFTs with NFT icons and/or NFT collection icons. NFT content may be organized within digital wallet through user interface partitions in order to classify certain NFTs based on a variety of attributes as well as user preferences.

Systems in accordance with various embodiments of the invention may utilize anchor NFTs tied to individual users in order to identify digital wallet owners. Anchor NFTs may be utilized by particular organizations and/or jurisdictions to retrieve data on parties to particular transactions. Records associated with particular anchors may be encrypted in order to preserve the user privacy. Entities including (but not limited to) governing bodies may implement systems and methods in accordance with some embodiments of the invention to regulate systems surrounding token transactions.

In accordance with a number of embodiments, transactions, consumption, and access surrounding NFTs may be willfully reported to processing entities. Systems and methods in accordance with such embodiments may enable businesses to collect and analyze data associated with token use. Users may willingly agree to share information surrounding their consumption habits in exchange for free, for benefits, and/or for compensation. Alternatively or additionally, in accordance with some embodiments of the invention, particular events associated with NFT use (such as sales) may be filtered and transmitted to a variety of entities.

NFT platforms in accordance with a number of embodiments of the invention may survey the digital wallets and associated devices of individual users. Wallet and device surveys may be applied to a variety of ends including, but not limited to, determining likely responsiveness to certain methods of advertising and assessing the popular demographics for certain categories of tokens.

While various token and wallet configurations are discussed above, reporting functionalities that can be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In accordance with several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In accordance with many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In accordance with many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In accordance with many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In accordance with several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

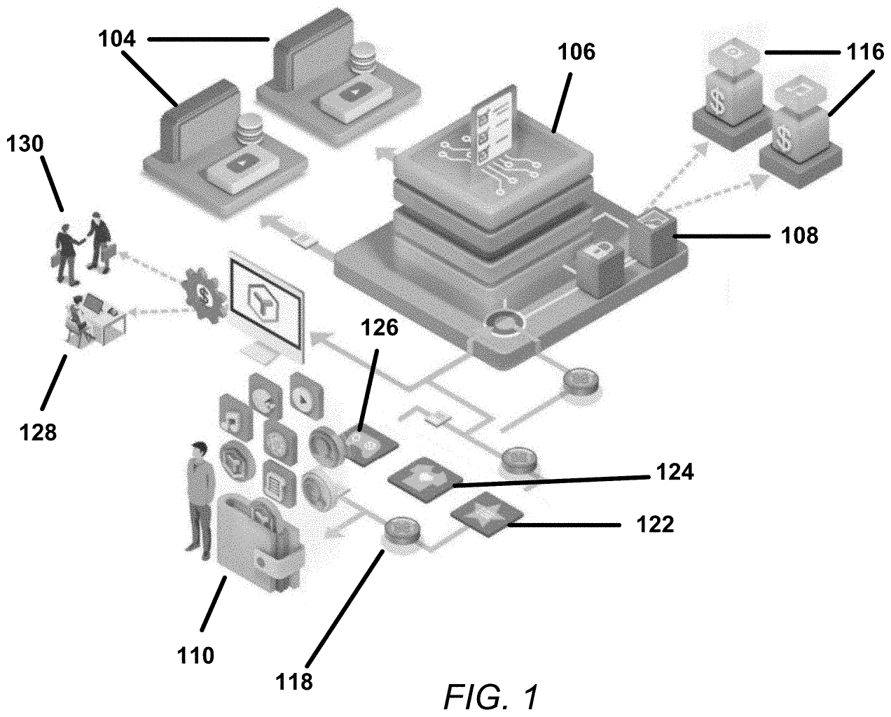

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In accordance with several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In accordance with many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In accordance with many embodiments, the verified users can be content creators that are vetted by an administrator of networks that may be responsible for deploying and maintaining the NFT blockchain. Once the NFTs are minted, users can obtain and conduct transactions with the NFTs. In accordance with several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In accordance with many embodiments, the fungible tokens can be fully converted into fiat currency and/or other cryptocurrency. In accordance with several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In accordance with several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In accordance with many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In accordance with many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the users. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When users wish to purchase NFTs using fungible tokens, media wallet applications can request authentication of the NFTs directly based upon the public key of the content creators and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In accordance with several embodiments, the public blockchain is decentralized and universally accessible. Additionally, in a number of embodiments, private/permissioned blockchains are closed systems that are limited to publicly inaccessible transactions. In accordance with many embodiments, the permissioned blockchain can be in the form of distributed ledgers, while the blockchain may alternatively be centralized in a single entity.

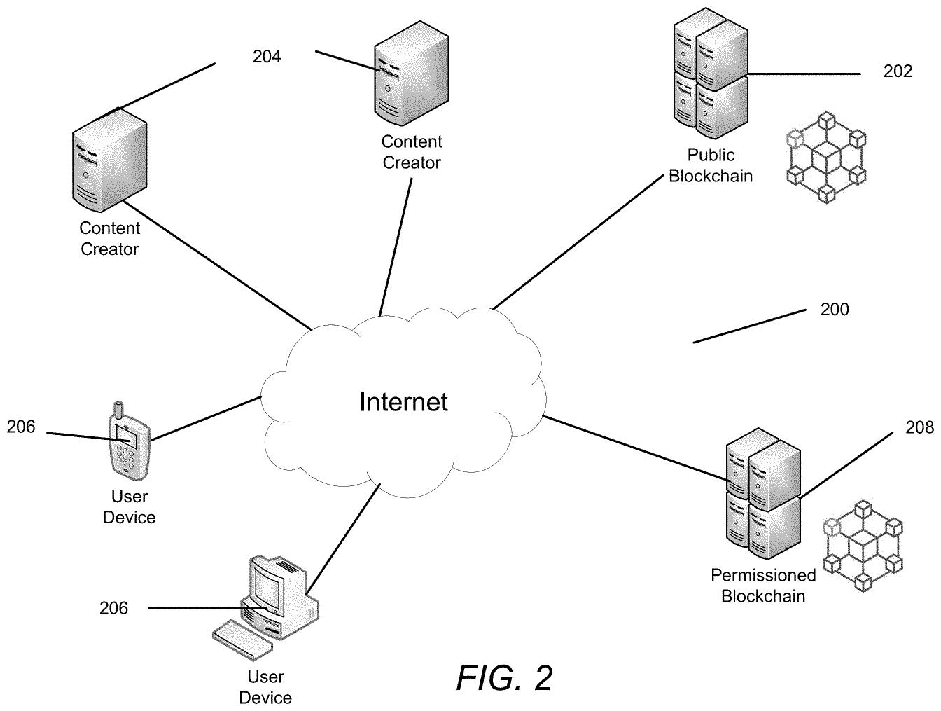

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with users based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In accordance with many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In accordance with many embodiments, NFT transaction data entries in the permissioned blockchain 208 are encrypted using users' public keys so that the NFT transaction data can be accessed by the media wallet application. In this way, users control access to entries in the permissioned blockchain 208 describing the users' NFT transactions. In accordance with several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In accordance with several embodiments, the permissioned blockchain 208 supports access control lists and users can utilize a media wallet application to modify permissions granted by way of the access control list. In accordance with many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In accordance with many embodiments, storage nodes within the permissioned blockchain 208 do not provide content creators with access to entire NFT transaction histories. Instead, the storage nodes simply provide access to encrypted records. In accordance with several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In accordance with several embodiments, the access to the data is determined by computer systems that implement permission-based data access services.

In accordance with many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In accordance with some embodiments, any of a variety of consensus mechanisms may be used by public blockchains, including (but not limited to) Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

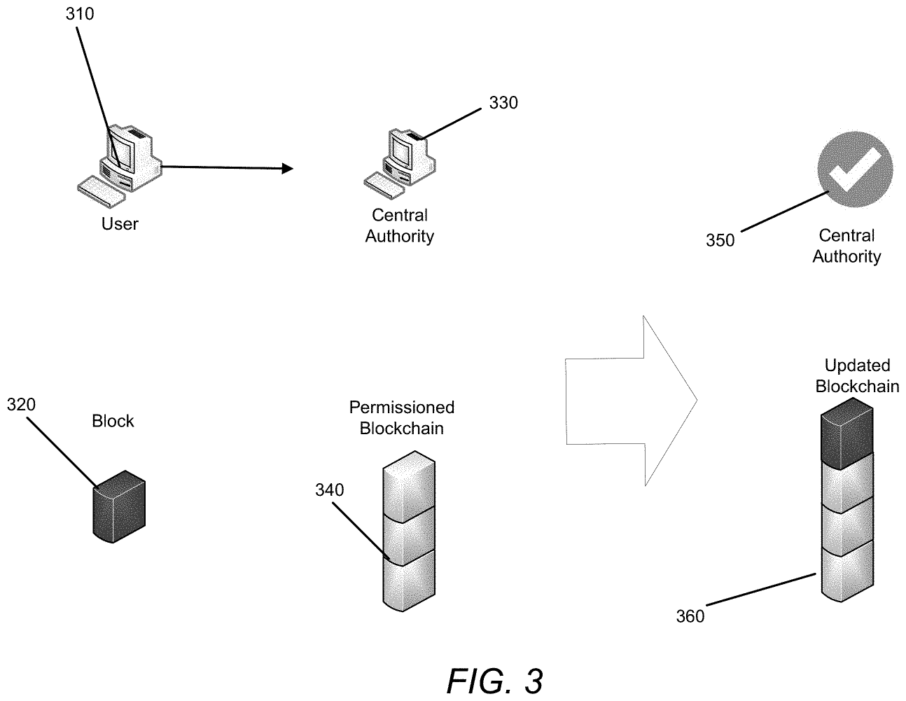

An implementation of permissioned (or private) blockchains in accordance with some embodiments of the invention is illustrated in FIG. 3. Permissioned blockchains 340 can typically function as closed computing systems in which each participant is well defined. In accordance with several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these modes. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

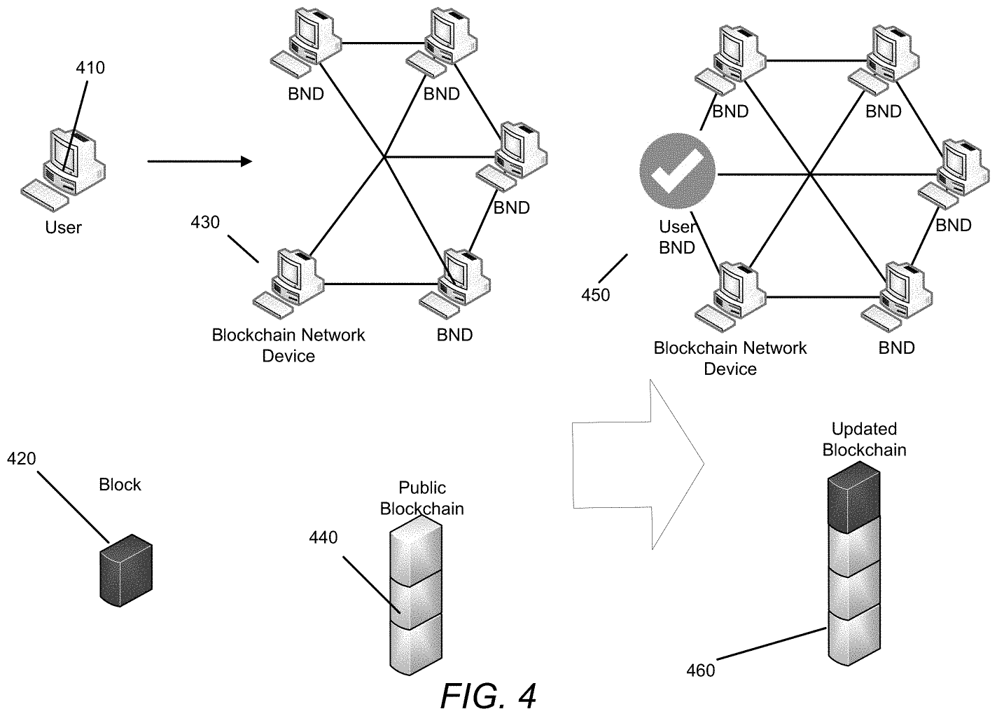

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In accordance with many decentralized blockchains, many blockchain network devices 430, in the decentralized system may have copies of the blockchain, allowing the ability to validate transactions. In accordance with many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the modes to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In accordance with many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In accordance with some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

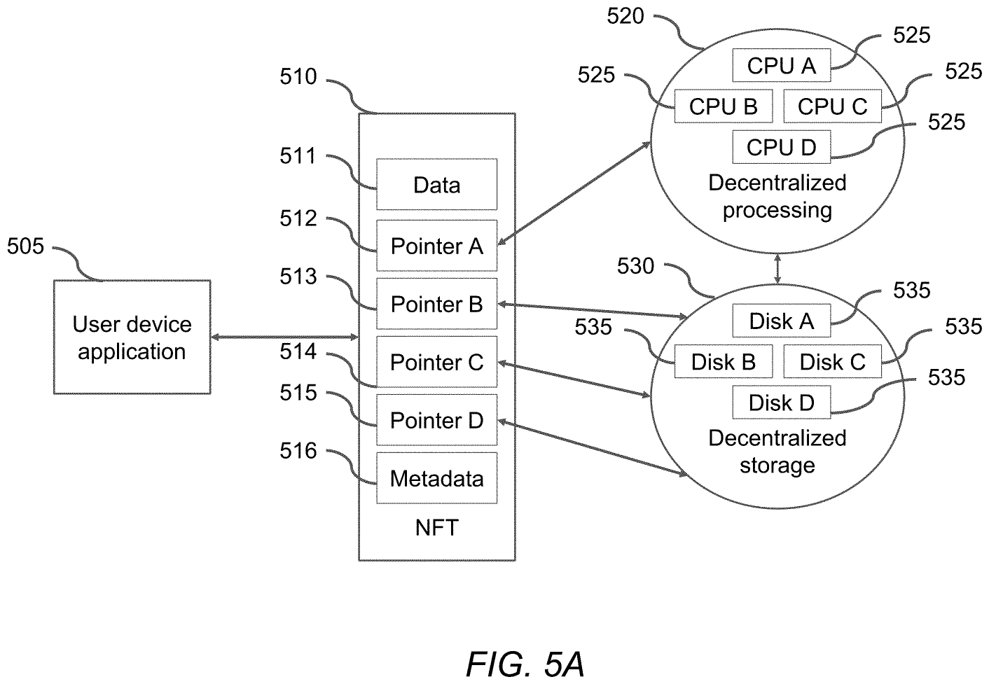

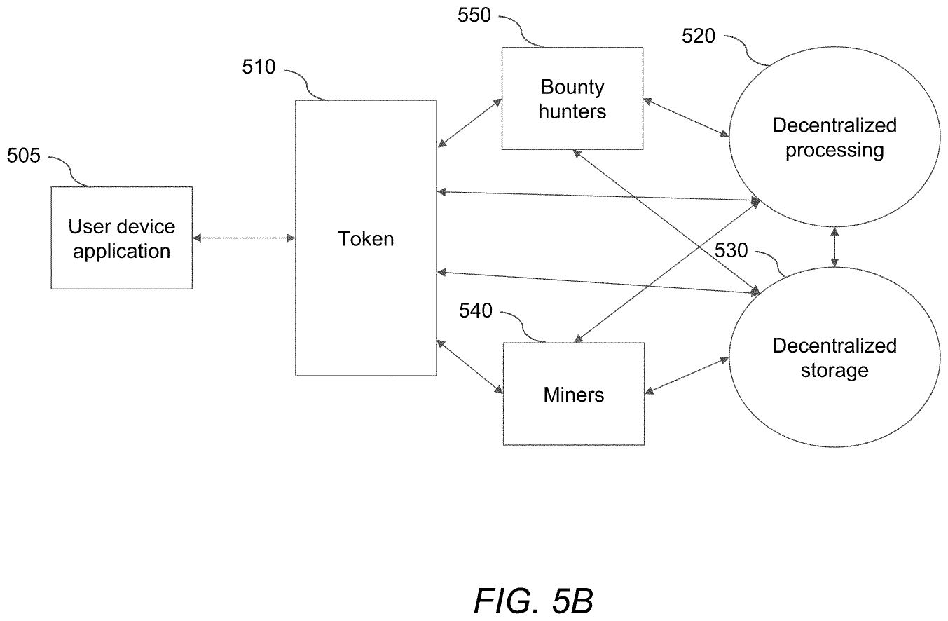

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In accordance with some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In accordance with some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a mode of demonstrating non-trivial allocations of processing power. Proof of Space (PoS) mechanisms may be used as a mode of demonstrating non-trivial allocations of memory or disk space. As a third possible approach, Proof of Stake mechanisms may be used as a mode of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In accordance with several embodiments the network optimization challenge may be selected from any of a number of different challenges appropriate to the requirements of specific applications including graph pebbling. In accordance with some embodiments, graph pebbling may refer to a resource allocation game played on discrete mathematics graphs, ending with a labeled graph disclosing how a player might get at least one pebble to every vertex of the graph.

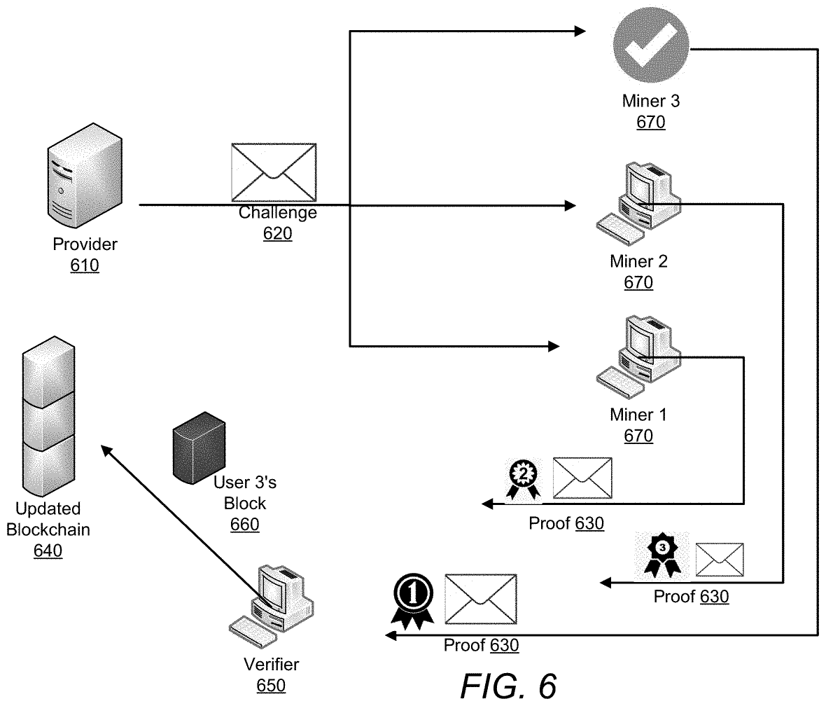

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

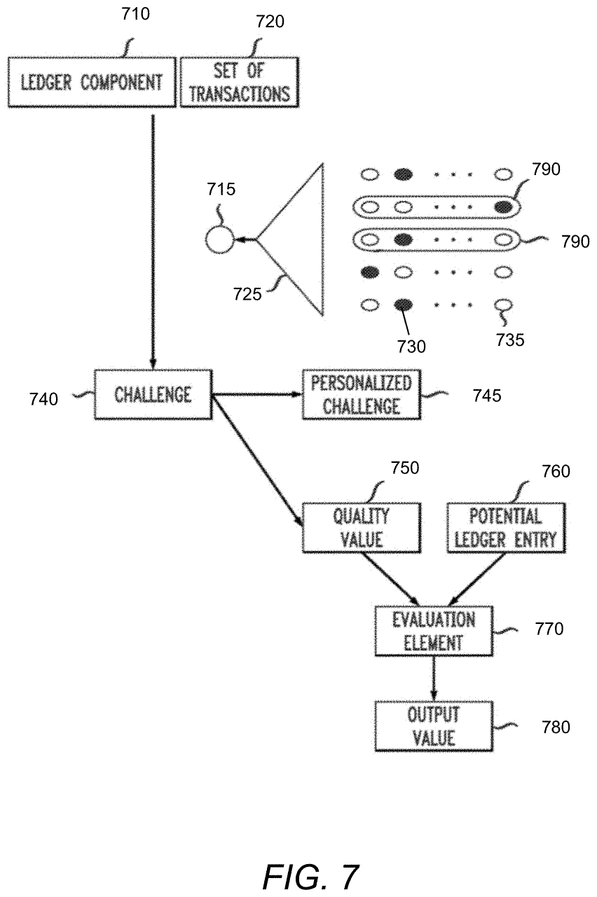

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In accordance with some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In accordance with several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In accordance with some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In accordance with some embodiments, non-proportional relationships may be created by modifying the function used to compute the quality value 750. When the evaluation 770 results in success, then the output value 780 may be used to confirm the suitability of the memory configuration and validate the corresponding transaction.

In accordance with many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In accordance with many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, In accordance with many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In accordance with many embodiments, the hybrid mechanism may incorporate a first and a second consensus mechanism. In accordance with several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

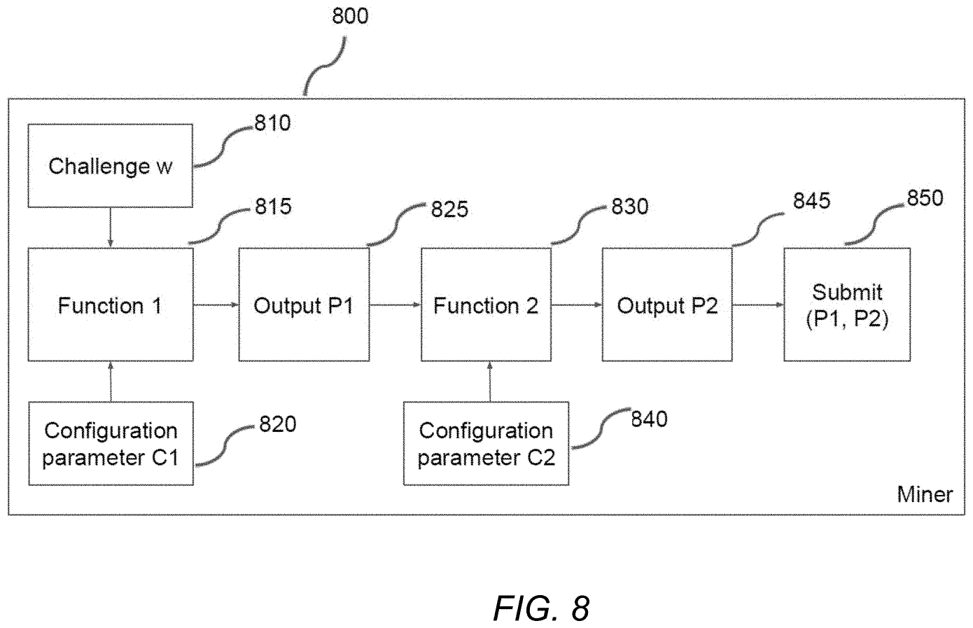

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In accordance with some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

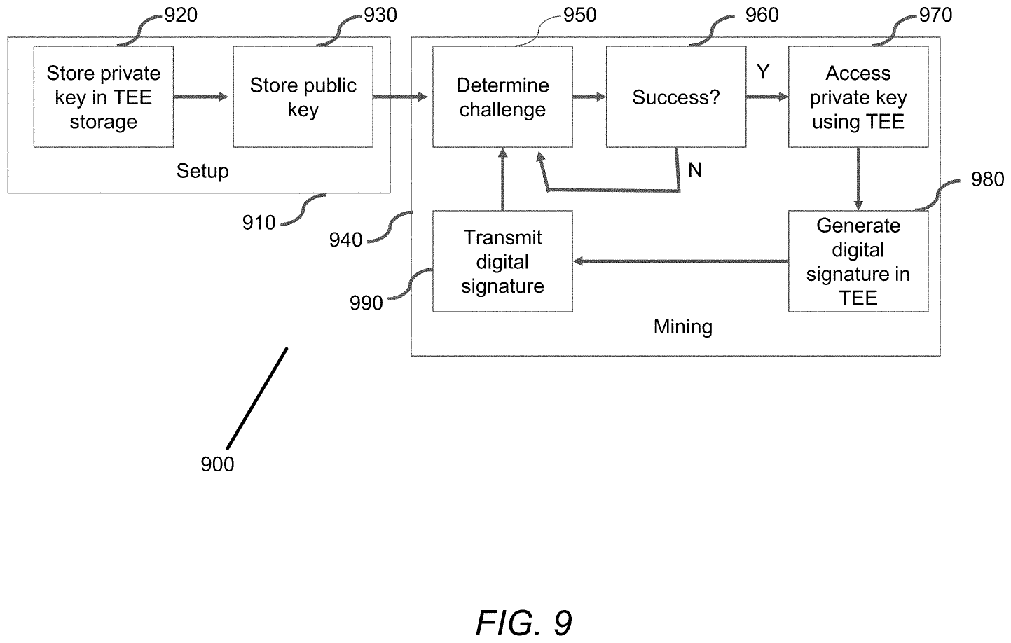

An illustration of sample process 900 undergone by TEE-based consensus mechanisms in accordance with some embodiments of the invention is depicted in FIG. 9. In accordance with some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In accordance with many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In accordance with some embodiments of the invention, the determination of success may result from some pre-set portion of the challenge matching a pre-set portion of the public key, e.g. the last 20 bits of the two values matching. In accordance with several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In accordance with several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In accordance with several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

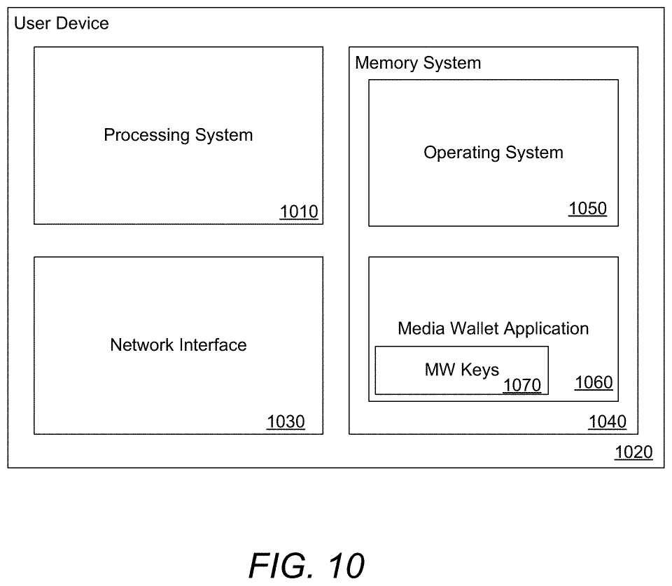

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In accordance with many embodiments, the media wallet application enables the user device to obtain and conduct transactions with respect to NFTs by communicating with an NFT blockchain via the network interface 1030. In accordance with some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

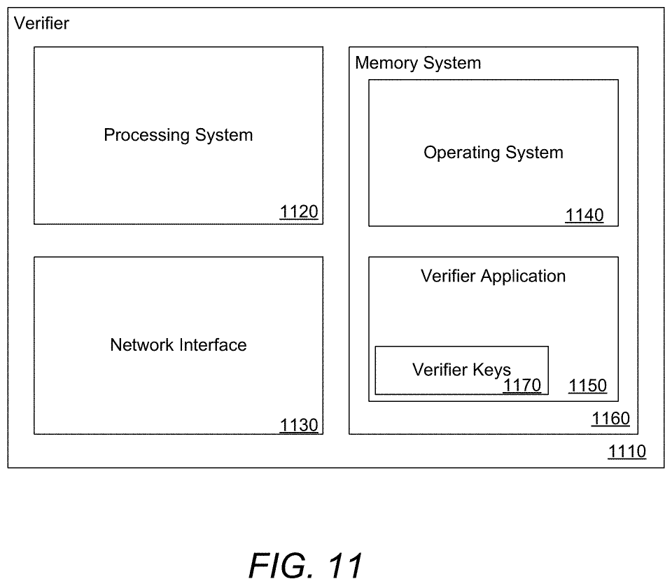

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

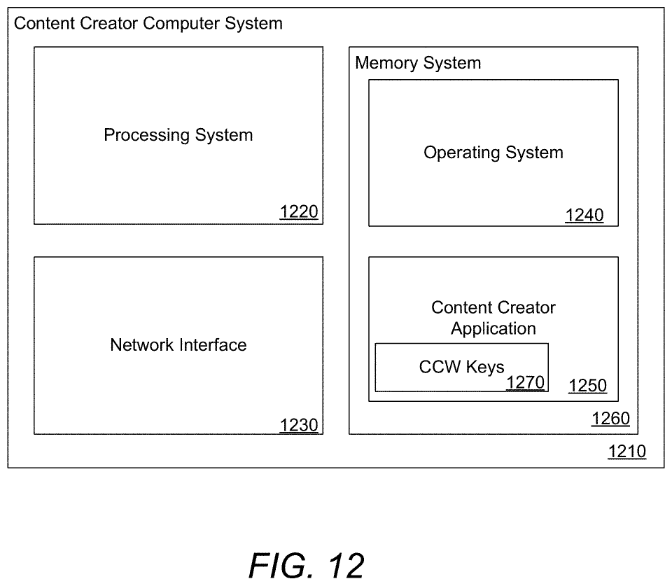

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In accordance with several embodiments, the digital wallet may securely store rich media NFTs and/or other tokens. Additionally, In accordance with some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

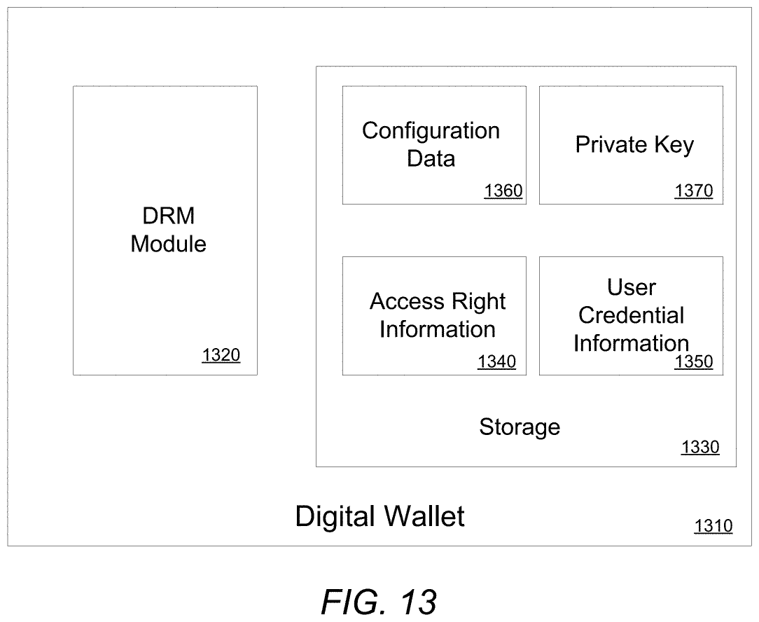

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including (but not limited to) decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 In accordance with some embodiments may also use one or more keys to communicate with a DRM server. In accordance with several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

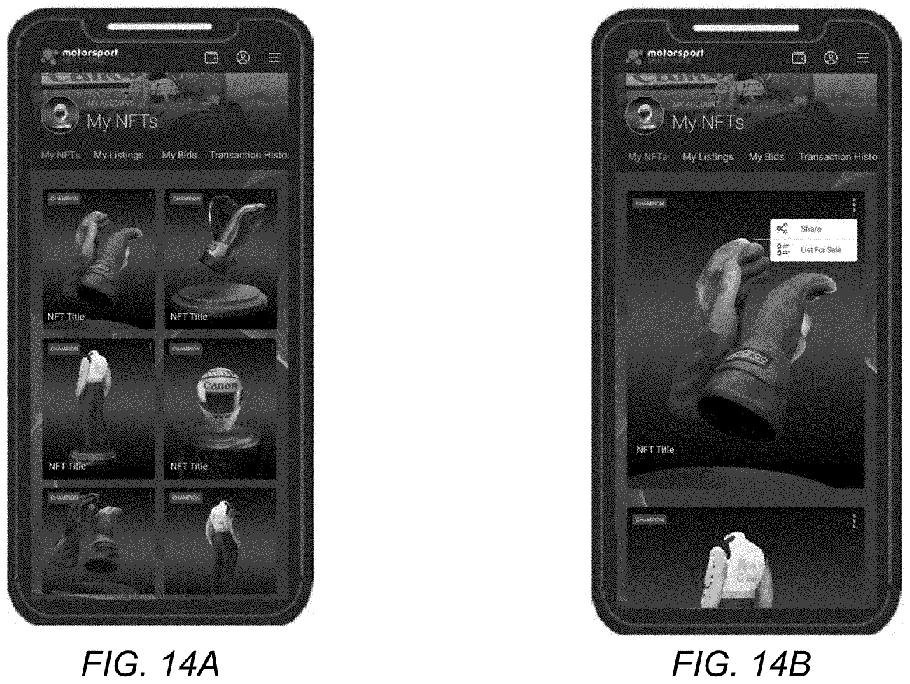

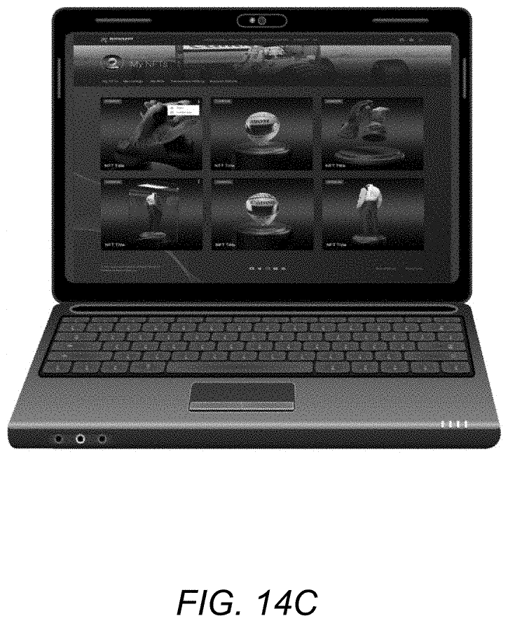

Operation of media wallet applications implemented in accordance with some embodiments of the invention is conceptually illustrated by way of the user interfaces shown in FIGS. 14A-14C. In accordance with many embodiments, media wallet applications can refer to applications that are installed upon user devices such as (but not limited to) mobile phones and tablet computers running the iOS, Android and/or similar operating systems. Launching media wallet applications can provide a number of user interface contexts. In accordance with many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In accordance with several embodiments, a first user interface context is a dashboard (see, FIGS. 14A, 14C) that can include a gallery view of NFTs owned by the user. In accordance with several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In accordance with some embodiments of the invention, a visual partition may in turn be partitioned into sub-partitions. In accordance with some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In accordance with some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In accordance with some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In accordance with some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In accordance with some embodiments, the first social NFT may then be associated with some rights and capabilities, which may be expressed in other NFTs. Additional rights and capabilities may also be directly encoded in a policy of the social security number NFT.

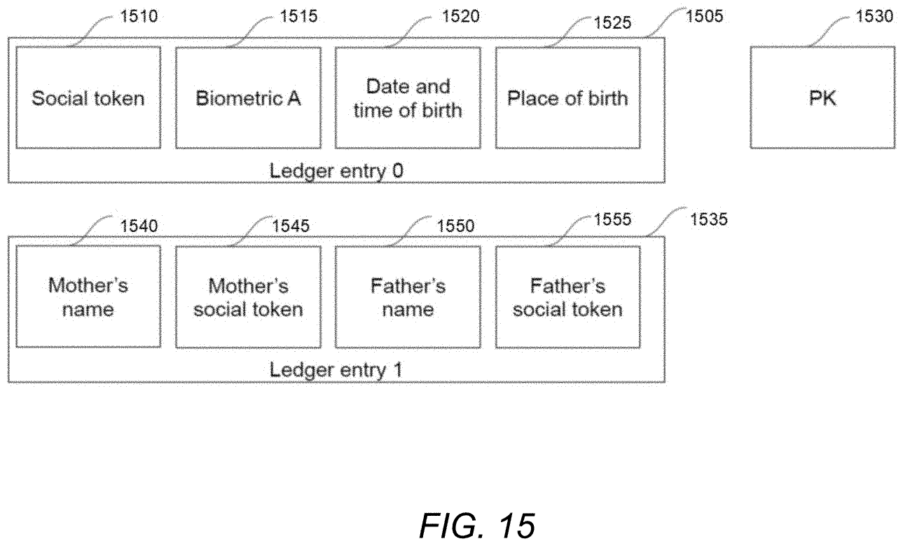

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including (but not limited to) mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In accordance with some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In accordance with many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In accordance with some embodiments, an agreement in a machine-readable form may include, but is not limited to, a policy and/or an executable script. In accordance with some embodiments, an agreement in a human-readable form may include, but is not limited to, a text and/or voice-based statement of the promise.

In accordance with some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In accordance with some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In accordance with some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In accordance with some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In accordance with some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In accordance with some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. Anchored NFT may tie to another NFT, which may make it both anchored and relative. An example of such may be called pseudonym NFTs.

Pseudonym NFTs may be a kind of relative NFT acting as a pseudonym identifier associated with a given social NFT. In accordance with some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including (but not limited to), what portions of a building employees may access, and what computer system employees may utilize. In accordance with several embodiments, employee NFTs may incorporate their owner's biometrics, such as a face image. In a number of embodiments, employee NFTs may operate as a form of promise NFT. In accordance with some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In accordance with some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including (but not limited to), licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including (but not limited to) traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In accordance with some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

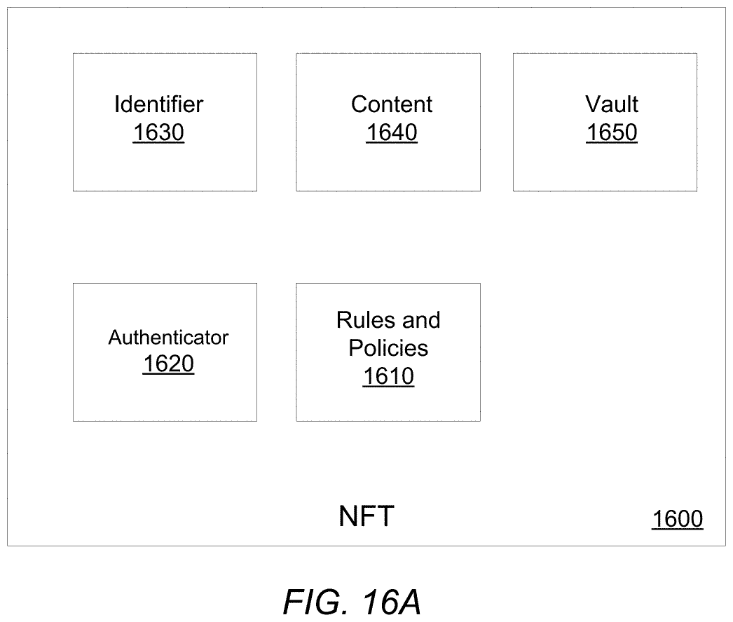

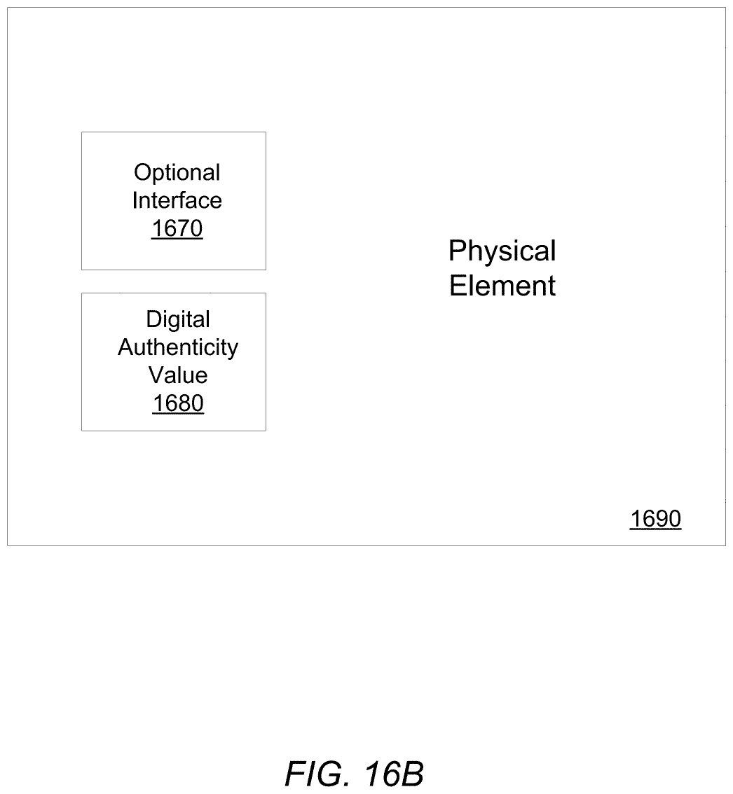

An example NFT which may be associated with specific content in accordance with several embodiments of the invention is illustrated in FIG. 16. In accordance with some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In accordance with some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In accordance with some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In accordance with some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In accordance with some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In accordance with some embodiments, the encoded value may also be represented in an authenticity database. Moreover, the physical interface 1670 may be physically associated with the physical element. One example of such may be a QR tag being glued to or printed on the back of a canvas. In accordance with some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In accordance with some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

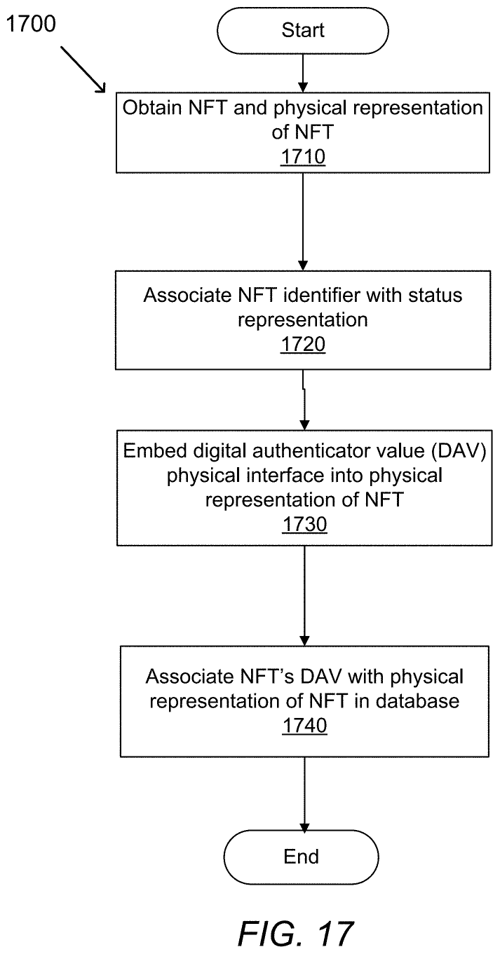

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In accordance with some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

Social Media over NFT Platforms

NFT platforms in accordance with many embodiments of the invention may implement systems directed to various social media capabilities. Social media functionality can be applied to transferring tokens, obtaining feedback on content, and generating new content.

A. Intelligent Social Media Content Creation

Systems in accordance with many embodiments of the invention may utilize policy-based elements, including (but not limited to) non-fungible tokens (NFTs). Such policy elements may be configured to track and control the provenance of valuable social media posts. NFTs in this disclosure may refer to smart-contract tokens capable of containing on-chain resources and/or pointing to off-chain resources. Off-chain resources may include (but are not limited to) creative assets such as images, books, poems, novels, music, and/or video files. Off-chain resources may additionally or alternatively refer to social media posts, which can contain original thoughts and expressions that are considered creative assets.

In accordance with various embodiments of the invention, social media posts may be minted into NFTs and posted on media platforms. For example, Alice may be an amateur artist and photographer that may be outspoken about her local elementary school board. One day, Alice may finalize an image of a tropical rainforest waterfall. The following day she may capture an interesting photograph of her dog. On the next day, she may attend a school board meeting that inspired a school busing idea and write down a summary of the idea. Alice, wanting to maintain original ownership of the creative content, can then mint three separate NFTs to capture the artwork, the photograph, and the thirty-word busing idea respectively. NFT minting platforms in accordance with some embodiments of the invention may enable Alice to automatically post sets of NFTs to her favorite social media accounts.

Systems in accordance with various embodiments of the invention may mint one or more NFTs to be posted on social media platforms. In numerous embodiments, systems may embed various attributes managing the use of NFTs over social media. For example, they may embed links to the identities of content creators into NFTs. Links to identities may include (but are not limited to) public key references. NFT mining platforms may embed policies related to the use of the NFTs by social media platforms that the NFTs are posted to. Such policies may be determined by the content creators and/or the mining platforms themselves. An example policy may require that a content creator's identity may be carried forward with the creative asset, including (but not limited to) when a social media post may be visible on-screen during a news broadcast. Additional policies may require tracking and reporting of likes, comments, commenters, content echoes, re-publications, etc. as disclosed in U.S. patent application Ser. No. 17/821,444, titled “Systems and Methods for Reporting Token Interactions,” filed Aug. 22, 2022, the disclosure of which is incorporated by reference herein in its entirety.

Systems in accordance with some embodiments may enable users to automatically post subsets of NFTs on social media accounts. Systems may, additionally or alternatively, enable users to create and upload content to be shared on social media (e.g., a photograph of Alice's dog). In enabling the minting of NFTs, applications operating in accordance with some embodiments of the invention may allow users to configure prospective tokens e.g., by selecting policies that can influence interactions with the tokens on social media platforms. For example, policies may include (but are not limited to) whether to track comments, whether to allow and/or disallow transport to additional platforms, and which social media platforms token content may be automatically posted to. Once tokens are minted, applications may enable users to select social media platforms and post them for user consumption. Tokens may be posted manually and/or through systems configured to do so automatically.

Systems in accordance with many embodiments of the invention may embed policies related to public use of NFT content, including (but not limited to) preventing platforms from re-publishing NFT content. Systems may incorporate DRM entities to protect certain assets. Additionally or alternatively, code may be present alongside and/or within the content (e.g., image, audio, etc.) to indicate the NFT source/address in order to protect the NFT asset from abuse. The code may be randomly generated code and/or specific to the blockchain. The code may be visible, such as alphanumeric codes and QR-codes. Policies may state royalty requirements for events including (but not limited to) the use of footage the content creator generated and uploaded on a cable TV news program. Entities (e.g., the news program) may then be able to automatically determine information including (but not limited to) what content they can use, at what cost, and what the terms of use are without the often involved and slow outreach to the content creator. Such royalty requirements may include (but are not limited to) the compensation required for different types of uses. As mentioned earlier, NFTs may be attributed to content creators, where attribution may, for example, identify the name of the originator and the preferred pronouns for this person. Policies may explicitly permit and/or prohibit adaptation/remixing. For instance, a policy may prohibit the use of a photo determined to be of a given person in the creation of “deep fakes”, without explicit permission from the associated person (e.g., in the form of a digital signature on a message related to the allowed photo). Policies may explicitly and/or implicitly permit and/or prohibit the use of content in datasets used to train machine learning models (e.g., instance models that generate new media directly and/or models that compute editing and processing parameters to be applied to other human-generated media). In various embodiments, platforms may enable creators to be given attribution and/or remuneration when the creators explicitly permit adaptation, remixing, and/or machine learning training on their work. Such platforms may further enable creators to be given attribution and/or remuneration when future NFTs building on their work are minted and/or sold.

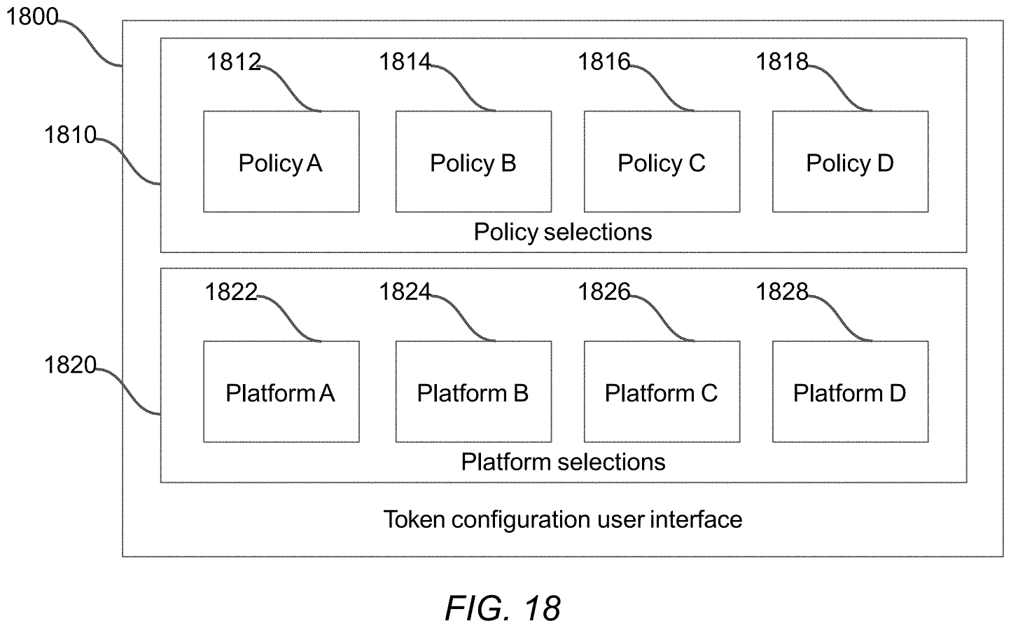

An example policy structure for NFT minting prior to social media posting, in accordance with certain embodiments of the invention, is illustrated in FIG. 18. Token configuration user interfaces 1800 may reflect what may be encountered with computer browsers and/or mobile applications. Policy selection 1810 windows, in accordance with certain embodiments of the invention, may be user-directed windows containing various interfaces for token policies 1812, 1814, 1816, and 1818. Such policies may include (but are not limited to) whether the content may be republished by other users, whether likes, commenters, and/or the number of views may be tracked, whether the content may be used by various entities (like journalists and reporters), etc. In accordance with several embodiments, prospective policies 1812, 1814, 1816, and 1818 may be presented to users prior to minting NFTs. In accordance with some embodiments, platform selection 1820 windows may be user-directed windows containing multiple interfaces for selecting social media platforms. The social media platforms may be applied to auto-publishing minted NFTs. The policy selection 1810 and/or platform selection 1820 windows may include (but are not limited to) radio buttons, pulldown selections, etc. Prospective platforms 1822, 1824, 1826, and 1828 may be presented to users prior to minting NFTs.

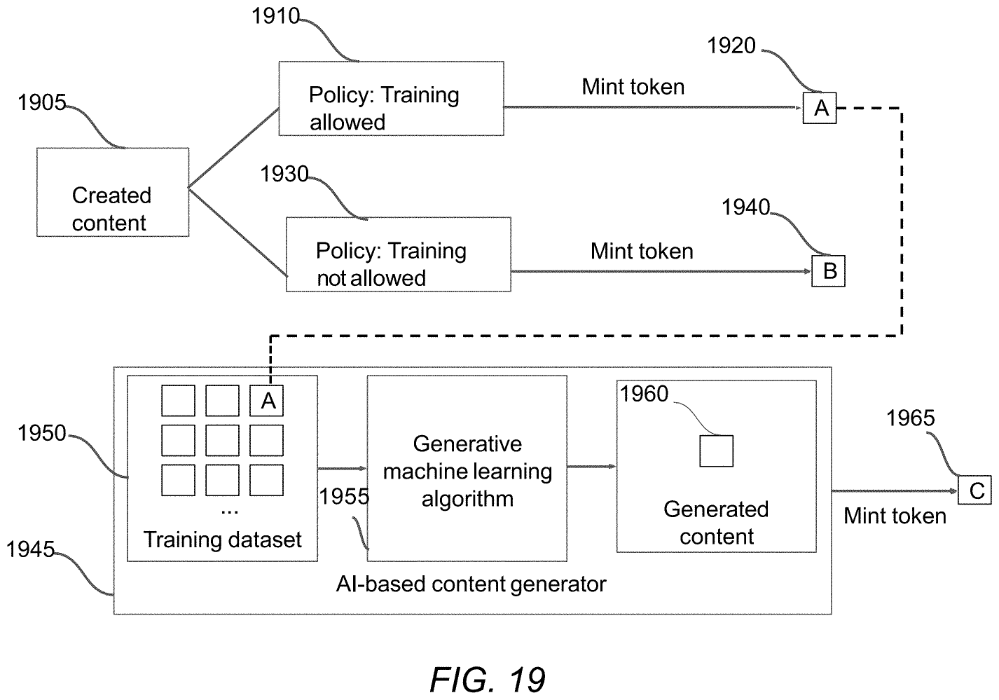

An example of a system to utilize a policy structure, in accordance with several embodiments of the invention, is illustrated in FIG. 19. Systems may explicitly allow and/or disallow the use of NFTs in training datasets. Such datasets may be applied to processes including (but not limited to) training AI systems to generate content 1905, for example, a musical song. Systems in accordance with a number of embodiments may establish policies 1910, 1930 that will be implemented in NFTs corresponding to the content. In some instances, policies 1910 may indicate that the new NFTs explicitly permit use in training datasets used to train AI content generation and/or content manipulation systems. Alternatively or additionally, certain policies 1915 may indicate that the new NFT may not be included in training datasets. An example NFT of this type may be called “B” 1940. AI-based content generator systems 1945, operating in accordance with various embodiments of the invention, may be designed to use training datasets 1950 of media examples, including (but not limited to) token A 1920, to computationally generate new content. From the datasets 1950, generative machine learning algorithms 1955 that operate through the content generator 1945 may be trained. For instance, token A 1920 and the rest of the training dataset 1950 may include musical songs. The generative machine learning algorithm 1955 trained using those songs may provide the content generator 1945 system with the capability to generate new songs. As mentioned, content generator systems 1945 may adhere to various token policies regarding whether tokens may be used in training datasets 1950. Here, the media content associated with Token A 1920 may be used (and has been used), but media from token B 1940 may never appear in this training set. The generated content 1960 newly created by the content generator 1945 may then be minted into new NFT tokens, such as C 1965. NFTs generated in accordance with some embodiments may be associated with smart contracts including provisions providing some benefit to the content creators. In the earlier example, token C's 1965 smart contract may have a provision that the creator of token A 1920 receives remuneration when token C 1965 may be sold.

Several embodiments of the intention may incorporate artificially intelligent content creation systems for auto-generating NFTs from existing sources. Existing NFT sources may include (but are not limited to) existing NFTs and social media posts, profiles, and engagement histories. Auto-generated NFTs may be minted, published, sold, and traded, etc. on platforms. Prospective platforms may include (but are not limited to) social media, advertising, and/or promotional systems such as those related to search engine results. Auto-generated sequence-able version assets may be created using original images and profile content from social media systems as base forms. In accordance with numerous embodiments of the invention, original images and profile content may be used to propose potential NFTs for advertisement and sale.

Intelligent content creation methods and algorithms operating in accordance with some embodiments of the invention can iteratively adjust and improve the process(es) of selecting, editing, and/or generating content: Selecting may refer to the selection of specific content to share, from among a set of candidates, including (but not limited to) selecting one or more photos from the set of all photos taken by users over a time period or at a location. Editing may refer to the modification of existing content, including (but not limited to) adjusting image contrast, applying more complex algorithmic processing for image effects such as skin smoothing, adjusting the musical content and/or equalization of music media items, and/or selecting short video clips from longer videos. Generating may refer to the creation of new content, for instance, the assemblage of multiple photos into static collages and/or video montages; the use of techniques such as StyleGAN and Style Transfer to generate new images, including (but not limited to) creating an “anime” version of a person's face and/or rendering a photo in the style of Van Gogh's Starry Night; the use of language models to generate new text status updates or image captions; the creation of new videogames whose text, visual and/or audio content are derived in part from users' social media posts and uploads; and/or the creation of interactive digital art pieces instantiated as web apps, whose visual and/or audio content may be derived (at least in part) from users' social media posts and posting history (e.g., GPS locations and times of their recent posts).

Intelligent content creation systems operating in accordance with a number of embodiments of the invention may perform selection, editing, and/or generation using strategies that aim to iteratively improve content creation based on one or more feedback signals. Feedback signals may include (but are not limited to) explicit feedback from specific users, aggregate feedback from multiple other users (who may be acting independently), and/or implicit feedback in the form of engagement, such as views, likes, and shares. Strategies operating in accordance with several embodiments of the invention may be embodied by program code whose logic specifies details of how selection, editing, and/or generation can be performed and/or specifies rules for how this should change in response to the reward signals. Alternatively or additionally, strategies may be embodied by optimization algorithms that attempt to identify approaches to selection, editing, and/or generation that will increase and/or maximize objective functions. Additionally or alternatively, strategies may be embodied by reinforcement learning algorithms that learn to adjust the details of the selection, editing, and/or generation in response to the feedback signals.

Additionally or alternatively, strategies may be embodied by suites of supervised learning models, wherein each includes classifiers and/or regression models. Regression models may be configured to predict from the user content and/or computational analysis on the appropriateness of mechanism(s) for selection, editing and/or generation, and parameterization(s) of such mechanism(s). In numerous embodiments, regression models may potentially provide probability distributions over mechanisms and parameterizations that can be sampled from, where these supervised learning models can adapt over time to reflect new feedback. Strategies may be embodied by supervised learning models that can produce filtering and/or rankings of candidate output artworks and approximate users' preference or other criteria, while adapting over time to reflect new feedback.

Strategies operating in accordance with some embodiments of the invention may incorporate combinations of the above characteristics. For instance, reinforcement learning algorithms could be used to attempt to determine the optimal configurations of artwork generation algorithms while explicit program logic may be used to generate additional output artworks. In accordance with some embodiments, all outputs may be presented back to users as a set. Systems in accordance with many embodiments of the invention may also incorporate additional implementations. For example, an implementation involving a non-executable element that conveys the strategy information to an external executable element, where such external executable elements may be part of the digital wallet (or other executable environment) used to store and/or render content related to tokens.

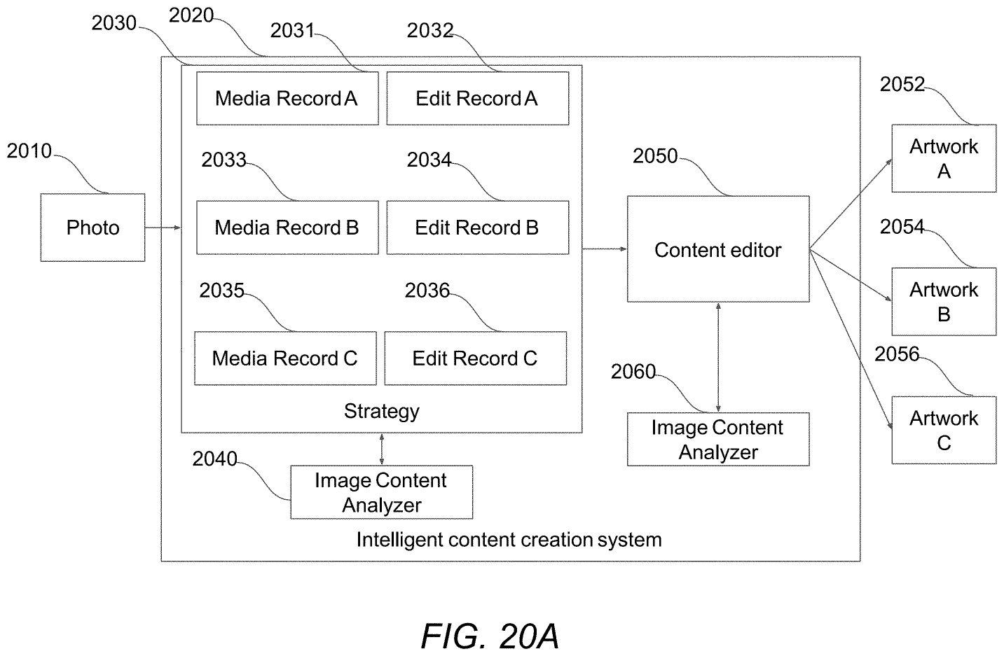

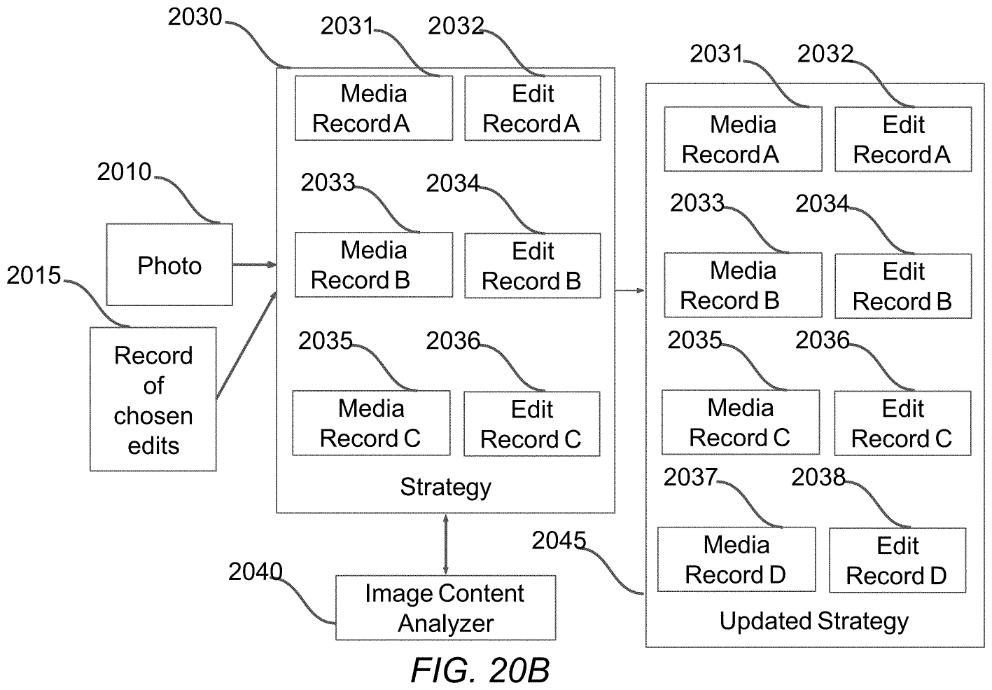

An example process, through which strategies within systems operating in accordance with certain embodiments of the invention, may guide content editors to produce new artworks, is illustrated in FIG. 20A. In accordance with certain embodiments, artwork including (but not limited to) photos 2010 may be provided as input to intelligent content creation systems 2020. Strategies 2030 implemented in such systems 2020 may contain records of other media and records of edits corresponding to that media. Specifically, the example depicted in FIG. 20A, the strategy contains references to three media items, named Media Record A 2031, Media Record B 2033, and Media Record C 2035. Media records may include copies of other media, including (but not limited to) digital copies of photos (and other artwork), feature vectors and/or content descriptors computed by image content analyzers, and metadata (such as an artwork's location and/or date of creation. In accordance with many embodiments of the invention, media records may include (but are not limited to), copies of past artwork uploaded to the system 2020.

Media records can be stored with information about the corresponding edits. In this example, Edit Record A 2032 can correspond to Media Record A, Edit Record B 2034 can correspond to Media Record B, and Edit Record C 2036 can correspond to Media Record C. Edit records may contain specifications of how the corresponding media records can be edited by content editors 2050. Corresponding edit records may include (but are not limited to) specifications of past edits made by content editors 2050. For instance, edits may include information about which filters should be applied to an image and with which parameter settings. Systems in accordance with some embodiments of the invention may apply edits to produce prospective artwork corresponding to the photo 2010. Such edits may be selected by users for photos. Alternatively or additionally, according to users preferences, specifications of certain edits (that were previously used to produce prior artwork) may be selected (for current use) by systems according to predictions. The predictions may, for example, be based on what users have previously liked.

Systems in accordance with numerous embodiments may obtain media records and edit records from other sources. These other sources may include, but are not limited to, photos uploaded by other users and the corresponding edits chosen by those users, photos and corresponding edits chosen by the system designers, and/or photos and corresponding edits chosen by domain experts.

Strategies 2030 in accordance with numerous embodiments of the invention may apply media records and edit records to produce new artwork from photos 2010. Strategies 2030 may employ image content analyzers 2040 to compute sets of content descriptors for the input (e.g., photo 2010). Content descriptors may capture information about the objects, people, and places in the photo; information about the photo's visual composition, etc. The strategies 2030 may compare content descriptors corresponding to photos 2010 to content descriptors for some or all of the stored media records. Comparison may be used to determine the similarity between photos 2010 and the stored media records. Strategies 2030 may use edit records corresponding to the most similar past media to specify how content editors 2050 should produce new sets of candidate artworks. For instance, strategies 2030 may instruct content editors 2050 to produce artwork using the edit record corresponding to the single most similar media record (e.g., edit record C 2036). Alternatively or additionally, strategies 2030 may instruct content editors 2050 to produce artwork that uses small variations on the aforementioned edits. Alternatively or additionally, strategies 2030 may instruct content editors 2050 to apply multiple edits using the edit records corresponding to multiple available edit records (e.g., three edits using the edit records corresponding to the first, second, and third most similar media records). Content editors 2050 operating in accordance with several embodiments may edit based on multiple factors. Content editors 2050 may use one or more additional image content analyzers 2060 to inform additional edits. For instance, the system of FIG. 20A may use an analysis of the position of faces in the photo 2010 to crop the photo for optimal positioning of faces in each output artwork. Here, the result of the content editor applying edits specified by the strategies 2030 and any additional edits may be the creation of multiple new artworks (e.g., Artwork A 2052, Artwork B 2054, and Artwork C 2056).

An example process, through which strategies within systems operating in accordance with certain embodiments of the invention, may be updated following user selections of new artworks, is illustrated in FIG. 20B. An example scenario in which such processes may be applied would be the strategy 2030 updating the intelligent content creation system 2020 following the user's selection of Artwork B 2054. In the scenario, the strategy 2030 may contain media record A 2031, media record B 2033, media record C 2035, edit record A 2032, edit record B 2034, and edit record C 2036. Strategies 2030 operating in accordance with a number of embodiments of the invention may receive both artwork (e.g., the photo 2010) and records of chosen edits 2015. Records of chosen edits 2015 may describe how content editors 2050 applied edits to photos 2010 in order to produce user-selected new artworks (e.g., Artwork B 2054). For systems operating in accordance with various embodiments of the invention, new media records 2037 and/or new edit records 2038 may be produced from photos 2010. New media records 2037 may include (but are not limited to) copies of the input photo and corresponding sets of content descriptors computed using image content analyzers 2040. New edit records 2038 may be produced from records of chosen edits 2015. Updated strategies 2045 may be produced by adding new media records 2037 and/or edit records 2038 to the already stored set of records within strategies 2030. Updated strategies 2045 can be used to produce future artworks.

The above implementation may be utilized in varying contexts. For example, a famous actor may post a daily picture of his adventures around the world. In accordance with certain embodiments of the invention, NFTs may be auto-generated every day with approval required from the actor to continue to post every day. An example auto-generated NFT may be a selection of one his photos of the day, edited to apply color adjustments and skin smoothing, with a brief text caption. Alternatively or additionally, depending on his past posting activities and preferences, the auto-generated NFT may apply a dramatic Style Transfer effect to render a photo in the style of an impressionist oil painting. Should the actor not like the auto-generated work, the actor may elect to re-seed the creation process to obtain new proposals, and/or simply wait for the next auto-generation to complete.

Intelligent content creation systems operating in accordance with several embodiments of the invention may learn the preference of users based on their posts and which auto-generated artworks they select and/or decline. For example, systems may propose three different new NFTs and request a relative user's rating amongst the three to assist with acquiring the user's preferences. With time, as the system learns from the user, the personalization can converge on the user's creative virtual persona. Personas can be wholly driven by user preferences and feedback. Personas may, additionally or alternatively, take into account the behaviors of other users on the platform (including other content producers as well as users engaging with generated content via likes, shares, etc.). Systems in accordance with many embodiments of the invention can utilize machine learning feature extraction to build knowledge, in the form of classifications, about the social media history of users. Social media history may include but is not limited to the typical number of posts per day, content in their feed, and their profile. Artificial intelligence may auto-generate derivative artwork based on the feature extraction for user review. Users may then have the capability to approve and disapprove of NFT minting and posting of the AI-generated artwork.

As another example, a social media influencer may present herself to her fans using the persona of an anime character. One day, she may take a number of selfies and provide them as input to a content creation system. Systems operating in accordance with a number of embodiments of the invention can be configured to use one or more types of generative adversarial networks (GANs) to generate set of candidate artworks. In the above example, the set may be of candidate anime artworks, each of which depicts the influencer as an anime character. GANs may, for instance, be configured as disclosed in “U-gat-it: Unsupervised generative attentional networks with adaptive layer-instance normalization for image-to-image translation”, preprint arXiv:1907.10830 (18009), by Junho Kim, Minjae Kim, Hyeonwoo Kang, and Kwanghee Lee, incorporated herein by reference. The GAN configuration could, additionally or alternatively, use the approach described in “AniGAN: Style-Guided Generative Adversarial Networks for Unsupervised Anime Face Generation,” arXiv preprint arXiv:18102.12593 (2021), by Bing Li, Yuanlue Zhu, Yitong Wang, Chia-Wen Lin, Bernard Ghanem, and Linlin Shen, incorporated herein by reference.

Systems operating in accordance with a number of embodiments of the invention may implement a series of configurations to facilitate the creation of GAN-generated artwork. Systems may incorporate parameters for users and/or computational processes to adjust output images according to criteria of interest, including (but not limited to) image coloration, type and/or extent of image artifacts. Additionally or alternatively, systems may implement mechanisms to analyze, prioritize, rank, and/or filter outputs based on criteria of interest, including (but not limited to) the composition and framing of the image, the image color palette, the presence and nature of computational artifacts, the similarity of the image to other images of interest, etc. Additionally or alternatively, systems may incorporate mechanisms for adjusting the GAN outputs in response to user preferences and other feedback signals. Additional feedback signals may include (but are not limited to) user actions, social media engagement, preferences, and/or actions of other people such as system users and/or domain experts.

Systems operating in accordance with many embodiments of the invention may generate output artworks that reflect variations on various characteristics of the input artwork(s). In the above example, each output artwork may match one of the original images in terms of pose, hairstyle, clothing, etc. while changing the style to an anime style. An example anime style, for example, may be similar to “SAILOR MOON,” featuring flat colorization with feminine color palettes and highly stylized eyes. Alternatively or additionally, users may prefer an anime style more similar to “DRAGON BALL Z”, featuring brighter colors and angular facial features and hair. Systems may enable users to input their preferred style and/or provide examples for users to choose from.

Systems in accordance with several embodiments of the invention may generate one or more suggested output artworks. Different output artworks may differ in terms of the visual details, for instance, but not limited to the drawing style, coloring, presence and/or absence of visual artifacts arising from the computational generation process. In this application, artwork may include but is not limited to traditional paintings, photorealistic images, anime- and cartoon-like images, drawing- and sketch-like images, images similar to videogame avatars and other videogame visual content, collages, abstract visual art, digital art, text, video (including photorealistic video and animation-like video, music videos, photo and image montages, abstract audiovisual content), virtual reality or augmented reality experiences, music of any genre, speech, sound art, and other sounds (for instance, natural soundscapes, sound effects, and videogame-like sound content). Artworks may, additionally or alternatively, comprise executable elements including (but not limited to) video games, interactive visual art, interactive music, and various additional configurations of executable elements.

In accordance with many embodiments of the invention, intelligent content creation systems may use one or more GANs to produce the output artworks. Singular GANs can be used to create multiple output artworks. For instance, multiple output artworks may be generated by applying changes including (but not limited to) cropping and/or coloring changes to the input image(s), applying modifications to the latent vector used to generate each image, choosing different reference faces (e.g., anime faces) for GAN variants. Different GANs operating in accordance with may use different GAN architectures. For example GANs may be trained on different training datasets, may have been trained using different processes, may be configured to produce images of different resolutions and/or sizes, etc. In accordance with several embodiments of the invention, other image generation and processing techniques could be used alongside or instead of GANs.

For systems operating in accordance with several embodiments, strategies may incorporate various types of information. Information incorporated by GANs may include but is not limited to users' past artwork selections; users' past likes and dislikes of output artworks; historical information about users' followers and their likes, shares, and purchases of output artworks; artwork selection and preferences by other content creators; artwork selection and preferences solicited by other people through mechanisms including (but not limited to) panels, surveys, and crowdsourcing, heuristics encoded into the systems by their creators; analysis of the content of the input including (but not limited to) information about the number of faces present and their poses and positions, facial expression, hair color, color palette; additional information from the platform and/or the photo metadata including (but not limited to) location and time of day; and/or other information to guide the choice and/or configuration of the GAN(s) used to generate the output artworks.

Systems operating in accordance with some embodiments may store records of past choices of GANs and their respective parameterizations. For example, a system may include a choice of reference anime face that was used to create the last output artwork users selected for minting. Systems may provide the option to automatically apply past choices and/or include small variations, to generate the next set of output artworks. Alternatively or additionally, systems may store records for previous input images and the output artworks that were selected and/or “liked” by users. Systems may alternatively or additionally enable users to search for previous input images that may be most similar to the current input. Searches may be performed according to image content analyzers and/or neural networks that input images and computes corresponding feature vectors and/or coordinates in latent spaces where the similarity between images can be computed. Similarity may be computed using distance and/or vector operations. Systems operating in accordance with several embodiments may apply the choice of GAN(s) and GAN parameterization previously applied to the most similar image(s). Alternatively or additionally, systems may use one and/or more trained machine learning models to compute the choice(s) of GAN(s) and their parameterizations. In such cases, trained models for GAN choices can take as input images and/or vector outputs by image content analyzers and output choices of GAN and/or probability distributions over GANs. Alternatively or additionally, trained models for GAN parameterization can take as input images and/or vector outputs by image content analyzers and output parameterization and/or probability distributions over parameterizations for the corresponding GAN.

Analysis of user images may inform modifications applied with one and/or more GANs. For instance, prospective modifications may include (but are not limited to) cropping and resizing images, background removal and/or blurring, adjusting brightness, and adjusting contrast. Analysis of users' images and/or generated output artworks may be used to trigger and/or configure error messages to users. In various embodiments, analysis may be used to circumvent the intended operation of systems. For example, when users upload photos with no face, anime versions of a face cannot be generated for the photo.

In the above example, the influencer may select her favorite generated artwork out of those created by the system to be minted into an NFT and shared with her followers. She may use a graphical user interface to indicate that she particularly likes certain other generated artworks even though she did not select them on this occasion, and/or to indicate that she particularly dislikes some others (for instance, two include computational artifacts that make her face look strange, and one uses a color palette that does not match her personal brand). An intelligent content creation system operating in accordance with some embodiments may use information about the artworks she picked, liked, and disliked to improve its generation strategy for the influencer. For instance, where machine learning models are used to predict the choice of GAN and GAN parameterization, these models may be adjusted using new training examples reflecting the GAN choice and GAN parameterizations that led to the selected and “liked” artworks being created. Alternatively or additionally, machine learning models may be used to filter and/or rank a set of candidate GAN-created artworks for the purposes of determining which outputs should be presented to users. The specific machine learning model implemented by the influencer may be adjusted using new training examples reflecting the artworks that were chosen, liked, and/or disliked by users.

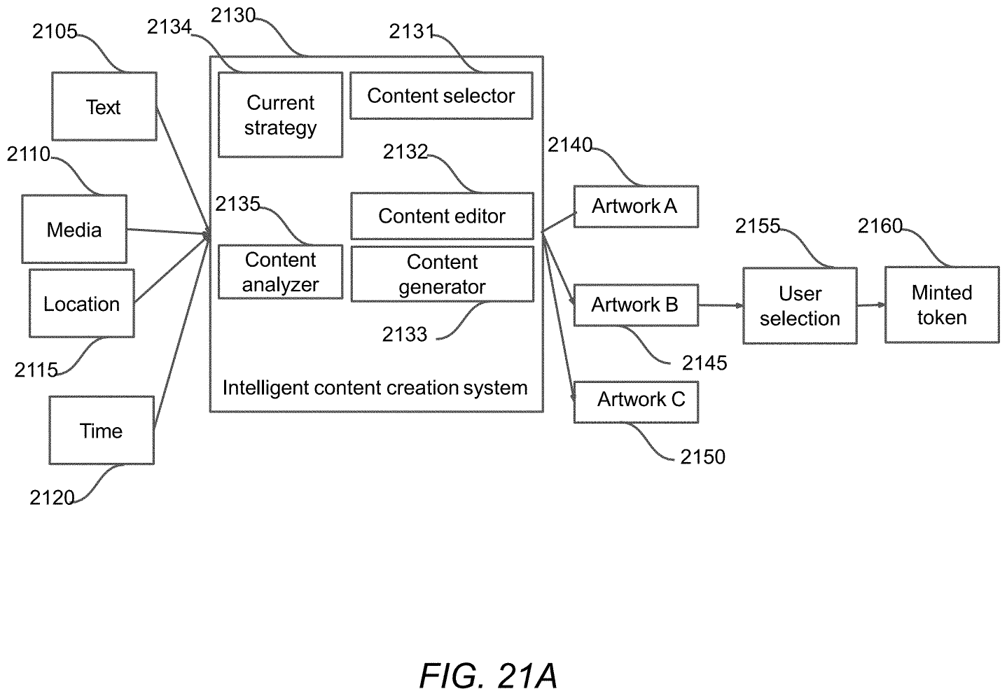

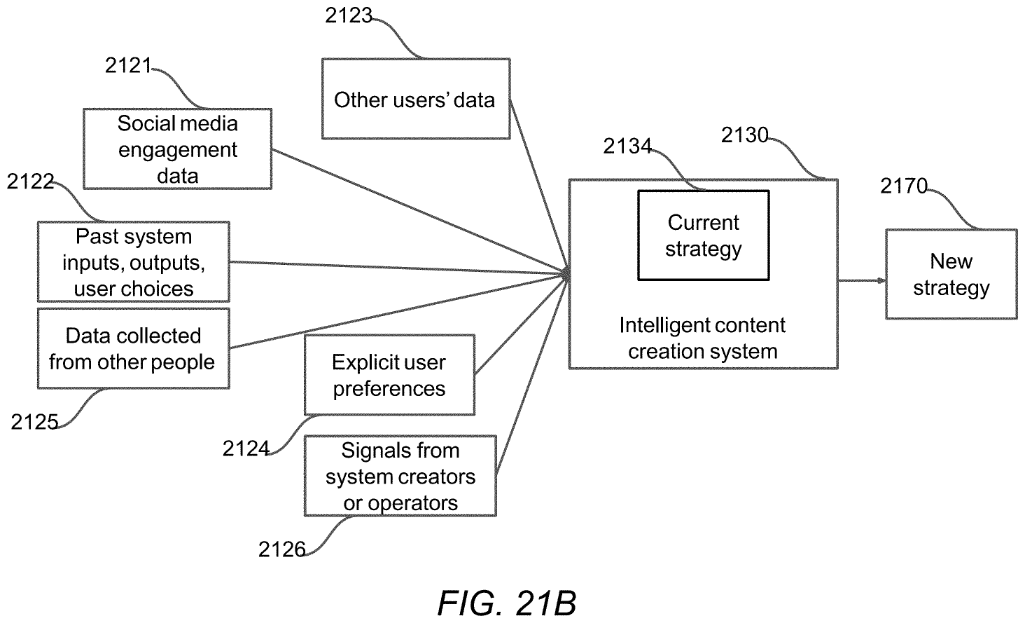

An example process by which intelligent content creation systems operating in accordance with various embodiments of the invention, can produce multiple candidate artworks is illustrated in FIG. 21A. A number of categories of users media 2110 may be input into systems. Examples of users media 2110 may include but may be not limited to one or more photos, text 2105 (such as captions supplied with the photos and/or social media status updates), and/or other data and metadata (such as the location 2115 of users and/or the time of day 2120). Intelligent content creation systems 2130 may employ content entities including, but not limited to, at least one content selector 2131, content editor 2132, and/or content generator 2133. One or more content selectors 2131, content editors 2132, and/or content generators 2133 may be used individually and/or in combination with each other. Systems in accordance with some embodiments of the invention may employ one or more current strategies 2134 to select among and configure its content selector(s), content editor(s), and content generator(s). Selection and configuration of content entities may be performed in order to produce one or more candidate artworks. Candidate artworks may include, for instance, three different filtered versions of a user's photo: artwork A 2140, artwork B 2145, and artwork C 2150.

Systems may employ one or more content analyzers 2135 which can be applied by strategies 2134 to inputs, the output artworks, and/or intermediary content. Content analyzers 2135 can be used by the current strategies 2134 of systems to inform the selection and configuration of other components. Content analyzers 2135 can be used to filter, rank, and/or adjust content produced by content selectors, content editors, and/or content generators. Content analyzers 2135 can be used to inform intermediary processing within content entities. Content analyzers 2135 can be used to trigger error messages and/or other user notifications to provide information to users about the content creation process. Content analyzers 2135 can be used to inform other editing and/or processing of media and other information within systems operating in accordance with numerous embodiments of the invention. Content analyzers 2135 can also be used for multiple other purposes within systems. Users may select 2155 any number of artworks produced by systems (e.g., artwork B 2145) to be minted 2160 into NFTs.

An example process by which intelligent content creation systems operating in accordance with a number of embodiments of the invention may adjust their current strategies is illustrated in FIG. 21B. Systems 2130 may assess user interactions and user data to adjust strategies 2134 in order to create content that better reflects user preferences and “creative personas.” Assessments can include, but are not limited to, past system inputs 2122 such as media 2110, text 2105, location 2115, time 2120, and other data from previous content generation, the past system outputs 2122, including (but not limited to) the candidate artworks 2140, 2145, 2150 output by the generation process, and past user choices 2122. User choices 2122 may include (but are not limited to) past content that users decide to mint into NFTs. Other inputs into this process can include, but are not limited to social media engagement data 2121 such as the number of “likes” and/or “shares” of past posts; explicit users preferences 2124 such as those supplied through graphical user interfaces to specify when certain types of generation are to be used; etc.

Data assessed may come from external sources, such as other system and/or platform users 2123. Data from other system and/or platform users 2123 may include (but are not limited to) other users' system inputs, outputs, and choices; other users' social media engagement data, other users' explicit user preferences, other users' media and/or text content posted previously on the platform, etc. Other inputs into this process may include data collected from other people 2125 who are not system and platform users. Data collected from other people 2125 may include (but are not limited to), data from participants in panels convened for the purposes of understanding preferences and/or behaviors; crowdsourcing workers participating in activities intended to gather information about perception and/or preferences; expert content creators providing explicit guidance and data related to their interactions, activities, preferences, and/or created content; etc. Other inputs into the assessment process may additionally include signals from system creators and/or operators 2126. This may include, but are not limited to requests to adjust system behavior to accommodate newly released methods for content selection, editing, and/or creation; to adjust system behavior to fix bugs; and to adjust system behavior to take into account new business strategies and/or new business intelligence.

For systems operating in accordance with many embodiments of the invention, inputs to the assessment process may take several forms. Possible inputs can include copies of the aforementioned data, including (but not limited to) copies of images used in past system inputs and outputs in 2122; content descriptors and/or feature vectors computed from the aforementioned data, including (but not limited to) feature vectors computed by an image content analyzer on copies of images used in past system inputs and outputs in 2122; outputs of other computations applied to such data, including (but not limited to) neural networks trained or fine-tuned on this data; etc. Intelligent content creation systems 2130 can use this information to produce new strategies 2170, to replace the current strategy 2134 for future content generation.

Moreover, intelligent content creation systems operating in accordance with various embodiments make take as input the reactions of followers and other users. For example, systems may be given access to feed indicating reactions, including (but not limited to) likes and/or dislikes, of followers and other users. Systems may use such signals for purposes of updating content creation strategies. In the example of the social media influencer, an intelligent content creation system may use one or more GANs to generate one output artwork based on the expressed preferences of the influencer, i.e., users of the system; another artwork based on the expressed preferences of followers; and a third artwork based on users who later converted to become followers. In accordance with some embodiments, supervised machine learning models may be used to predict the GAN(s) and corresponding parameterization(s) that most align with the expressed preferences of the users. Alternatively or additionally, machine learning models could be used to predict the GAN(s) and corresponding parameterization(s) that most align with artworks that followers have previously liked, shared, and/or purchased. Alternatively or additionally, machine learning models may be used to predict GAN(s) so as to align with the likes, shares, and purchases of users who are likely to later be converted to become followers.

In accordance with some embodiments, machine learning models could be used to predict which of a set of GAN-generated images are most likely to align with various preferences. In one example, alignment with the user's preferences may be assessed. Additionally or alternatively, machine learning models may be used to rank the set of GAN-generated images according to the user's preferences. Alternatively or additionally, other machine models could be used to predict appropriate selections and/or rankings, from sets of GAN-generated images, to determine alignment with the preferences of followers and/or users who later converted to become followers.

As content modifications are presented to the influencer, in the form of one or more selectable output artworks, they may be labeled. Prospective labels may include (but are not limited to) “Most in line with your previous selections”, “Likely to please your followers” and “Likely to help gain more followers”. Various users and/or admins associated with the system (e.g., the influencer) may select what categories to present.

After various analyses, systems operating in accordance with some embodiments of the invention, may learn to generate changes (e.g., conversions to anime characters). Changes may include (but are not limited to) changes that best reflect user preferences and the preferences of users of importance to the users. For instance, in the case of the influencer, systems may learn to propose candidate artworks that avoid certain distortions of her facial features, show good contrast between the influencer and the background, and use a color palette consistent with her brand. To achieve preferred outcomes, systems can employ mechanisms including (but not limited to) adjusting internal parameters used in the artwork generation GANs, as well as filtering and/or ranking proposed artworks based on computer vision analysis of the input images and/or the GAN output images.

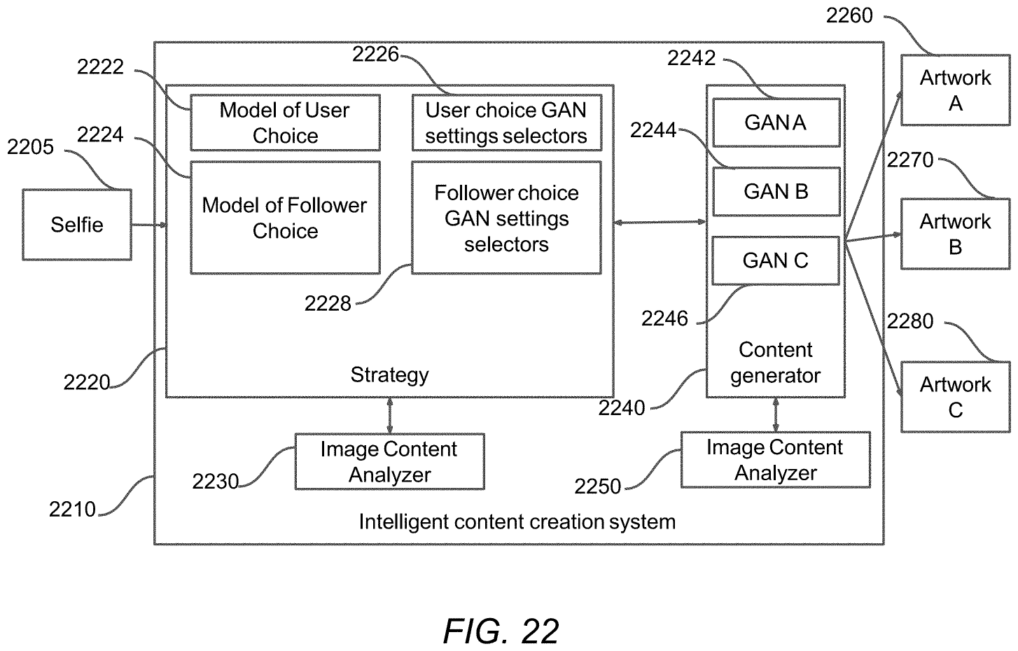

An example process by which strategies, operating in accordance with some embodiments of the invention, may employ machine learning to configure content generators, is illustrated in FIG. 22. Under such processes, artwork (e.g., a photo selfie 2205) may be provided as input to intelligent content creation systems 2210. Content generators 2240 associated with such systems may use multiple GANs. For example, an example content generator may incorporate three GANs, GAN A 2242, GAN B 2244, and GAN C 2246, each of which can be capable of generating new artworks.

Strategies 2220 within systems 2210 may contain models of user choice 2222. Models of user choice 2222 may be used as classifiers that predict which one or more of the content generator's 2240 GANs are best suited to generate new content according to user preferences. An example model of user choice 2222 may be used to assess the best GAN to generate images for the new selfie 2205 when the goal may be to produce output artworks that the users like the best based on their past choices, likes, and dislikes.

Strategies 2220 within systems 2210 may contain models of follower choice 2224. Models of follower choice 2224 may be used as classifiers that predict which one or more of the content generator's 2240 GANs are best suited to generate new content according to content consumer preferences. An example model of follower choice 2224 may be used to assess the best GAN to generate images for the new selfie 2205 when the goal may be to produce output artworks that the users' social media followers like. Models of follower choice 2224 may make assessments based on the past activity of likely consumers (e.g., social media followers), including (but not limited to) NFT purchases, likes, shares, and comments.

Strategies in accordance with certain embodiments of the invention may incorporate multiple additional features targeted to configure content generators. Classifiers used by strategies operating in accordance with certain embodiments of the invention may take as input the original content itself (e.g., the selfie 2205) and/or feature vectors computed for the content using image content analyzers. Strategies may include multiple sets of GAN settings selectors. Sets of user choice GAN settings selectors may be responsible for determining the settings of the content generator GAN(s) selected by the strategy, given the goal of producing artworks that users prefer. Set of follower choice GAN settings selectors 2228 may be responsible for determining the settings of the content generator GAN(s) selected by the strategy, given the goal of producing artworks that the consumers of the users' content (e.g., social media followers) like. Each set of settings selectors 2226, 2228 can contain the ability to set parameters of one or more of the content generator's 2240 GANs.

In accordance with a number of embodiments, sets of settings selectors may contain the ability to set multiple versions of parameters for individual GANs; for instance, user choice GAN settings selectors 2226 may contain one setting selector for GAN A 2242 that represents the parameterizations most commonly chosen by the users for content generated using GAN A 2242. The user choice GAN settings selectors 2226 may contain another setting selector for GAN A 2242 that represents the parameterizations second most commonly chosen by the users for content generated using GAN A 2242. In accordance with some embodiments, a settings selector can store one or more values for each parameter of a corresponding GAN. In one example, a settings selector may store the selection of a preferred reference face for GAN architectures (that may use such a reference when needed).

In more complex configurations, settings selectors may be machine learning models whose input may be the original artwork (e.g., selfie 2205 image). In numerous embodiments, machine learning models may take in vectors, containing information about the original artwork, computed by image content analyzers. In accordance with some embodiments of the invention, the output of the above machine learning models may include predicted values for parameters of the corresponding GAN(s) and/or predicted probability distributions over parameter values for the corresponding GAN(s).

Strategies in accordance with certain embodiments of the invention may utilize outputs of the models of user choice, the model of follower choice, the user choice GAN settings selectors, and/or the follower choice GAN settings selectors to instruct content generators. Content generators may be instructed on which GAN(s) to use and how to parameterize these to produce the candidate artworks. Content generators may use the specified GAN(s) and parameters to produce output images.

Content generators operating in accordance with a number of may apply editing to product images. Example editing may include applying background removal (to produce output artworks that feature white backgrounds). Content generators may use image content analyzers to determine when editing may be necessary. For example, image content analyzers may identify whether generated images contain noticeable artifacts that might be suppressed using blurring and/or resizing.

Content generators operating in accordance with certain embodiments may generate additional images using GANs and/or parameterizations not requested by strategies. For example, this may include attempting to identify parameterizations that do not produce visible artifacts and/or facial distortions for the selfie 2205. Content generators 2240 may request additional GAN choice(s) and parameterization(s) from strategies 2220. This may occur, for instance, in the case that the initial choices and parameterizations did not yield any images without significant artifacts or distortions. In the earlier example, the result of the content generator applying the GANs and parameterizations specified by the strategy 2220, as well as applying any additional edits and generations, can be the creation of three new artworks, Artwork A 2260, Artwork B 2270, and Artwork C 2280. Because different GAN(s) and/or parameterizations were used to make these artworks based on models of users choice and follower choice, information about the rationale for generating each artwork can be output to the user.

As another example, consider a musician who would like to share a series of “teaser” video clips with his fans, each showing a short video of him rehearsing with his band to prepare for an upcoming tour. Each day, the musician may upload 20 minutes of unedited video footage from some part of the day's rehearsal. He can specify using a graphical user interface that he would like to produce an “exciting” 15-second video clip to share. The intelligent content creation system can provide him with five candidate videos. Each one may present 15 seconds of the rehearsal. Chosen times might be different in different candidate videos, but each can attempt to capture content that may be “exciting” based on automated analyses of the visual and audio properties of the clip. Furthermore, each one may apply some audio editing to the video's sound, including (but not limited to) compression and equalization. The first time the musician uses the system, the intelligent content creation system may employ a strategy that configures the audio editing processes to mimic as closely as possible the “sound” of the musician from his last studio album. Further, the video timings can be selected using audio analysis to ensure that each clip mainly includes music, rather than only the musicians talking. The musician can view each of the candidate clips and may notice one that captures a particularly exciting musical moment, but the sound editing of the clip isn't exactly what he wants. He can then request that the system generate some additional variants of this clip, each with slightly different sound editing processes applied. He may listen to the new variants, identify one he likes, and mint it as an NFT to share with his fans. After one or more such interactions, the system can use information about which clips the musician chose to improve its automatic audio editing, ensuring that the sound of future clips most closely matches the musician's desired sound. Furthermore, the musician can instruct the content generation system to take fan engagement with past clips into account, so that it may attempt to adjust its strategy for selecting video edit points and applying audio editing to produce future content that may be more similar to popular past clips.

In accordance with many embodiments of the system, system updates may be determined through modes of obtaining feedback including (but not limited to) panels. In particular, one or more end consumers (e.g., followers on social media) may sign up to participate in a panel. The members of the panel may receive one or more of the present outputs and be asked to rate them. Ratings may be based on but are not limited to how catchy songs are, whether the users feels dancing when listening to it, whether they would like to buy a copy of any one of them, and which ones. The collected feedback may be used to improve intelligent content creation systems. For instance, feedback may be used to train a model used for ranking suggested options presented to the musician. Alternatively or additionally, feedback may be used to train or refine machine learning models that predict good configurations and parameterizations for automated video editing components. Alternatively or additionally, feedback may be used to train or refine a computational analysis component capable of labeling and/or ranking audio content through terms including (but not limited to) how “catchy” or “danceable” a piece of music is, and how well the music matches some other concept and/or property. In accordance with some embodiments, computational analysis components may be tailored to the music of particular musicians, shared across multiple musicians and/or shared across multiple content consumers. The collected feedback may be stored along with demographic profiles of the parties providing the feedback, enabling content creators to select specific demographics and obtain rankings of content based on the feedback.

Systems operating in accordance with some embodiments of the invention may need not be automatic. Additional system configurations may include (but are not limited to) user-initiated and/or initiated by external triggers. External triggers may include (but are not limited to) the user's departure from a foreign country as determined by a GPS on their smartphone, user requests, and/or particular dynamics of follower engagement on social media platforms. Intelligent content creation systems may be operated by social media companies as a part of their services to user bases. The deployment of such systems may be incentivized by the ability for social media companies to be compensated. Prospective benefits may include (but are not limited to) a portion of the sales price, commission, and/or fee (such as a transaction fee). Intelligent content creation systems may also be operated by wallet applications. Wallet applications may operate through the cloud computing network and/or be local on users' devices.

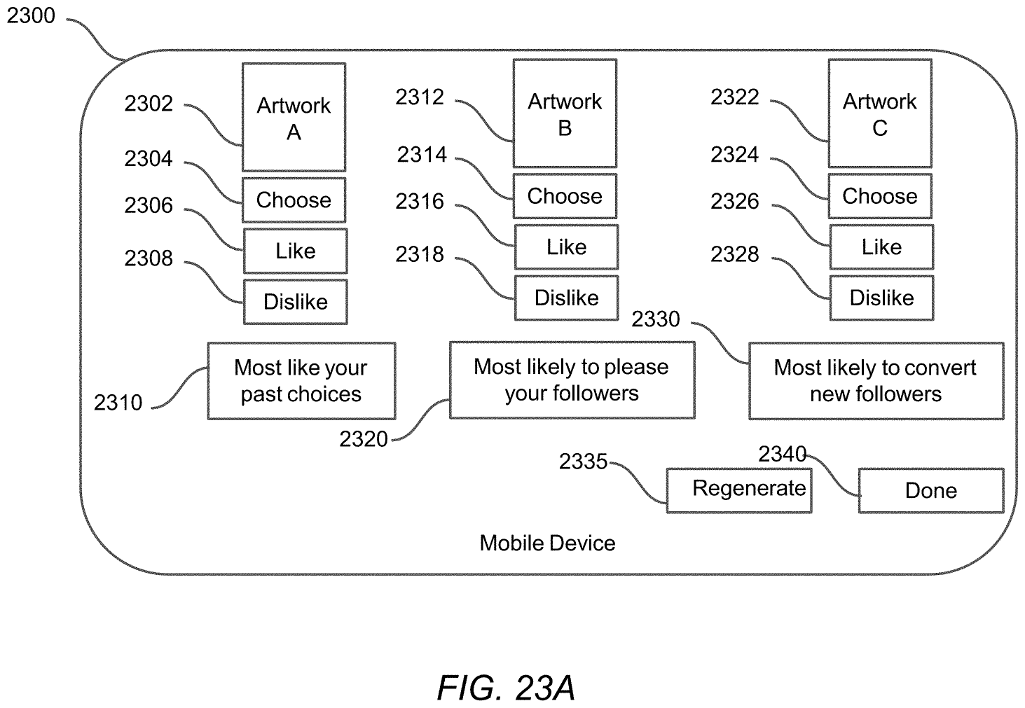

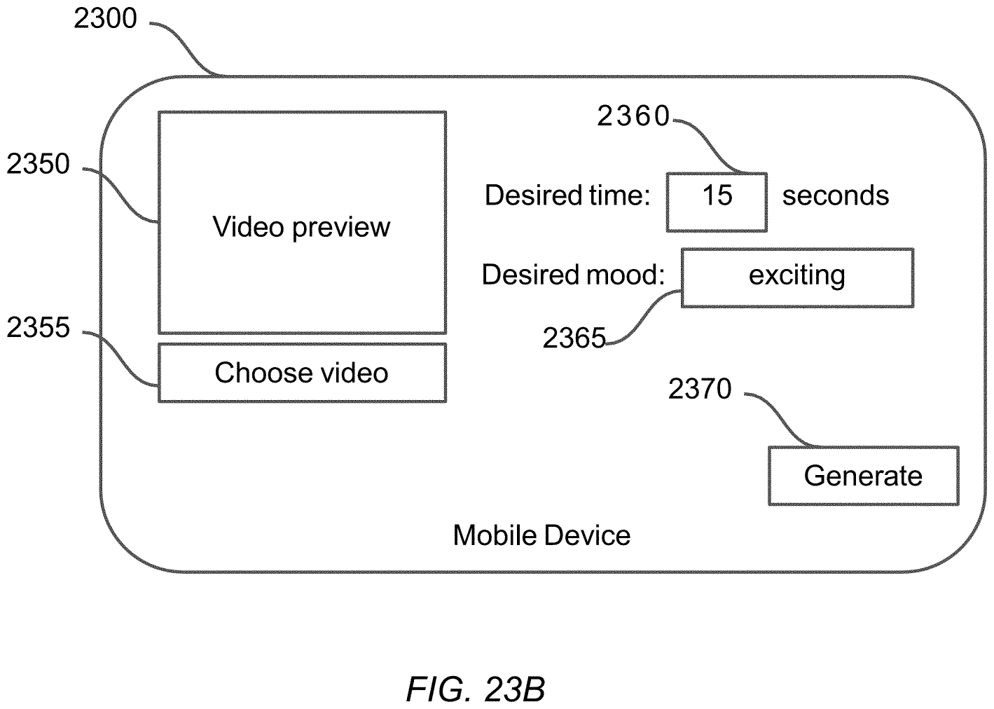

An example implementation of mobile device interfaces for viewing, selecting, and providing feedback on candidate artworks, in accordance with numerous embodiments of the invention, is illustrated in FIG. 23A. Feedback on candidate artworks can be produced by intelligent content creation systems as described above. Applications running on mobile devices 2300 may show created artworks A 2302, B 2312, and C 2322 to users. Applications may enable users to choose one or more of the artworks to be minted to NFTs. For example, applications operating in accordance with some embodiments may use a button 2304 for Artwork A 2302, button 2314 for Artwork B 2312, and/or button 2324 for Artwork C 2322. Applications may enable users to record users' approval (i.e., likes) of any number of output artworks. For example, applications may use a button 2306 for Artwork A 2302, button 2316 for Artwork B 2312, and button 2326 for Artwork C 2322. Applications may, alternatively or additionally, enable users to record that they dislike any number of output artworks. For example, applications may use button 2308 for Artwork A, button 2318 for Artwork B, and button 2328 for Artwork C.

Mobile device 2300 interfaces operating in accordance with various embodiments of the invention may provide descriptions and/or rationale for candidate artworks. For instance, an interface may inform users about classifications including (but not limited to) artworks most similar to past choices 2310 and/or likes; artworks most likely to please social media followers 2320, and artworks most likely to convert new followers 2330.

Applications in accordance with many embodiments of the invention may include additional options for users. Once users record decisions including (but not limited to) choices of artwork for NFTs, likes, and/or feedback, applications may enable users to indicate completion (e.g., a button 2340) and induce the NFTs to be minted. Alternatively or alternatively, users may use buttons 2335 to regenerate new sets of artworks. In such cases, applications may account for any likes and/or dislikes users have previously recorded. The information entered in mobile device interfaces about users' choices, likes, and dislikes can be used to inform future generations through adjustments to the system strategies, as illustrated above.

An example implementation of mobile device interfaces for requesting the generation of new edits, in accordance with some embodiments of the invention, is illustrated in FIG. 23B. New edits may be generated by intelligent content creation systems as described in the rest of the specification. Applications running on mobile devices 2300 operating in accordance with many embodiments of the invention may provide buttons 2355 that users may use to choose videos to use as source material for generated edits. Once chosen, previews of videos 2350 may be displayed in the interface. Users can use applications to enter information about desired edits. For example, users may indicate information including (but not limited to) the desired time, length, and mood of the video. In accordance with certain embodiments, information like the desired time of the video may be indicated through text entry boxes 2360. Alternatively or additionally, information like the desired mood of the video may be selected from drop-down menus 2365. When users have chosen the video and entered any desired additional specifications, they may request (e.g., through a button 2370) that systems operating in accordance with many embodiments of the invention generate the new edits.

As another example, consider a travel blogger who takes many photos and videos of her week traveling through a new city. She may add short voice descriptions and text descriptions of her surroundings, feelings, activities, and food at moments throughout each day. At the end of the last day of this trip, she may log into a social media platform and indicate she would like to generate a new interactive narrative experience based on the week for her followers. Intelligent content creation systems operating in accordance with certain embodiments of the invention may use their strategies to select photos and videos to include in the experience. To do this, image content analysis techniques may be used to identify and analyze the contents of photos and videos. For instance, image content analysis techniques may be used to determine features including (but not limited to): whether images include faces, landmarks, nature, and/or food; which media items capture the same objects; the visual quality of photos and video (for instance determining whether images are in focus and/or well-lit); where audio contains content (such as speech, music, ambient sound, and/or silence); whether speech may be spoken; what language speech may be in; and what the audio quality should be (e.g., whether speech may be likely to be decipherable over background noise).

In the above example, once candidate media is identified for inclusion in the experience, systems operating in accordance with numerous examples of the invention may use GPS data to link selected media to 2D maps of the city. Systems may generate executables that, for instance, allow end users to navigate through virtual city maps and/or the blogger's timeline of local travels while viewing key photos, watching videos, and listening to the sounds of the city around them. Systems may generate text captions or longer text narratives to accompany and guide users as they explore the city. In accordance with some embodiments, systems may generate transcriptions of the blogger's recorded voice descriptions and/or adaptations of the blogger's own text descriptions (adapted to fix spelling and grammar). Alternatively or additionally, text generation may make use of predictive language models, including (but not limited to) models like GPT-2 fine-tuned on previous posts, using text and voice transcriptions as prompts to generate new text. Additionally or alternatively, new text may be generated from data including (but not limited to) images, audio, video, text snippets, GPS, time and date, examples of text previously written by the same person, and other information that may be provided to the system by users, the system's creators, the platform, other platform users, and others.

In this example, generated text captions and narratives could be presented to end users in various ways. Generated text may be provided in forms including (but not limited to) text on-screen in the language of the content creator, text on-screen in another language such as the native language of the end user, as a voice rendered in the language of the content creator, in a simulation of the voice of the content creator, as a voice rendered in another language, and in a simulation of the voice of the content creator speaking their own language. Intelligent content creation systems operating in accordance with a number of embodiments may present users with several candidate immersive narrative experiences. Additionally, supplemental information can be presented that can aid users in comparing and assessing each experience. For instance, systems may present users with candidate experiences that differ in factors including (but not limited to) the length and/or pace of playthrough, the number of media items included, the narrative text, and the visual assets (for instance differing in color palette and font).

Systems operating in accordance with a number of embodiments may present users with the opportunity to interact with each narrative experience. Systems may present users with text summaries of key facts about each candidate experience, including (but not limited to) playthrough length, the number of media items included for each day, the number of food photos each day, text summaries of the audio present in each video and/or audio clip in the experience, etc. Systems operating in accordance with numerous embodiments may present users with text transcripts of all narrative text to be evaluated and/or corrected. Systems may present users with visual representations of the experience. For instance, users may receive a 2D map of the city with markers for all the locations with corresponding media, thumbnails of the videos, and image thumbnails included.

Creators may determine content inclusion given the selection of media and the scope of the generated text narrative. In the above example, the blogger may, for instance, note that a few of her favorite photos have not been included and/or that the generated text narrative includes some grammatical errors. In such cases, they may manually instruct systems operating in accordance with some embodiments to re-generate experiences using the included photos and/or specify how the grammatical errors should be corrected. Systems may re-generate the output as instructed, adding the photos, correcting the grammatical errors, and adding some new text to the narrative to describe the newly included photos. The systems may provide creators with executable interactive narratives and/or provide text summaries and visual aids to clarify the intended expression. In accordance with some embodiments, systems may highlight the new changes in the text summaries and visual aids so the changes can be approved or rejected by the creator. Creators may then select their experiences to be minted as NFTs and shared with their followers. This may then enable users to interactively explore their experience of the city through the NFTs.

Systems operating in accordance with some embodiments may be configured to adapt strategies for future content creation based on automatic, creator, and/or follower actions. In some cases, systems may favor the creation of experiences that feature particular lengths and/or narrative pacing. Alternatively or additionally, systems may be fine-tuned on the creators' manual corrections of previously generated content. Interactive experiences deployed to followers may generate records of actions within the experience. Systems may record the fact that followers engage more with particular photos and videos. Systems may not that followers tend to spend more time exploring certain parts of the city that feature landmarks and/or that include a particular narrative tone. This information can inform strategies in their selection of media and/or guide the seeding/refinement of the language generation models for future experience creation.

The above approaches to intelligent content creation incorporating feedback can be used in a variety of contexts beyond social media. For instance, the travel blogger in the example above may use the same content creation system in the same way even if she may be publishing content on her private website rather than on an existing social media site or other third-party platforms. In some cases, there may be no opportunity for feedback signals from social media platforms in the form of tracking follows, likes, shares, reactions, and so on. However, content creators releasing content on independent sites and/or apps may have similar feedback signals available including (but not limited to) the ability to track page views, time on page, downloads, and purchases; the ability to track comments and analyze comments for sentiment and identity; the ability to prompt for on-page and/or in-app feedback; the ability to prompt access to reviews in an app store; etc. Feedback signals for non-social media platforms can be used instead of or in addition to feedback signals tied to social media platforms.

Even when content creators do not use feedback from fans, followers, and purchasers, the above intelligent content creation approaches may be applied to feedback from the creators themselves and/or other sources. Other source may include (but are not limited to) other content creators using the same creation platform(s) to do similar work, and people performing tasks on crowdsourcing platforms. For example, consider an indie musician with a small but growing fanbase who may be using a home recording studio with digital audio workstation (DAW) software to record a new song. Early in the songwriting process, the songwriter may use one function of the intelligent content creation system to explore variations on the song lyrics he has written. He may provide the system with a text file containing his lyrics. The system may output several new potential versions of the lyrics. For instance, the system could use computational models of pronunciation, prosody, and semantics. Alternatively or additionally, the system could use language models that capture information about the likelihood of certain words and word sequences in the language generally and/or in song lyrics in particular. Alternatively or additionally, systems may use computational models of sentiment, language models capable of generating new text in certain languages given a prompt, and/or other approaches to analyzing and generating language.

Systems operating in accordance with some embodiments may enable the musician to create different versions of the lyrics that may replace particular words to achieve a more consistent and/or different rhythm, to avoid clichés, to better rhyme, etc. Alternatively or additionally, systems may enable the creation of versions that complete uncompleted verses, add entirely new verses, etc. Various content creators (e.g., the musician) may iteratively select generated text, make their own edits, try lyrics as they are developed, and return new changes to the system to generate new alternatives. Each time users indicate that they may like and/or select a piece of text systems can use the choices to attempt to improve future text generation to reflect their preferences.

Eventually, the musician may finalize the lyrics and begin recording the song. Some of the musical material for the song may involve audio tracks recorded in his home studio, including (but not limited to) him singing and playing guitar; samples taken from sample libraries; synthesized musical material (for instance, he might play one track on his home MIDI keyboard and it may be rendered to sound like a vintage 80s synth such as the Casio CZ-101), etc. He may be reasonably happy with a version of the song and use another function of the intelligent content creation system to explore variations.

Systems in accordance with some embodiments may allow users to specify what should be varied. For example, the musician may explicitly request that he would like to create versions of the song with different drum tracks. Here, the intelligent content creation system may use a strategy for creating drum tracks that draw heavily on information about drum tracks made by other creators. For instance, a computational analysis of the musician's song, including (but not limited to) the lyric text, audio, MIDI/symbolic musical data, and other data available from the DAW including metadata, can reveal information about its tempo, style, and mood. Systems may be configured to search their records to identify similar songs by other content creators, songs whose creators have granted permission for their work to be adapted, remixed, and/or used as training data, songs that have sold more successfully, etc. The musician's system may then assemble a series of candidate drum loops, matched to the tempo of this particular song, one or more of which the musician may choose as the basis of his drum track. The musician may then use manual editing and/or further computational processing to complete the drum track for the whole song.

The musician may select a drum loop that may be an adaptation of an existing loop and/or which may be generated by a machine learning system trained on existing loops. In such cases, sales of NFTs minted from songs created with this drum loop may be used to generate revenue for the creator(s) of the original loop(s). Payment may be governed according to policies within NFT smart contracts and/or other contracts and user agreements. In this instance, the strategy for drum loop generation may not be influenced substantially by the loop choices of the musician. Instead, strategies in accordance with several embodiments of the invention may update gradually as systems' bodies of music (taken from all users) grows and feedback from content creators and/or fans may be received. Finally, once the constituent recordings are complete, the musician may use the DAW to mix the individual tracks and master them into a recording, using the combination of automated and manual editing available to him in the DAW.

Before release, the musician may use another function of the intelligent content creation system to generate a final set of variants, for different editing and mastering. Systems may be capable of creating new edits by interfacing directly with the DAW through an API. System strategies may first generate sets of candidate edits, each with different mixing and mastering processes. The mixing and mastering parameters and processes used to create these candidate edits may be determined in whole or in part by machine learning models trained in advance on music mixed and mastered by expert human audio editors. Alternatively or additionally, the machine learning models may be trained in advance on data collected from feedback from music listeners convened in panels. Alternatively or additionally, the machine learning models may be trained from “crowd workers” on Amazon Mechanical Turk (MTurk) and/or similar crowdsourcing platforms for the purposes of obtaining information about listener perception and/or preferences of different approaches to audio editing. Such feedback can be provided through modes including (but not limited to) surveys, MTurk classifications, and corresponding user interfaces (UIs) on other competing platforms. In accordance with various embodiments, the parameters and processes may be determined in whole or in part by audio editing actions undertaken by other users of the intelligent content creation system. Alternatively or additionally, these parameters and processes may be determined using a combination of such approaches and/or using other approaches.

Intelligent content creation systems in accordance with many embodiments may present sets of candidate edits back to users for evaluation and/or selection. Alternatively or additionally, systems may present the set of candidate edits, or portions thereof, to new crowdsourcing workers. In the above example, candidate edits may be presented in the context of listening tasks constructed to infer listener preferences. Inferred preferences may be used to filter and rank the sets of candidate edits before presenting them. Final sets of candidate edits presented back to users may be presented alongside information about how various edits were constructed and/or why they were suggested. For instance, one edit may be labeled “This edit sounds most similar to edits made by experts working in this genre” and another may be labeled “This edit was preferred by crowdsourcing workers who live in your country and report frequent listening of this genre.” Intelligent content creation systems may use user selections and/or the outcomes of the new crowdsourcing listening activities to refine strategies for editing future tracks (by the musician and/or by other users).

In contexts where the training of AIs and/or machine learning algorithms may be performed based on multiple sources. Training sources may (at least in part) include (but are not limited to) input from crowdsourcing workers, recorded demographics associated with the workers, scores associated with the workers (including (but not limited to) the number of HITs the worker has performed), etc. Systems in accordance with numerous embodiments can generate scores based on alignments between the inputs provided by workers and/or decisions made by influencers associated with the artwork generation. Systems may therefore give greater weight to workers whose feedback supports the preferences of the influencer.

As suggested above, systems operating in accordance with a number of embodiments may incorporate various score systems. Success scores of the accepted artwork may be associated with, but not limited to the number of likes it gets, the number of clicks it gets, the number of conversions it gets associated with, etc. Based on the success scores, workers supporting the creation of this artwork may get an increase in worker scores. Worker scores may determine, but are not limited to the weight associated with the input of the worker, and may the number of financial benefits, such as bonuses, that the worker receives.

Systems and techniques directed towards minting NFTs over social media, in accordance with various embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 18-23B can be utilized within any of the NFT platforms described above.

B. Influencer-based NFT Promotion

In accordance with some embodiments of the invention, NFT smart contracts may be configured to enable inherent evolution, spawning and/or peeling capabilities over social media platforms and NFT marketplaces. Evolution, spawning, and peeling are disclosed in co-pending application U.S. Provisional Patent Application No. 63/275,713, titled “User-Specific Evolution, Spawning and Peeling,” filed Nov. 4, 2021, the disclosure of which is incorporated by reference herein in its entirety.

For example, NFTs may be pre-configured by artists (i.e., content creators) to be purchased by one or more individuals, with entities known as editions. Editions may refer to NFTs that represent the same asset, but with different transaction hashes, effectively providing a plurality of ownership and access to the asset. Policy conditions associated with, but not limited to, editions may enable buyers to resell NFTs with royalties benefitting the creator(s) (e.g., a musician). The policies may also enable the current holders of the NFTs to spawn (or generate) one or more NFTs from the purchased NFT. The spawned NFTs may exist within the same royalty structure, enabling a grassroots ability to mint additional tokens to meet the ownership demands. For example, a musician may create a song and an associated single NFT for sale for $1 with policies that include: (1) any single NFT may be re-minted, and/or spawned, as a one-time event into two new NFTs representing the same asset by the current NFT holder, and (2) all NFTs in the lineage must sell for $1, with a 60% royalty going to the creator. In this example, a single NFT might spawn into a lineage of purchased 1,000,001 NFTs whereby the creator earns $1 for the first NFT and $600,000 (collectively) for all spawned NFTs that are successfully sold, for a total of $600,001 in proceeds. Examples of spawning are disclosed in U.S. Provisional Patent Application No. 63/275,713, titled “User-Specific Evolution, Spawning and Peeling,” filed Nov. 4, 2021, the disclosure of which is incorporated by reference herein in its entirety.

In one example situation, an NFT buyer that successfully sells two spawned NFTs may receive 40% commission (less any transaction fees) and/or an $0.80 flat fee for successfully selling the spawned NFTs in the prior example. The same buyer might choose to sell their original NFT for $1.00. In accordance with some embodiments, an original NFT may be considered inferior to an available spawned NFT that has an ability to still spawn two more NFTs. In this scenario, it might make sense for the creator to enable an NFT to sell for $0.20 once it has exhausted its spawning capability. This can be expressed by a policy associated with the content of the NFT. The NFT creator might, alternatively or additionally, choose to create the first NFT with a creator option to mint additional editions. This may be used in the event that the lineage of one or more of the initially released editions are “squatted-on” by the early buyers.

Crypto-wallet functionality may enable the minting of spawned NFTs. The creator policy may enable or disable current NFT owners from enjoying continued access to the asset upon sale of the NFT that the current NFT owner bought/paid for. In this manner, the creator and current NFT owner may both enjoy an economic appreciation of the asset as their influence spreads and popularity increases. Creators may enjoy continued streams of royalties based upon marketplace demands. Creators, by policy, can control the pricing when they wish. For instance, a musician creator may specify a single price for which all spawned NFTs must sell at, a minimum and/or a maximum price. Similarly, the creator may specify rules governing evolution and/or peeling, disclosed in U.S. Provisional Patent Application No. 63/275,713, titled “User-Specific Evolution, Spawning and Peeling,” filed Nov. 4, 2021, the disclosure of which is incorporated by reference herein in its entirety.

Spawning “rules” may be determined by a first original NFT. For example, the first NFT may state how many additional NFTs may be spawned, how many times an NFT may be spawned etc. The first original NFT may also define how many generations it may be possible to spawn, should there be a limit. Policies governing spawning is incorporated in NFTs, and/or be referenced by NFTs. For example, NFT policies may be reference using a URL and/or a name of the policy. In accordance with some embodiments, policies may be publicly accessible, and/or accessible to users of the NFT.

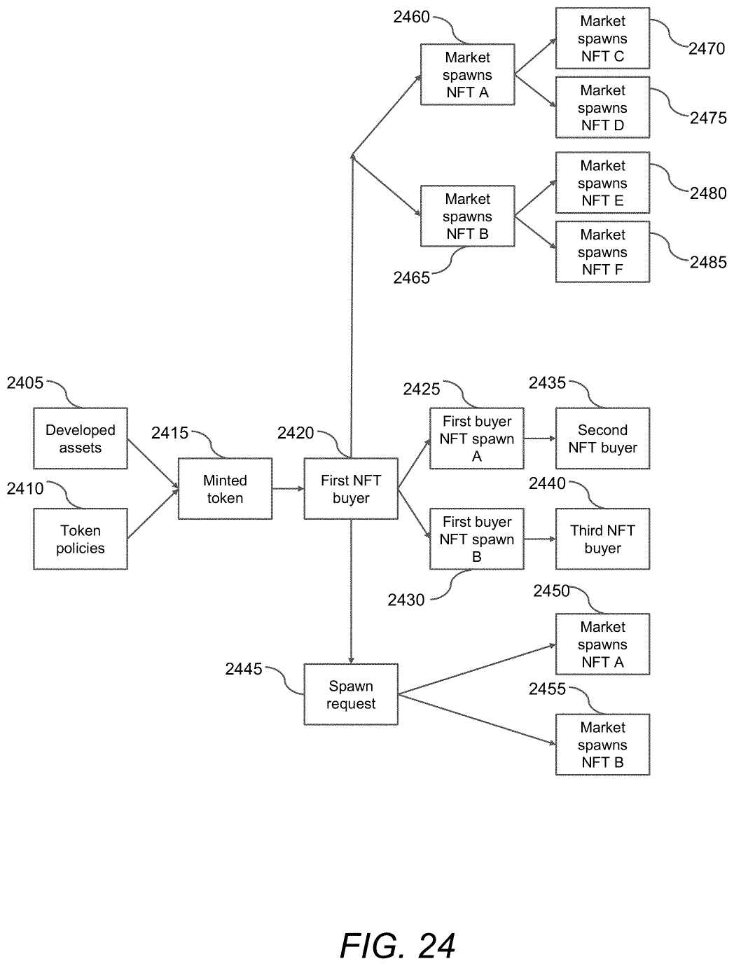

A system for NFTs spawning new additional NFTs, in accordance with various embodiments of the invention, is illustrated in FIG. 24. As mentioned above, content creators may develop assets 2405, for example a song file, to have minted into tokens. Content creators may also set policies for the sale, lease, and/or consumption of tokens. In this example, a policy can provide for a 50% royalty on the first and all subsequent NFT sales in a lineage of NFTs (i.e., NFTs spawned from the song file NFT). Another policy may enable NFT buyers to spawn two additional NFTs for sale to two additional buyers with the same terms. Systems in accordance with some embodiments of the invention may allow creators to generate (and/or authorize generation of) minted NFTs 2415 related to the asset 2405 and policies 2410.

In accordance with many embodiments, NFT buyers 2420, 2435, 2440, may purchase NFTs 2415 under the policies 2410 established by the content creators. A first NFT buyer 2420 may purchase the NFT 2415 and be provided access to the asset(s) 2405. Assets in accordance with some embodiments of the invention may be protected through systems including (but not limited to) digital rights management and cryptographic encryption. Buyers may like NFTs 2415 and wish to further “publish” the work by spawning additional NFTs from the first NFT, as permitted by the policies 2410 set by the creator. In the above example, the first NFT buyer 2420 may choose to generate two spawned NFTs from the initial NFT 2415: first buyer NFT spawn A 2425 and first buyer NFT spawn B 2430. A second buyer 2435 may purchase the first buyer NFT spawn A 2425 and a third buyer 2440 may purchase the first buyer NFT spawn B 2430. Both the second 2435 and third 2440 buyers may continue the sequence by making up to two additional NFTs under the policies for the initial NFT. As such, the initial NFT 2415 may cascade to many additional buyers. Additionally or alternatively, NFT buyers 2420, 2435, 2440 may elect to resell the initial token 2415 after spawning additional tokens. In accordance with a number of embodiments, NFT buyers 2420, 2435, 2440 may elect to resell the initial token 2415 before spawning tokens. NFT policies may enable new owners of the first NFT 2415 to spawn additional NFTs and/or preclude further spawning after an initial spawning event. Resale of the first NFT 2415 may preclude the first buyer from enjoying access to the asset. The universal nature of the inherited NFT policies may control the various possibilities through the cascade of ownership.

In accordance with some embodiments, NFTs may be spawned with the assistance of NFT marketplaces. In such instances, the spawning of NFTs may be performed by NFT marketplaces rather than through automated smart contracts and/or wallet-initiated activity. For example, the first buyer 2420, may request 2445 permitted NFT spawning from the NFT marketplace. Marketplaces operating in accordance with a number of embodiments of the invention may have contractual obligations to do so. As such, an example marketplace may mint NFT A 2450 and NFT B 2455 at the request of the first buyer 2420. In accordance with several embodiments, buyers who spawn NFTs through marketplaces may be permitted to sell the newly created NFTs through those same marketplaces. Marketplaces operating in accordance with some embodiments may substitute established processes of minting NFTs with the lazy-minting process elaborate upon below.

Cascades of NFTs may be used to provide royalty flows for creators. The first buyer 2420, finding the asset desirable, can enable the spawning of NFT A 2460 and B 2465 through a variety of modes including (but not limited to) marketplaces, wallet interfaces, and smart contracts. The two new tokens may be purchased by secondary buyers, who also desire to spawn more NFTs 2470, 2475, 2480, 2485 in the lineage. As such, tertiary buyers may purchase additional NFTs C 2470, D 2475, E 2480, and F 2485, establishing a total of 7 purchased NFTs in the cascade of purchased NFTs. In this example, the creator may have sold the first NFT 2415 for $1 and has a policy that all spawned NFTs must sell for $1. Ignoring commissions, blockchain mining and/or validator fees, and resale royalties for clarity, the creator may then receive $0.50 from every subsequent NFT purchase. Since the creator receives $1 from the first sale, $0.50 each from the sale of NFTs A through F would enable a creator income of $4. When the buyers of NFT C through F spawn 2 more NFTs each the creator's income can approximately double again, and so on with each additional layer of NFT spawning. At some point, demand may slow ensuring not all spawned NFTs will sell. From the perspective of the first NFT buyer 2420 (as well as all subsequent buyers), resale royalties may allow them to be essentially reimbursed for the cost of the initial purchase. For systems operating in accordance with some embodiments of the invention, any number of economic policy configurations may be implemented to enable numerous possible financial outcomes for the creator and/or the influencers.

In accordance with some embodiments, NFT marketplace platforms may be configured to lazy-mint and/or mint NFTs with one or more assets in manners that enable NFT resellers to spawn one or more NFTs from existing owned NFTs. In such cases, NFT reseller may simultaneously incorporate the policies of the original NFT on behalf of the creator and the current holder of the NFT. Here, lazy-minting can correspond to the action of preconfiguring an asset for NFT sale without minting the token to the blockchain until a sale may be complete. Lazy-minting can enable sellers and marketplaces to avoid costly minting fees (e.g., gas fees) for items that never sell and/or to delay fees until sales may be executed.

In the above illustrative situation, the holder of the original NFT may be permitted to retain and/or sell the original NFT. Retention and sale may depend, in part, upon whether the holder intends to have continued access to the asset. Similar benefits may accrue to the creator and buyers of the NFTs as in the spawning example above. Marketplaces operating in accordance with some embodiments may be authorized to implement various policies based upon contracts, and/or similar agreements, with the creator. Alternatively or additionally, such actions may be based upon the pre-configured smart-contract terms of the initial NFT.

One example policy of the elements in an edition of NFTs may be a lottery system. In such cases some subset of the NFTs (e.g., three editions), may be associated with a benefit provided to an acquirer of the NFT. An example benefit may be a cash prize of 2 ETH. This “randomly awarded” benefit (or bounty) may be paid for by a small royalty that may be paid to a party, upon transfer of ownership of the associated NFT. In some embodiments, the determination of what NFTs in the edition “win” may be determined upon detection of a triggering event. Such policies may be therefore a form of evolution. Evolution is disclosed in co-pending applications U.S. Patent Application No. 63/240,953, titled “Methods for Conditional Transaction Tokens, Secure Sharing of Token Assets, Wallet Spam Protection, and User Interfaces for Acceptance of Terms,” filed Aug. 29, 2022; U.S. Provisional Patent Application No. 63/240,953, titled “Evolution of Tokenized Artwork,” filed Sep. 5, 2021; U.S. Provisional Patent Application No. 63/245,976, titled “Token Content Unlocking Method,” filed Sep. 20, 2021; U.S. Provisional Patent Application No. 63/248,570, titled “Content Evolution Techniques,” filed Sep. 27, 2021; U.S. Provisional Patent Application No. 63/254,062, titled “Token Evolution with Physical Embodiment,” filed Oct. 9, 2021; U.S. Provisional Patent Application No. 63/255,032, titled “Non-Fungible Token Peeling,” filed Oct. 13, 2021; U.S. Provisional Patent Application No. 63/275,713, titled “User-Specific Evolution, Spawning and Peeling,” filed Nov. 4, 2021; and U.S. Provisional Patent Application No. 63/291,411, titled “Robust Personalization with Applications to NFT Evolution,” filed Dec. 19, 2021 the disclosures of which are incorporated by reference herein in their entireties. In some example uses, the triggering event may be a known time, such as midsummer 2023 at noon EST. In another example use, the triggering event may be unknown, and/or inaccessible through inspection of the NFTs and their policies. The NFT may, for example, rely on a trigger provided by an oracle, wherein the oracle computes a function that may be not publicly known (but may be verified) like the creator of the NFTs.

In accordance with some embodiments of the invention, original NFTs used in the lottery system may include one or more encrypted fields. Such fields may be not inspectable and/or understandable without access to a decryption key. In some cases, the original NFT may be minted/created by a lottery company that holds the decryption key. Encrypted fields may include functions that create random numbers and/or other types of output. Alternatively or additionally, encrypted fields may include static random values. In accordance with a number of embodiments, the NFT may instead be completely open and inspectable and may for example have a counter, value, and/or another unique identifier.

In one example, a lottery company may spawn 1000 NFTs that they sell for 10 dollars each. Any spawned NFT may in turn be spawned once into 10 spawned NFTs. Each original NFT may regulate that 1,000,000 NFTs may be spawned in total. When users purchase and/or acquire a spawned NFT, for the price of 10 dollars, the users may spawn its NFT into 10 spawned NFTs. The users may sell the spawned NFTs for a set price (e.g., 10 dollars each) and keep a portion of the sale price (e.g., 2 dollars) while the rest automatically goes to the lottery company. In accordance with many embodiments, NFTs that are unable to spawn may be priced lower. Beyond that, market prices, within a given range, may be used to set the cost of an NFT. This may then allow any users who buy an NFT the potential of earning at least 20 dollars should the total number of NFTs not yet have been reached.

The lottery company may at the end, when the last NFT has been spawned and sold, generate a random value corresponding to a unique value and/or identifier of the NFTs thus making that NFT the winner of the lottery. Such a value can be based on observed events and data in a way that makes it publicly verifiable, e.g., allowing users who did not win to verify that the computation of the winner was done in the proper manner. It may not enable such users to determine the winner, only that they did not win, and that this was not an arbitrary decision. Alternatively or additionally, once the total number of NFTs have been spawned, the lottery company may provide the decryption key and/or decommit to a specific number/value that corresponds to a winning NFT. In accordance with some embodiments, lottery companies may keep track of the number of spawned NFTs because they are all immutably written on the blockchain. The users may then decrypt the encrypted field and see if the number/value of their NFT(s) match the specific number/value that corresponds to the winning NFT.

Users having an NFT that has a specific number/value that corresponds to the winning NFT may then share the prize. For example, the prize may be a portion of the income the lottery company received from all the spawned and purchased NFTs. All users who could spawn and sell NFTs may make a profit regardless. Additionally, users could also win the cash prize from the lottery company. The only ones who may not benefit under such a system may be the last users who could not spawn anymore, due to the maximum number of spawned NFTs having been reached.

In accordance with some embodiments of the invention, entities may use NFTs to fractionalize ownership of non-fungible assets. For example, an owner of a non-fungible asset (e.g., a specific race car) may want/need some extra money. In this example, the car may be worth 100,000 dollars. The owner may mint one or more NFTs (e.g., 10 NFTs) and set, over a platform and/or marketplace operating in accordance with certain embodiments of the invention, a value of each minted NFT to 2000 dollars. The owner may then sell these NFTs to one or more buyers. In accordance with certain embodiments, an NFT may give the buyers corresponding ownership of the race car. Alternatively or additionally, the NFT may give the buyer a right to a percentage of a profit that the race car generates. Such rights may be time-dependent (e.g., the profit percentage is allowed for a year). Alternatively or additionally, the NFT may give the owner of the NFT the right to display some type of advertisement associated with the asset (e.g., a sticker on the race car).

In accordance with numerous embodiments, original owners may define different rules for the original NFTs when they are minted. For instance, the owner may decide that an original NFT may be spawned once and any spawned NFT may not again be spawned. Such a rule might be desirable for the owner so that he/she may limit the total number of NFTs. Specifically, the number of NFTs representing an asset, such as when 100 NFTs of a single music file are issued as editions, may be increased with spawning events. Conversely, when NFTs are issued to represent fractional ownership of an asset, the ownership of an individual NFT may be diluted by the action of spawning new NFTs, or sub-fractions of ownership of the original asset.

In the example, the buyer of an original NFT may want to sell half of their NFT. Sale of the NFT may correspond to a sale of actual fractional ownership of the race car. In accordance with some embodiments, the buyer of the original NFT may spawn the original NFT into one or more additional NFTs. In such cases, this may cause the value of the original NFT to be halved and the spawned NFT to have a value of half of an original NFT. Values of NFTs may vary depending on varying factors including (but not limited to) features of the asset (e.g., the success of the race car in competitions, age of the race car, etc.). Systems operating in accordance with a number of embodiments may govern how many spawned NFTs can be generated from an NFT. For example, when an NFT owner initiates spawning, marketplaces/platforms could ask how many units to spawn, after which no further spawning of this NFT, its spawned copies, can be allowed.

Other forms of gambling and/or fractionalization may be supported by related mechanisms. For instance, off-chain oracles may provide information about what horse won a horse race. Holders of one or more NFTs corresponding to the winning horse may receive a payment corresponding to the winnings on this horse. Such amounts may be fixed, such as $1000. In such cases, the cost of acquiring the NFT at any point in time may reflect the odds of winning, as perceived by the buyers and sellers. For example, the cost of the NFT could simply be a market price, and determined by market forces. Alternatively or additionally, an unbiased entity may determine gambling odds.

The use of NFTs in such fractional ownership and/or environments may enable users to associate smart contracts with any of the constituent NFTs. As such, users may bet on and/or benefit from other features than being the winner. For example, some people may be interested solely in betting on whether horse A will beat horse B, but without caring whether either horse wins the race. This can be expressed using a smart contract that results in a payment of a stated crypto currency, including a stable coin. The NFT with the associated contract can be bought and sold at market prices. In some instances. Gambling such as this may occur with a limitless number of everyday activities from sports to presidential election outcomes. A Formula 1™ race may feature any number of oracle-assisted crypto wagering outcomes. In another example, the organizers of a racing team may elect to sell portions or all of a new or existing race car in an effort to better fund the team. Fractional ownership of the race car can enable the automatic awarding of race prize proceeds to the fractional owners of the winning vehicle. Fractional owners may be incentivized by non-monetary benefits, including (but not limited to) being allowed to collectively design and/or select a logo representing the fractional owners. Such logos may in the case of the F1 race, be placed on and/or associated with the race car. The size and prominence of the logo may be based on features including (but not limited to) the number of investments made and/or the amounts of royalties from NFT re-sales received by the issuing entity.

Users who believe a particular outcome is likely (e.g. a particular horse may be more likely to win than what the odds suggest) may promote their expected outcome to other parties (e.g., social media friends and followers). Increasing the number of supporters may benefit all current owners of NFTs associated with the outcome/asset (e.g., the horse, the race car). Therefore, royalty policies associated with all of the NFTs associated with the outcome/asset in question may result in small payments being made to promoters when other parties are convinced to participate. In accordance with some embodiments, incentives may include a particular discount code issued by the promoter. In such cases, promoters may generate references to NFTs and/or collections of related NFTs, even when not owned. This may allow the promoters to receive benefits when there may be purchases associated with the reference. Buyers may benefit from using the reference, as this can provide discounts and/or other incentives. Additionally or alternatively, the owner of the NFT that may be sold can also benefit (e.g., when there may be an associated increase in the value of the NFT). Specifically, in accordance with some embodiments, royalties may be related to the difference between the sales price and the price the NFT being sold was purchased for. The discount the buyer receives may be taken out of the royalty provided to the promoter.

As NFTs spawn, evolve, and/or otherwise change, they may become associated with other types of blockchain. For example, a first NFT may live on the ETH blockchain, but as it spawns, the new versions may be placed on the SOL blockchain. One reason for doing this may be to lower transaction costs. When a first NFT evolves and its new content is associated with a content description on another blockchain, the new NFT may be governed by the same ownership transitions as the original NFT from which it evolved. Thus, this can correspond to the creation of a new representation, e.g., on a different blockchain to the original NFT. In such cases, an ownership change of one representation may cause an ownership change of the other. In some instances, the change may be directional, e.g., the sale of the first NFT causes the automatic transfer of ownership of the second, whereas no ownership change can be initiated for the second one without being prompted by a recorded ownership change of the former.

Original NFTs may be recorded on blockchains with higher security than the blockchains of evolved, spawned, and/or changed versions. In such cases, the original NFTs may carry the ownership information whereas the representations on the second chain may carry the content. In cases where there may be a security problem with the second chain, this may prevent an incorrect ownership assignment. In some embodiments, token owners may specify whether the tokens should be represented on one or more blockchains. Additionally or alternatively, the token owners may specify what policies for transfer and content representation apply (e.g., in a type element associated with the newly minted token). For example, a token that exists on blockchain A and for which the owner requests a replication on blockchain B may include control information that specifies whether users may initiate ownership changes for the latter tokens and/or whether ownership may be always mirrored on both blockchains.

NFTs that may be generated in response to spawning events may have royalty policies that differ from the royalty policies of the NFTs from which they spawned, but remain in compliance. For example, the result of the spawning may have a royalty policy that gives 75% of the sale value to the originator of the NFT from which this NFT spawned whereas that original NFT may have a royalty policy that provides only 5% royalty. NFTs may be possible to spawn any number of times, but based on the hierarchy of the resulting NFT, royalties may make spawning less attractive.

Systems and techniques directed towards promoting NFTs over social media, in accordance with certain embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIG. 24 can be utilized within any of the NFT platforms described above.

C. Token Interactions over Social Media

Systems operating in accordance with some embodiments of the invention may enable users to share access to tokens among connected users of social networks. Here, access may include, but is not limited to social media contacts knowing about the ownership of tokens, capacity to know about the recent addition of access rights to tokens, capacity to know about the consumption of tokens, capacity to know about the compatibility of token to which contacts have access rights and tokens to which users have access rights, and capacity to render tokens (where rendering may include playing, displaying and otherwise using the token).

In accordance with some embodiments, token use may take various forms. For example, token use may combine sensory output from devices including (but not limited to) displays, speakers, tactile output units (such as vibrators), and units controlling the temperature in rooms, (such as control units connected to thermostats, heaters, fans and/or air conditioners. Rendering access may be full and/or limited. In accordance with some embodiments limited rendering access may correspond to lower resolutions, segments of contents (e.g., only one layer of a digital work, levels 1 and 2 of a game, and/or a limited number of plays, such as only 2 plays per week).

In accordance with many embodiments, access rights can be governed through various forms including (but not limited to) matrices. Matrices may indicate what rights to what tokens are granted to what groups. Groups may include one or more contacts (e.g., over social media). Additionally or alternatively, contacts may include direct contacts (e.g., friends) and/or indirect contacts (e.g., friends of friends). In accordance with certain embodiments, access rights may include the capacity to find tokens when performing searches. For example, Alice may perform a search for all tokens among her direct contacts that are compatible with tokens that Alice owns and/or has acquired a license for. The compatibility of two or more tokens may indicate whether one of them can obtain, as input, data produced as an output from another. Two or more compatible tokens may communicate using secure APIs, and/or with the communication may be facilitated by a social media application.

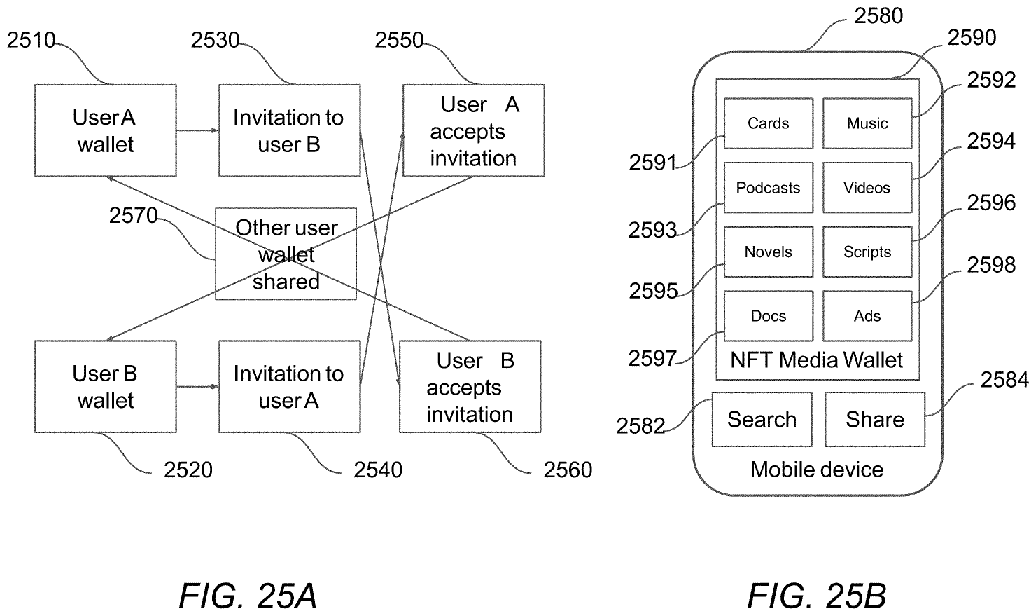

A linking process using the media wallet functionality of two wallets, operating in accordance with certain embodiments, to share tokens is illustrated in FIGS. 25A and 25B. For example, user A wallet 2510 and user B wallet 2520 may exist with the functionality. Both users may wish to share and/or link their wallet contents with the other user. User A 2510 can issue an invitation 2530 to user B 2520. Additionally or alternatively, user B 2520 issues an invitation 2540 to user A 2510. Assuming that the invitation(s) to share wallets are accepted, 2550, 2560, systems operating in accordance with some embodiments of the invention may share 2570 the contents of the two wallets are shared in step 2570. Sharing wallets may, but are not limited to, allow the NFT content to interact across users wallets. In accordance with some embodiments, more fine-grained sharing can be performed, including (but not limited to) directories and subdirectories of wallets. Sharing may be conditional on occurrences including (but not limited to) other sharing actions.

An example implementation of an NFT media wallet 2590 functionality within social media mobile application systems is illustrated in FIG. 25B. Applications running on mobile devices 2580 operating in accordance with some embodiments of the invention may include, but are not limited to social media wallets 2590. Social media-based wallets 2590 may house references to NFTs presently licensed to the device owner, including (but not limited to), NFTs for cards 2591, music 2592, podcasts 2593, video 2594, novels 2595, scripts 2596, documents 2597, and advertisements 2598. Applications may include, but are not limited to search capabilities 2582. Applications may include the capacity to share and/or link information 2584 with other applications, users, family members, colleagues, and/or organizations. Systems in accordance with numerous embodiments of the invention may allow the sharing and/or linking of any number of NFTs in the NFT media wallet 2590.

Several embodiments of the invention may incorporate trading mechanisms associated with users of social networks. In such cases, users can purchase tokens, otherwise gain access to tokens, and/or enable associated users to gain at least partial access to the tokens. users may indicate, for tokens, whether the token may be for sale, and what the price is. The users may specify reserve prices and/or request sale offers. In accordance with various embodiments When users make sale offers exceeding reserve prices, transactions may be auto-initiated. In some cases, bidding users may be constrained in terms of how often they may place offers for given items.

Token auction implementations utilized by systems operating in accordance with numerous embodiments of the invention may enable users to auction tokens with reserve prices and/or predetermined time delays between bids. Systems may enable users to place one or more tokens up for auction. Systems may allow users to set reserve prices (e.g., $100) and/or pre-determined time delays (e.g., 24 hours). When bids exceed reserve prices, NFTs may be sold and transferred. When bids do not, predetermined time delays may begin, wherein no bids may be allowed for a time period and/or no bids from the bidder under the reserve are allowed for a time period. In accordance with several embodiments, predetermined time delays may impact all potential bidders and/or a subset of bidders. After the predetermined time delay, users may submit new bids. In accordance with some embodiments, previous bidders that do not have pending bids for tokens may receive reminders when a certain amount of time may be left before the received bid(s) are evaluated. Reminders may include (but are not limited to) emails, SMS, push notifications sent to apps, etc. In accordance with several embodiments, systems may enable users to opt-in and/or opt-out of reminders.

For example, Alice may specify the reserve price for an NFT at $500, and indicate that each bidder may be only allowed to place one offer per 24 h period for the token. Alice may further specify that her system can only receive and consider one offer per 1 h period. That way, should Bob place an offer for $400, he can be automatically rejected since the offer is below the reserve price. Further, the system may prevent Bob from asking his friend Cindy to try to place an offer for $401 right afterward Bob receives the rejection of his offer, since that second bid can only be considered after one hour.

Systems in accordance with some embodiments may include a timer showing the duration until the next offer can be considered. Should multiple offers be received during the time preceding the next offer period, then they may all be considered after the waiting period has expired. In such cases, the highest bidder may be selected when their bid exceeds the reserve price.

The above constraints, for systems operating in accordance with certain embodiments, may be governed by policies that can be selected and/or created by users. Additionally or alternatively, some portions of the policies may be publicly viewable. For example, Alice's inventory of tokens may indicate that token A has a reserve and that only the next bid can be considered in 7 minutes and 22 seconds.

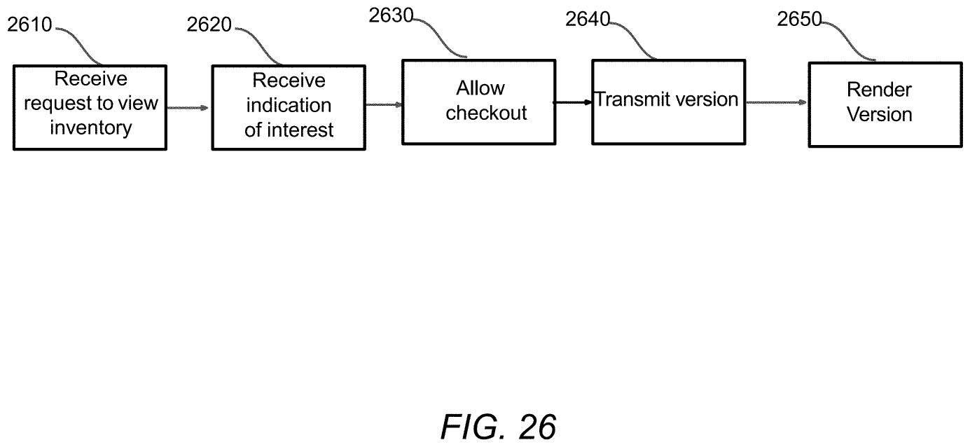

A check-out process for systems operating in accordance with several embodiments of the invention is illustrated in FIG. 26. Process 2600 receives (2610) users (e.g., Bob) request to view the inventory related to one or more additional users (e.g., Alice). Process 2600 receives (2620) an indication from the users of interest in tokens in the inventory of an additional user. In accordance with some embodiments, indications may take multiple forms including (but not limited to), clicking on and/or hovering over a representation of the token (e.g., icon). Process 2600 determines (2630) that a check-out may be allowed. Determinations may be based on, but are not limited to the policies of the token originator (e.g., artist) and the policies of the current owner (e.g., Alice). Determinations may depend on the qualifications and achievements of users. For example, process 2600 may consider whether Bob may be a member of a group that enables check-outs of tokens of this type and/or classification. Process 2600 may depend on the users' computational environments. For example, process 2600 may assess whether Bob has a certificate indicating that his computational environment satisfies some requirements, such as having a trusted execution environment (TEE) from a given vendor, of at least a given version, etc. Process 2600 transmits (2640), a version of the token in which the users have indicated an interest. In accordance with several embodiments, transmitted versions may be, but are not limited to, degraded versions of tokens (e.g., lower resolution), tokens with additional DRM rules (e.g., in the form of a wrapper that uses encryption), and/or using constructions involving derived and/or meta-tokens. Upon receipt by the user, process 2600 renders (2650) the transmitted token. Rendering may include but may be not limited to playing the content on a loudspeaker, displaying it on a screen, using it as input to a game, etc. In accordance with many embodiments of the invention, check-outs may be temporary and access to the version transmitted may be limited. For example, access to the transmitted token may be limited to one day, one rendering, etc. Users may also be limited to additional constraints including (but not limited to) a certain maximum number of check-outs per week. After the version received by the users may be no longer renderable, process 2600 may erase the version from the user's device and provide a notification confirming erasure to the inventory management entities of the one or more additional users.

Tokens in platforms operating in accordance with a number of embodiments can be acted upon in various forms. Tokens may be, but are not limited to being can be rented, purchased, borrowed, checked out, and viewed (in full or in part). Additional actions that can be performed relative to tokens are disclosed herein. The control over what actions can be performed on a given token may depend on policies and the identity, membership and/or inventory of users wishing to perform the action.

In accordance with certain embodiments, the management of policies may be done in secure computational environments. Secure computational environments may be implemented using environments including (but not limited to) trusted execution environments (TEE), digital rights management (DRM) software units, and/or server-managed software units that control what actions are allowed. Such server-managed software units can be operated by social media entities including (but not limited to) Facebook™ and/or LinkedIn™.

In accordance with various embodiments, discounts may be given to one or more select users. Discounts may differ depending on the types of different users. Alternatively or additionally, discounts may be algorithmically generated and/or generated at random from acceptable ranges (e.g., a range from 1% to 19% discount). The discounts may be provided by sellers, and/or by systems operating in accordance with several embodiments. Systems may select when to provide discounts at points including (but not limited to), random times, at the start of bidding for particular items, during particular events/promotions, and/or times when revenue is likely. Content creators (e.g., artists), may sponsor one or more discounts to start bidding. Advertisers may pay for discounts to be given in response to the right to display one or more advertisements to some or all bidders, and/or to learn demographic information about who bids. Discounts may not be determining factors for winners but may be used to stimulate the bidding and create excitement. For example, discounts may be offered to users who have made at least three bids on tokens, who have recently purchased related token(s), and/or who have recently made bids related to token(s). Some discounts may be provided to social media influencers to stimulate bidding activity. In accordance with many embodiments, other additional constraints, governed by policies, can be used to shape transactions, stimulate transactions and/or create awareness of tokens.

Furthermore, accessing users can access inventories, and/or parts thereof, of tokens in the possession of users they connect, and make offers to gain access to one or more of the tokens owned by the connected users. Here, access may take various forms including (but not limited to) limited use, including (but not limited to) only for one usage; partial use, including (but not limited to) only a low-resolution version; borrowed use, providing full access for a particular duration; and/or the purchase of the token. Offers may be monetary, and/or may involve the access by the first users to tokens in the inventories of the second user.

Tokens may be stored in wallets associated with users, including (but not limited to) users with ownership rights to the tokens. User wallets may also store, but are not limited to borrowed tokens and tokens that users check out from other users. The wallets may be stored on, but are not limited to user devices, including (but not limited to) phones; in secure storage environments including (but not limited to) one that may be protected against tampering; devices that may be encrypted; and/or devices for which contents may be authenticated. Wallet information may also be backed up in one or more locations including (but not limited to) on a laptop owned by the users of the wallet, on a controlled-access cloud server, on a protected storage server; on an application associated with a social media company; and/or another wallet access application.

Intermediaries can process token information that may be being transmitted between users accounts. Examples of such intermediaries may include (but are not limited to) social media servers, cloud servers, Internet infrastructure nodes and consumer routers. Such intermediaries can generate logs related to token information that may be requested, transmitted, sold, lended, etc., Logs may be anonymized to not disclose from whom and/or to whom information may be transferred. The logs can be used to, but are not limited to, identify popular content, determine that there may be a risk for fraud, determine that a price for an item may increase based on many purchase requests, and more. The logs can be collected by third parties and sold to organizations wishing to determine what products may be most popular, wishing to advertise their products, wishing to determine the demographic fit between products and consumers, and more.

Systems operating in accordance with many embodiments of the invention may include recommendation mechanisms that identify tokens associated with accessing users that may be likely to be of interest to other users. Additionally or alternatively, the systems may provide the second users with indications of the identified tokens. This may be done without identifying the owner of the identified tokens. Each token can be described using predicates, including (but not limited to) stating the type of token including (but not limited to) a game and/or a visual art piece; the originator of the token; a classification of the originator (e.g., top-1000 music NFT creator); a classification of the token, including (but not limited to) its price category, a genre it may be associated with, including (but not limited to) “rock”, and more. The tokens can also be described using one or more vector values, where a vector value identifies the token by the class of token that it most resembles along an array of dimensions. A collection of tokens accessible by one and the same users can also be described using predicates including (but not limited to) the above-mentioned predicates.

The token inventories of two different users can be compared to generate relative similarity values that may be based, on various attributes. The attributes may include, for example, the vector distance of the two and/or more vector values. Users may also be described by the average vector distance between pairs of tokens (or their contents) in their inventories, to determine a variance value that indicates the breadth of interests of the user. When two inventories are compared, similarity scores may be computed based on their vector distances. Additionally or alternatively, systems may be determine whether there may be overlap (e.g., shared editions of the same NFT), which may be a function of the variance value of each of the associated users. There may be overlap between two inventories from the perspective of one of the users but not the other, due to potentially different variance values of the two users. When there is overlap between Alice's and Bob's inventories with respect to Bob, then Bob may be made aware of Alice's inventories, and/or overlap may be used as input when Bob performs a search for tokens matching his interests, being compatible with his tokens, and/or matching a search query he enters.

Systems operating in accordance with many embodiments of the invention may include search mechanisms that enable accessing users to search for tokens that may be compatible with one or more tokens in their possession. Searches can be limited to users that may be connected to the accessing users within a maximum and/or minimum number of connections (e.g., three shared friends). Searches may be based on, but are not limited to the creator; the asset data file such as a book, artwork, image, and/or music file; metadata associated with the asset and NFTs; descriptions provided by the artists; previous marketplace listings; and social media content related to the NFTs. Such searches may involve AI and natural language processing. Search results like these may be useful for advertising NFT sales, data mining information about users and artists, enabling social media users to locate resources from other social media users, etc.

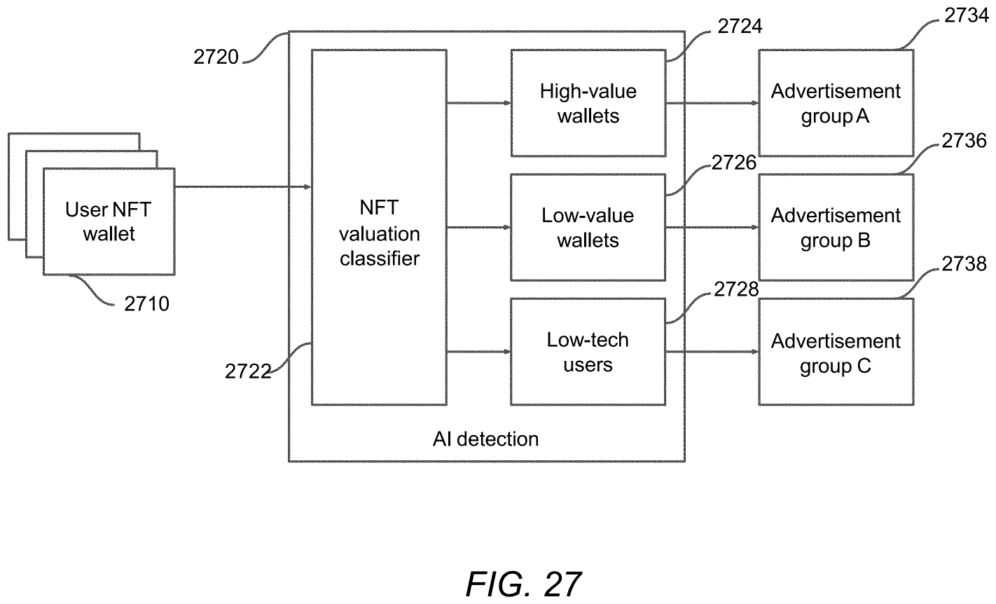

An AI data-mining method operating in accordance with numerous embodiments of the invention is illustrated in FIG. 27. AI data-mining methods may classify users, at least in part, on the value of their wallets token inventories. A portion 2710 and/or the entirety of a social media network may be subjected to AI data-mining systems 2720. In doing so, digital wallets may be classified for one or more characteristics, including (but not limited to) overall wallets value, through NFT valuation classifiers 2722. Example classifications may include (but are not limited to) high-value wallets 2724, low-value wallets 2726, and low-tech users 2728 that have no active wallets inventories. For example, the classification for high-value wallets 2724 may include users with tokens that have values in excess of a particular threshold amount used to indicate wealth (e.g., >$25,000). The classification for low-value wallets 2726 may include users with tokens that have values less than an amount that can indicate wealth, but values exceeding an amount sufficient to indicate tech-savviness (e.g., <$25,000, >$1,000). The classification for low-tech users 2728 may include users without non-fungible tokens, indicating either no wealth, lack of interest in NFTs and NFT wallets technology, and/or lack of understanding of NFTs and NFT wallets technology. Classified groups may receive targeted advertisements, including (but not limited to) group A 2734 for high-value wallets 2724, group B 2736 for low-value wallets 2726, and group C 2738 for low-tech users 2728, respectively. For example, social media platforms operating in accordance with some embodiments of the invention may choose to advertise inexpensive NFTs to tech-savvy users that may be not wealthy. Alternatively or additionally, social media platforms may advertise expensive products of any sort to the wealthy classification group. Alternatively or additionally, the third and final classification might result in advertisements for NFT newbies to entice them into the world of NFTs. In many instances, social media platforms may earn sales commissions on related sales through such advertising initiatives.

Systems operating in accordance with many embodiments of the invention may use artificial intelligence to scan social media networks and profiles and potential interests in connected users' NFTs that may be for sale. These searches may be performed, for example, using rich metadata stored on-chain. System can be used for marketing purposes for more intelligent and successful matches for particular digital assets to given users. Methods in accordance with numerous embodiments may use natural language processing to analyze the textual data stored in both the NFTs, the user profiles, and posts to find a nearest neighbor match ranking list. More advanced systems may analyze the actual media files to make the match. For example, user A uses Instagram to publish photographs of frogs. User B may be selling NFTs and/or animated amphibians that might be of interest to users A. Neither user A and/or user B would need to have any text that describes their love of frogs and/or amphibians.

An AI self-organizing map method may be able to analyze these images to find similarity in social media posted images with data analyzed directly from the NFTs' artworks, as disclosed in U.S. patent application Ser. No. 17/806,728, titled “Systems and Methods for Encrypting and Controlling Access to Encrypted Data Based Upon Immutable Ledgers,” filed Jun. 13, 2022, the disclosure of which is incorporated by reference herein in its entirety. In another example, user A may post music of Indian classical music, and user B might have a new music NFT that has a sitar as the main instrument. Again user A and user B both lack textual data describing their interest in Indian classical music. In this example, the social media recommendation system can analyze the actual music files of user A as well as the music file stored on-chain of the NFTs using self-organizing maps to help create a recommendation for marketing purposes. Such systems can enable NFT owners to locate users who might be interested in their listing(s).

In accordance with certain embodiments of the invention, social media profiles may include inventories of token assets. Not all owned assets may be listed here. Social media account owners may indicate for each asset and/or groups of assets whether they are visible to one or more groups of users. Groups may include (but are not limited to) groups of direct contacts, indirect contacts, groups containing the members Alice and Bob, anybody with a social media account, anybody, etc. Assets unowned by an account owner, but which the account holder has access to may also be visible in profiles. An example of such an asset may be tokens that may be borrowed from another user. The tokens may be visible when the policies of the owner and of the borrower allow them to be seen. Both of these policies may specify what groups of users may see vs. may not see the access to an asset. In some configurations of the system, assets that may be neither owned and/or borrowed but which satisfy another access criteria, including (but not limited to) being rented, may also be shown, conditional on policies associated with the asset making the asset visible to a given viewer. As assets are listed, associated data may also be detailed. Examples of such data include the origin of the asset, the estimated value of the asset, the most recent purchase/lease price of the asset, how much the asset costs to rent and/or gain access to, and whether a particular asset may be compatible with tokens held by the viewer of the inventories. Example assets include tokens including (but not limited to) NFTs.

Some tokens may not be transferable, according to either users selection and/or by token policy. For example, tokens representing membership in an organization would typically not be transferable, e.g., by being sold and/or rented. Such tokens can still be shown as part of inventories. They may be shown conditional on a similar membership and/or triggering action associated with a potential viewer. Some tokens may represent achievements, e.g., reaching level 5 in a game, and/or matching a cat token with another cat token that may be compatible, as disclosed in co-pending application U.S. Provisional Patent Application No. 63/240,953, titled “Evolution of Tokenized Artwork,” filed Sep. 5, 2021, the disclosure of which is incorporated herein by reference in its entirety. Such tokens may also be displayed in the same manner as the inventories may be displayed.

The ability to see assets in inventories may be conditional on the assets of the viewer. For example, Alice may be a member of the Dog Lover's Society, and may possess tokens that identify her as such a member. She may let any of her contacts see a representation of this token, except those who belong to the competing Cat Lover's Society. Alice indicates that such users may not see this membership token. Similarly, Cindy may own tokens representing a magic sword, to be used in a game she plays. She may not want other players of the same game to be able to see that she owns this magic sword, as that may take away the possibility to surprise them in the game. However, she may be willing for them to see that she possesses an artifact of some unidentified type, used in the game associated with the magic sword. Yet another example may be that Dave, who may be a music collector and owns many songs that have been minted as NFTs, does not wish people who do not own NFTs to see his collection of such assets. All of these conditions for being able to see assets can be expressed as rules and policies.

Rules and policies can also be used to specify the extent to which various groups of users may interact with NFTs. For example, one policy may state that anybody in Eve's group of friends, labelled privately by her as “true buddies,” can check out any of her NFTs, to the extent that the associated NFT permits this. The accessibility of associated NFTs may be additionally limited by the originator of the NFTs. Beyond this, however, Eve may let friends use such checked-out NFTs, and indicate that each user in this group may check out exactly one NFT of hers exactly once every day. Here, checking out may refer to a temporary borrowing of the asset for a pre-specified duration (e.g., 30 minutes) and/or rendering. In accordance with certain embodiments, no permission request may need to be approved by the owner (Eve in this case) due to pre-emptive policies on how assets may be accessed by the users of the pre-specified group.

Systems operating in accordance with many embodiments of the invention may include mechanisms to notify users of changes in the inventories of their contacts. For example, as Alice acquires a new NFT artwork, one or more of her contacts may receive a notification, including a message on their timeline and/or comparable message board, that Alice owns the artwork. The notification may include a representation of the token their contact acquired, including (but not limited to) information about the originator/artist of the token, a visual and/or audio representation of the token, information about potential compatibility with tokens held by the recipient of the notification. Also, users may be notified when a contact of theirs has tokens that evolves. Evolution of tokens may be disclosed in co-pending application, U.S. Provisional Patent Application No. 63/240,953, titled “Evolution of Tokenized Artwork,” filed Sep. 5, 2021, the disclosure of which is incorporated herein by reference in its entirety.

Systems operating in accordance with many embodiments of the invention may enable the combined use of identity and alias tokens in social media users' wallets on social media platforms. For example, users may choose to sign-up for their social media account with an identity token created prior to, and/or at the time of sign-up, for the benefit of the user. Other users may choose to include their identity tokens within their social media wallets. Wanting privacy, some users may choose to be known on the social media system by an alias token, optionally associated with a hidden identity token.

Such arrangements may assist social media platforms operating in accordance with a number of embodiments in detecting bots that may be not associated with a true identity. For instance, social media websites may be commonly plagued with automated bot systems that post information that may be deemed as unsolicited advertisements that the platform earns no revenue from. Other bots may serve as unwanted trolls and/or simply a distraction from the intended social environment. Similarly, a desirable bot may itself have tokens describing its bot identity to the social network, while undesirable bots would not. Identity and alias tokens, along with derived tokens, are described in co-pending application U.S. patent application Ser. No. 17/808,264, titled “Systems and Methods for Token Creation and Management,” filed Jun. 22, 2022, the disclosure of which is incorporated by reference herein in its entirety.

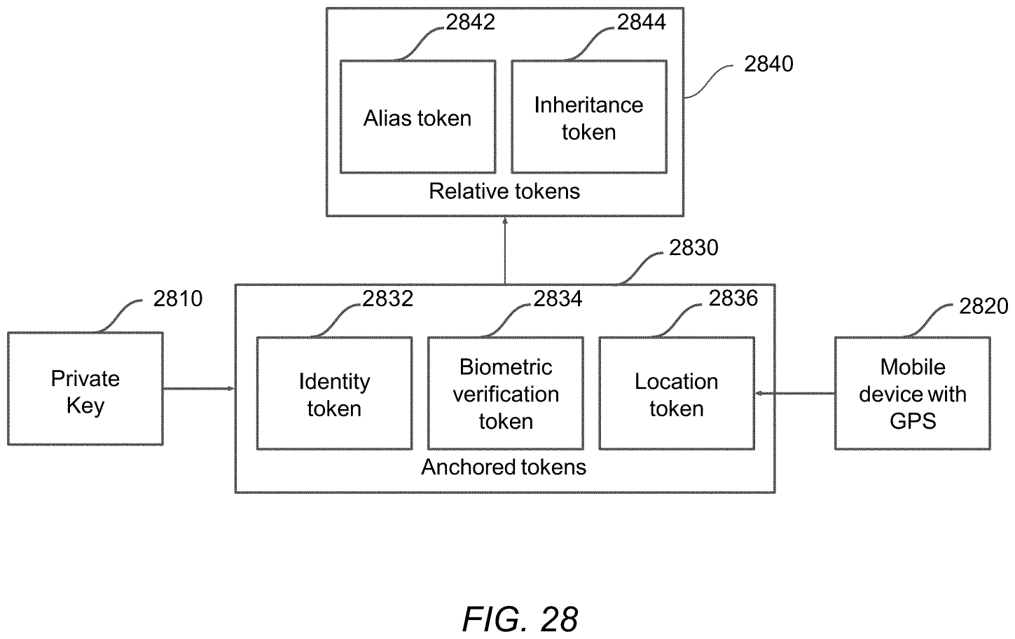

The use of identity and alias tokens alongside platforms operating in accordance with many embodiments of the invention is illustrated in FIG. 28. Identity and alias tokens may be utilized by users to sign-up on the platforms. Platforms including (but not limited to) social media platforms may allow and/or reject attempts to create social media accounts based on whether users may be real people. As such, systems may be configured to reject unwanted automated advertising bots. Social media platforms operating in accordance with some embodiments of the invention may allow users to use their real names and/or aliases. In some instances, social media platforms may identify users utilizing aliases through modes including (but not limited to) directly (e.g., whether the information may be sourced by the users during sign-up) and indirectly (e.g., the linking of two-factor authentication devices like smartphones). Identity and alias tokens may enable users to declare their identities to social media platforms, independently of whether the tokens exist prior to, during, and/or after account creation.

Anchored tokens operating in accordance with certain embodiments of the invention may vary in form. Anchored tokens 2830, including (but not limited to) identity tokens 2832 are described in co-pending application U.S. patent application Ser. No. 17/808,264, titled “Systems and Methods for Token Creation and Management,” filed Jun. 22, 2022, the disclosure of which is incorporated by reference herein in its entirety. Additional anchored tokens may include, but are not limited to biometric verification tokens 2834. Identity tokens 2832 may be associated with public keys and/or biometric verification tokens 2834. Biometric verification tokens 2834 may double as anchored tokens. As such, biometric verification tokens 2834 may tie identifiers (e.g., identity tokens 2832) with associated private keys 2810 to physical beings through biometric records. Biometric verification tokens 2834 operating in accordance with some embodiments of the invention, may incorporate biometric templates for users. A third form of anchored tokens 2830 may include location tokens 2836. When user identities may be confirmed through biometric verification 2834 and/or identity tokens 2832, location tokens 2836 may be used to assert the approximate locations of the user(s). In accordance with several embodiments of the invention, anchored tokens 2830 may be supported by systems of one or more sensors, including (but not limited to) mobile devices with GPS 2820 receivers, capable of determining physical locations.

Systems in accordance with some embodiments of the invention may use relative tokens 2840 to facilitate sign-ups. Relative tokens 2840 may include (but are not limited to) pseudonymous tokens, alias tokens 2842, and/or inheritance tokens 2844. In this example alias tokens 2842 may be able to access location data from location tokens 2836 among the anchored tokens 2830.

Alias tokens 2842 may be used by social media applications to express the locations of particular aliases derived from legitimate identities. Alias tokens 2842 may express such locations without needing to communicate and/or reveal the underlying identities of the individual(s). In one example use, users Alice may be represented by an identity token 2832 that specifies a unique system identifier only used for Alice. The identifier may, for example, be a public key whose corresponding private key can be used to sign identity assertions. In accordance with some embodiments of the invention identity assertions may be used to prove that users (e.g., Alice) agree to some fact and/or request. Identity assertions may take, but are not limited to the form of contract tokens, for example.

Before identity assertions may be generated, systems operating in accordance with a number of embodiments of the invention may verify users' identities. For example, in the above example, a biometric verification token 2834 may indicate that Alice's biometric template may be being matched. In addition, liveness tokens can be used to determine whether biometric verification tokens 2834 are likely to be false (e.g., generated from a recording of Alice). In accordance with some embodiments, liveness tokens can be generated by the same biometric sensor collections that generate the signals corresponding to the biometric verification token(s).

In accordance with many embodiments of the invention, anchored tokens 2830 may be used to facilitate various forms of access in situations where tokens 2830 correspond to assertions that users may be physically present in specified locations. For instance, the assertion may be determined by the verification of her biometrics and the corresponding liveness verification, combined with the location information of the GPS sensor that may be part of the mobile device with GPS 2820. The location may, for example, correspond to a position right outside Alice's home's entrance door. In such cases, systems operating in accordance with certain embodiments of the invention may automatically unlock the door when the door handle may be touched. In another example application, the same technique can be used to unlock the door of an enterprise building where Alice works. In accordance with some embodiments, for purposes of compliance, enterprises and other entities, for which access can be identity-dependent, may require logs of who accesses their facilities. Alternatively or additionally, instead of logging identity tokens 2832, corresponding alias tokens 2842 may be generated and logged to preserve users privacy. In accordance with several embodiments, when a user's biometrics and liveness may be verified, but their location fails to be determined and/or may be determined to be substantially different from system estimates, then systems may determine that the user's location may be not known. In the above example, Alice's door may then remain locked.

Systems operating in accordance with many embodiments of the invention may include logging mechanisms. Logging mechanisms may be used to initiates the generation of one or more logs indicating events that have taken place, including (but not limited to) the evolution of tokens, the occurrence of an event that may influence the triggering of an evolutionary step based on matching at least a portion of a policy associated with evolution, the near-triggering of an event, an event matching a policy exception, etc. The logs may be stored on blockchains and may be, at least in part, encrypted to limit exposure of sensitive information. Applicable tokens can be used to decrypt such ciphertext information. The artwork of one artist may, for example, have access to decryption keys used to access encrypted information. Alternatively or additionally, tokens that may be compatible may have the capability to decrypt, and/or acquire that capability by requesting keys stored with a compatible token.

Some misbehavior may be very complex and not possible to identify by social media platforms using built-on policies. Consider, for example, an intricate circular reselling scheme for tokens aimed at causing the evolution of the token while not losing control of the token by selling it to a non-controlled entity. The detection of this may be very complex. Tokens may, instead of and/or in addition to detection mechanisms that may be in the form of rules and policies, include other information. This information may potentially be in the form of policies that specify the rewards for detecting undesired behavior, along with references to and/or specifications of such undesired behavior. This way, external entities, including (but not limited to) bounty hunters, can be used to patrol and police the behavior of users and their agents. Bounty hunters and associated methods were disclosed, for example, in co-pending applications U.S. patent application Ser. No. 17/817,931, titled “Methods for Securely Adding Data to a Blockchain Using Dynamic Time Quanta and Version Authentication,” filed Aug. 5, 2022, and U.S. patent application Ser. No. 17/808,264, titled “Systems and Methods for Token Creation and Management,” filed Jun. 22, 2022, the disclosures of which are incorporated by reference herein in its entirety.

In accordance with certain embodiments of the invention, NFTs may be minted to represent various artworks including (but not limited to) a song, a movie, a poem, a picture, etc. The ownership of these NFTs may be transferred in various forms e.g., bought, sold, rented, borrowed, checked out, etc. Users may also tag NFTs using any number of tags. Tags may be generated by entities including (but not limited to) content producers, NFT owners, social media personas, and/or users who wish to generate a tag. One tag may be “my favorite movies”. Users can apply such a tag to NFTs that represent their favorite movies, thereby creating derived tokens from the NFTs associated with their favorite movies. The derived NFTs can be displayed on their social media profiles, in their inventories, etc., along with information identifying the meaning of the tag and/or the name of the tag. The derived NFTs, when rendered, may show information including (but not limited to) content related to one or more of the layers associated with the NFTs from which they were derived; reduced-quality versions of the content from which they were derived; a related image; the same content as the original, next to advertisements; etc. Should advertisements be banner ads, for example, every time they may be rendered, the owner of the NFTs from which they were derived may be paid a small amount (e.g., ¼ of the amount that the advertiser paid to have the ad shown).

Alternatively or additionally, click-through ads can result in payments to the owner of the NFTs from which the derived NFT was generated, when users click on the ad. Ads like these may be naturally targeted, as users who tag movies with “my favorite movie” may disclose their preferences, and users who render this derived token NFT are likely to have similar preferences. The ad can therefore promote a movie and/or a game that may be likely to be appreciated by users who like this movie. In one example use case, NFTs might correspond to a given full-length movie. A derived token, of the type described here, may include an image of the main actress, and a snippet of the theme song. It may also include the favorite scene of the users who applied the tag “my favorite movie” to the NFTs associated with the full-length movie.

In accordance with numerous embodiments of the invention, tokens may represent an achievement, including (but not limited to) a professional and/or personal achievement of users. Some examples of such may include (but are not limited to) “Master's Degree from University of Ontario”, “has passed the bar exam in Arizona”, “registered nurse”, “published journalist”, “mom”, “winner of annual Rhode Island badminton tournament”, “honor student at Littleville Elementary”. Tokens may also be derivations of tokens that relate to achievements, e.g., “parent of honor student at Littleville Elementary” and/or “Holder of graduate degree from American University”. These tokens may be transferred in different ways than other tokens described herein. In accordance with several embodiments, the tokens may be minted and awarded by certified entities, be self-generated, be generated by a peer group that agrees the triggering event took place, be derived from other tokens, etc. These tokens, which may be described as badges, may be included in an inventories, and may affect the evolution of other tokens, just as these tokens may evolve based on inputs generated from other tokens and/or external data.

Achievements may be established relative to social media networks operating in accordance with many embodiments of the invention as well. Possible achievements may include (but are not limited to) “new member”, “1,000 followers”, “1M follower influencer”, “influencer”, “journalist”, “valued advertiser”, “government employee”, “social media company employee”, etc. Access to resources, evolution triggers and optional discounts can be generated based on what tokens, including achievement-based tokens like these, are part of a user's profile, e.g., are included in the inventories list of the user. Another example token may indicate that tokens, including (but not limited to) NFTs, that users minted has achieved a particular achievement, including (but not limited to) having been sold for $10,000 and/or being watched by at least a million people; this may be automatically generated independently of whether the token may be still in the possession of the user. Thus, the inventories may not only reflect possessions, but also other characteristics associated with users and/or their creations.

Another token type may refer to a social media post that satisfies some criteria, including (but not limited to) having been viewed by at least a million people, having been liked by at least one hundred thousand people, having been cited by at least 10,000 people, etc. Such tokens may be automatically minted and incorporated in the inventories of users. Users can indicate whether such achievement tokens may be for sale and/or not, and can enable bidding on them.

Tokens can be bought, sold, licensed, conditionally lended, etc., based on policies, based on payments, and based on other transfers and/or granting of access rights. A variety of purchase methods may be possible, including (but not limited to) the auction methods described herein, other auction methods, and other purchase approaches not involving auctions. Such methods can also be used in the context of the acquisition of access rights that may be not purchases, including (but not limited to) the renting and/or checking out of an item.

Systems and processes directed towards token interactions over social media, in accordance with many embodiments of the invention, are not limited to use within NFT platforms. Accordingly, it should be appreciated that applications described herein can be implemented outside the context of NFT platform network architecture and in contexts unrelated to the management of fungible tokens and/or NFTs. Moreover, any of the systems and processes described herein with reference to FIGS. 25A-28 can be utilized within any of the NFTs platforms described above.

D. Social Media Integrations of NFTs

Systems in accordance with a number of embodiments of the invention can provide policy translation mechanisms to users. In accordance with a number of embodiments of the invention, content policies, especially governing access rights, may be entangled when translating content (e.g., NFTs) onto social media platforms. One part of these access rights policies may be the cost of usage of the derived/transferred content for users, including (but not limited to) users of the social media service other than the owners. In many instances, relevance may depend on context.

In some cases, a first item, like an NFT and/or content elements associated with NFTs, may be associated with a first policy, including (but not limited to) an access rights policy or a digital rights management (DRM) policy. A second item may be derived from the first item, and associated with a second policy, where the second policy may be compatible with the first policy. The second item may also, however, be associated with a third and a fourth policy. The third policy may be connected with a rendering context of the second item, including (but not limited to) social media contexts, and may be set by social media service providers. The third policy may, for example, require that a portion of revenue associated with the use of the second item be given to the social media company and/or the entity associated with the context of rendering/use of the second item. The fourth policy may be stated by a party holding access rights to the first item, including (but not limited to) NFTs owner, and may dictate the access right policies of the second item. For example, these policies may govern in the context of social media use.

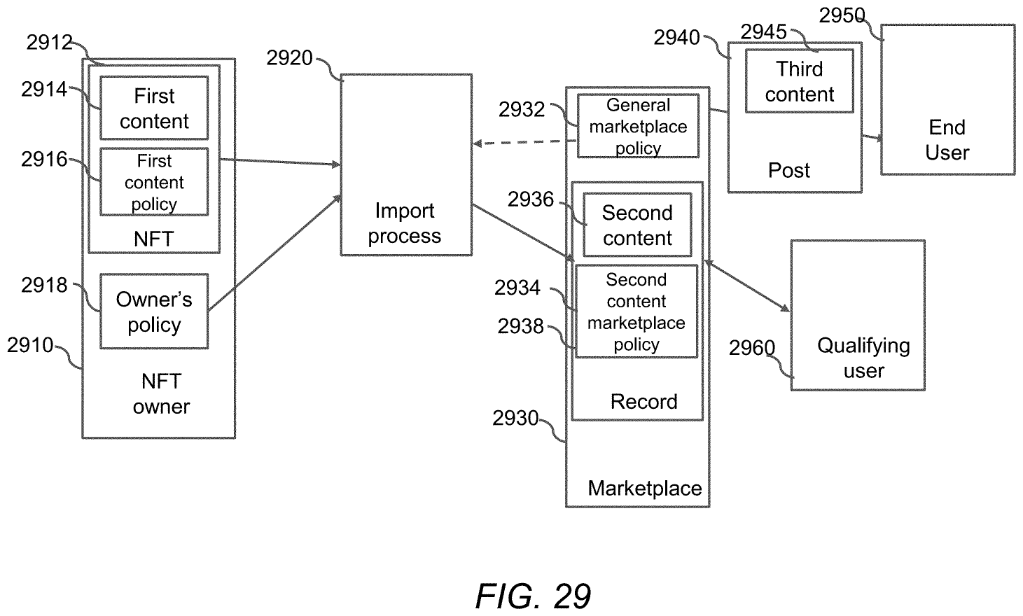

An example of how such systems may affect NFT-related content associated with marketplaces, operating in accordance with various embodiments of the invention, is illustrated in FIG. 29. Import processes 2920 may be used to provide NFTs 2912 and/or parts thereof to marketplaces 2930. Marketplaces 2930 may include (but are not limited to) social media services. NFT owners 2910 with access to the NFTs 2912 a first content 2914 and a first content policy 2916 may use systems operating in accordance with several embodiments of the invention to import the first content 2914 into one or more marketplaces 2930. The first content policy 2916 may govern the use of the NFTs and may be created by the content creator associated with the NFTs 2912. An example first content policy 2916 may state a royalty structure related to the use of first content 2914. Import processes 2920 may be part of the marketplace 2930 and/or be free-standing services (e.g., offered by wallets associated with the NFT owners 2910). Import processes 2920 may provide an owner's policy 2918 which may be selected and/or created by the NFT's owner 2910. The owner's policy 2918 may state the royalty requirements associated with accessing second content 2936 derived from the first content 2914. For example, an owner's policy 2918 may indicate that the NFTs owner should be paid $0.01 every time qualifying users 2960 may be granted access to use the second content 2936.

Marketplaces 2930 may be associated with one or more policies additionally governing the importation of NFTs. Marketplaces 2930 may be associated with a general marketplace policy 2932 that may specify requirements including (but not limited to) royalty requirements, access rights, and any limitations to what content may be allowed in the marketplace 2930. The general marketplace policy 2932 may be provided to and/or known by import processes 2920 operating in accordance with numerous embodiments of the invention. Marketplace policies 2932, 2934 may enable configurations of the first content 2914 to generate associated second content 2936. Modifications of content may be performed through marketplaces 2930.

As a result of imports facilitated by import processes 2920, marketplaces 2930 may store records 2938. Records 2938 may include (but are not limited to) second content 2936 and second content marketplace policies 2934. In accordance with some embodiments of the invention, second content marketplace policies 2934 may include (but are not limited to) references to the first content policy 2916 and owner's policy 2918. Further, second content marketplace policies 2934 may explicitly encode the general marketplace policies 2932. Qualifying users 2960 may gain access rights to the second content 2936, through actions including (but not limited to) satisfying the second content marketplace policies 2934. Marketplaces 2930, through users, including (but not limited to) qualifying users 2960, may generate (at least in part) posts 2940 for social media. In accordance with several embodiments of the invention, posts 2940 may include third content 2945 that may be equal to and/or derived from the second content 2936. The posts 2940 may be accessed by end users 2950, and the third content 2945 may be rendered on devices associated with end users 2950. Access to and rendering of third content 2945 may be conditional on end users 2950 satisfying requirements for being allowed to access third content 2945. Requirements for end users 2950 may depend on, but are not limited to the age, location, and accepted terms of service associated with end users 2950.

In accordance with various embodiments of the invention, content may take various forms. For one, the content associated with an item may not be publicly accessible in plaintext. Instead, it may be in forms, including (but not limited to) on a blockchain, in an encrypted format, and/or not publicly available at all. In accordance with some embodiments, systems may associate access control measures with content. For example, systems may require that a browser requesting the content has an access right. Such access rights may be expressed by having an HTML cookie and/or digital signature associated with having been granted access to the content. However, content may also be publicly available, but not selectable (as a meme and/or a sticker for example) within the context of a social networking application.

Public availability may be impacted due to restrictions placed by social networking applications. The restrictions may be placed on audio-visual content including (but not limited to) content that the social network does not have rights to, has not vetted as being safe, has not determined ownership rights of, may not receive a royalty for, etc. Restrictions can be placed on audio-visual content as a rule, and then exceptions made. Such instances may correspond to a whitelisting approach. Alternatively or additionally, a blacklisting approach can be used, through which content may be a priori possible to include in social messaging posts, except if it has been blacklisted. As a third alternative, there may be some types of material that may be governed by the whitelisting approach for some purposes (including (but not limited to) providing emoji-based reactions to content) while other content may be governed by the blacklisting approach for other purposes, (including (but not limited to) inclusion in the form of a user-selected URL in a message).

The use of systems operating in accordance with a number of embodiments of the invention to translate items and policies over networks may enable the newly imported items to have modified restrictions. For instance a second (i.e., derived) item may to be accessible using the whitelisting approach while the first (i.e., original) item may only have been available in the context of the blacklisting approach. One way to express this may be by the inclusion of the derived item in user interfaces. An example may be sticker selection interfaces, where the derived item may be an image, a movie, an audio file, and/or an executable script. Inclusion into the sticker selection interface may be conditional on the second policy being satisfied for a given user. For example, users who have acquired the right to transmit the second item explicitly, in the form of a sticker may do so in outgoing posts. Users without this right may forward posts with such stickers, conditional on being allowed by the second policy. However, they may not have the right to edit the forwarded post, and/or only the right to edit it using an append-only write policy. The second policy may include requirements for logging of use, where such usage statistics (i.e., logs) may be conveyed to the owner of the first item from which the second item was derived.

Parties with access rights to the content associated with the original item may be considered the content owner in some circumstances. In particular, the party may be considered the content own if they have the right to control, at least in part, the access right policies of other parties with respect to the first item and/or any derived content, including (but not limited to) the second item. Content owners may set policies, corresponding to the owner's policy. Example policies may dictate that the 1000 first users who qualify may have access rights to the content of the second item for free. Additionally, the next 10,000 users who qualify may have access rights to the content of the second item only by paying a fee, e.g., of $0.10. Any other users may need to pay $1 to have access rights to the content. Users in the first group, (i.e., the 1000 users who are given the content for free) may qualify if they have at least 5000 followers. Users in the second group, (i.e., the 10,000 users who pay $0.10) may qualify if they have indicated that they like content from the creator of the content of the first item, from which the second item was derived. The qualification criteria may change over time. For example, users in the group of 1000 users may need to post one or more messages reached by at least one million users, containing the second content, within the last 30 days in order to keep qualifying to have access rights to the second content. Users that cease to qualify may have their rights revert to a pool of unclaimed access rights, from which different users who has not had access rights to the second content may claim access, given that they qualify.

The second policy may include a third and a fourth policy, wherein the third policy may be also referred to as the marketplace policy and the fourth policy may be also referred to as the owner policy. The marketplace policy may specify rules specified by the marketplace, including (but not limited to) the social media company where the content of the second item may be used. Such rules may specify, but are not limited to the type of content that may be allowed; the manner in which content may be used; the manner in which different types of content can be combined (e.g., in one post and/or used as a sticker); and the manner in which the marketplace may be compensated. One example rule identifying how the marketplace may be compensated may be that there may be a 10% royalty, wherein this applies to all revenue derived from the content of the second item. One example rule of how content may be combined may specify that content from some first content creators may not be combined with content from some second content creators that may be not part of a list approved by the first content creators, wherein combination may mean a derivative work, an overlay of one with the other, and/or the concurrent use in one social media post.

The owner's policy may be for the content owner to specify how content may be being used in the context of the social media setting or other application corresponding to the marketplace. For example, this may state, but is not limited to how many people may use the content, whether there may be a per-use charge and/or a per-user charge, and whether there are rules specifying what qualifies users to have access to the content. Owner's policies may specify who may use content, whether it may be forwarded, and whom it may be visible to. For example, one policy may state that content may be only visible to users who satisfy one or more conditions, including (but not limited to) having usage scores that establish that they are humans and not bots, require some minimum level of activity, and/or require some type of activity to be allowed to gain access to content. Here, there may be different qualifying rules for using the content. Example may include (but are not limited to) by originating a post and/or message containing it; by forwarding a post containing it; and/or rendering the content.

The second (or derived) policy may combine with aspects of the first policy. The combination may be specified by a content creator, with the marketplace, and/or with the owner's policy. Accordingly, the second policy may state how the content may be used, as limited by the rules associated with the first, marketplace and owner's policies. The second policy may also state, but is not limited to what payments, if any, are required for various uses; and how royalties for such payments may be divided among participants associated with or specified in the first, marketplace, and owner's policies. The second item may be controlled using access controls and encryption. Access controls, as well as associated policies, may be determined to be in compliance by wallets, by a social media application, and/or by an approved application, including (but not limited to) a DRM-enhanced browser, a certified application, etc.

The marketplace policy may, in some embodiments, be part of a record that also references and/or includes but is not limited to the second item, the first policy which may be associated with the content creator, and the content owner policy. However, in some implementations, the marketplace policy may apply to all records of content items uploaded to the marketplace by their associated owners. In such cases, the marketplace policy may not need to be explicitly associated with the uploaded content. In such instances, when there may be only a small number of selectable marketplace licenses that can be applied to some uploaded content, the marketplace may store the marketplace policy through forms including (but not limited to) data, executable code, in an app, and/or a backend server executable. Some portion of the marketplace license may also be stored as data. For example, the license may be stored in a database including entries associated with content, where such entries may be also indicating one or more policy elements associated with the marketplace.

The content derived from content associated with NFTs (i.e., second content) may be associated with various types of polies. These policies may include (but are not limited to) a royalty component indicating the terms of usage; and an access control element identifying what users may use the content derived from the NFTs content. Here, multiple uses may be identified and associated with access rights. One usage type may be to include the derived content in a message. Another use may be to generate a message not including the derived content, but where the message may be associated with a thread of messages in which the derived content may be a part. Another example use may be to render the derived content on a personal device, including (but not limited to) the display of a phone. Yet another example use may be to render the derived content on a shared device, including (but not limited to) a loudspeaker or screen of a mall. An example access control may associate different such rights with different users and users with different roles. An example role may be that of users that have paid a royalty of a specified size, e.g., one that matches the required payment for a given usage type. A service provider, including (but not limited to) a social media service or a media publication service, may store content and policies in a secure database.

An example secure database may be one that controls access to the service provider, and to which access information may be securely logged. The associated logs can be used to determine royalty payments. Secure logs may, for example, be authenticated and/or encrypted. Log entries can also be secured by being stored in the secure database. The secure database may log access to any privileged operation, including (but not limited to) the access to a log entry, access to a data element associated with sensitive data including (but not limited to) royalty payment data. Logs can be tamper-proofed, which means that they may not be partially rewritten by hostile processes without this tampering being detectable; one such technique was disclosed in “Server-side detection of malware infection” by Markus Jakobsson and Ari Juels, incorporated herein by reference.

Secure logs can be generated in multiple ways. Ways to secure logs may include (but are not limited to) encrypting entries or parts thereof, authenticating entries or parts thereof, using access control to limit the ability to write logs, and/or enabling auditing of what parties perform append-only writes of audit log entries. One way to authenticate entries or parts thereof may include the use of a forward-secure authentication scheme, which can protect against modification of historical log entries, as disclosed in “Server-side detection of malware infection” by Markus Jakobsson and Ari Juels, incorporated herein by reference.

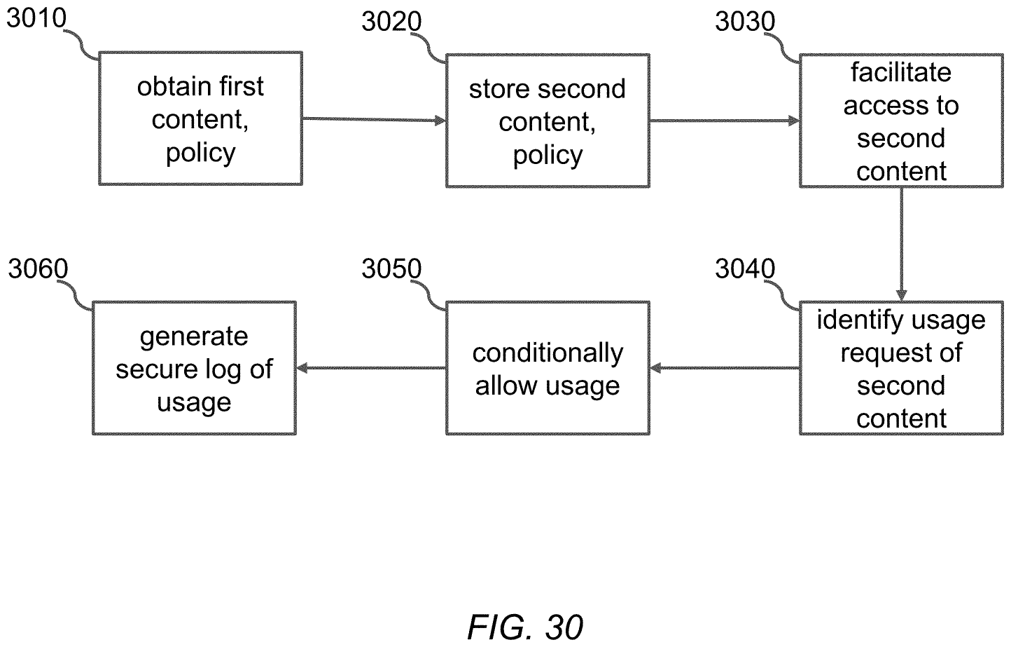

The derivation and usage of content in accordance with certain embodiments of the invention is illustrated in FIG. 30. Process 3000 may be performed by service providers, including (but not limited to) social media services. Process 3000 obtains (3010) access to a first content element and associated policies. Process 3000 stores (3020) a second content and associated policies. In accordance with numerous embodiments of the invention the second content may be derived from the first content and/or be identical to the first content. The second content may be a variation of the first content including (but not limited to) portions of the first content and/or enhanced versions of the first content. The policies associated with the second content may include (but are not limited to) a second policy that may be derived at least in part from the policy associated with the first content, a policy provided by and/or associated with the owner of the first content, and a policy associated with the service provider. Process 3000 facilitates (3030), access to the second content. Process 3000 may facilitate (3030) access by enabling an entity (e.g., Users other than the owner of the first content) to include the second content in messages the entity generates. In accordance with numerous embodiments, facilitating (3030) access may require the entity to satisfy requirements including (but not limited to) matching profiles, performing required actions, and/or making payments specified with the second policy. Process 3000 identifies (3040) a request to use the second content. The request may come from the entity and/or by a recipient of a message sent by the entity, where the message includes data that may be based, at least in part, on the second content. Process 3000 conditionally allows (3050), the usage of the second content, based on events that may include but may be not limited to the second policy being satisfied. The second policy may state an access control rule, for example, which can verified to be satisfied prior allowing the usage of the second content. Process 3000 generates (3060) and stores a secure log entry, wherein the secure log entry describes at least one aspect of the usage of the second content. Aspects may include (but are not limited to) the context of usage, the entity using it, the manner in which the second content may be used, and/or data associated with the generation and/or auditing of royalty payments associated with the usage of the second content.

Users may upload the content of NFTs on their favorite social media platform, and generate a second content from the first content. The first content may be a 20s long movie, and the second content may be a single-frame snapshot from this movie, an excerpt of the movie, or the entire movie. The users may then enable one or more recipient users to access and use the content, e.g., by offering it for free or at a charge. Access may be facilitated using the platform where the content was uploaded and/or using other means. These users with access to the second content may now include the second content in media posts they make (e.g., as memes or stickers) and recipients of such messages can render the second content and request being allowed to use the content by including it in posts they create. This may require these recipient users to satisfy one or more requirements, including making a payment.

Users may also bid on first content. For example, users may bid to buy the NFTs from which the second content was derived. This can be done using the social media platform, through modes including (but not limited to) a graphical user interface (GUI) and/or by the interested buyer obtaining ownership data. The aforementioned ownership data may be encoded in and/or with the second content, generating a purchase offer to be presented to the owner of the NFTs. Should the owner of NFTs agree to sell the NFTs from which the second content was derived, based on the terms associated with the content, buyers may take over all future royalty payments associated with the use of the second content. Additionally or alternatively, sellers may receive royalty payment from users who agree to use the second content after the acquisition of the NFTs by the buyer.

Systems and techniques directed towards integrating NFTs into social media platforms, in accordance with many embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 29-30 can be utilized within any of the NFT platforms described above.

E. Obtaining Token Feedback

Systems in accordance with some embodiments may enable automated and semi-automated content curation based on various configurations. Prospective configurations may include (but are not limited to) one or more selected objectives, one or more target groups, and data associated with the one or more target groups, such as trend data, preference data, and data indicating the typical response to content by members of the group based on content classifications. Content may include but is not limited to text content, such as announcements, travel essays, blog entries, short stories, and portions of a movie script; video content, such as what a vlogger may produce; and music that originators compose and/or performs. Other examples of content may include visual elements, narrative elements, political messages, audio content, executable content such as what a game may comprise, and/or combinations of such content elements.

Systems and methods operating in accordance with a number of embodiments of the invention may be applied to help small entities, such as mom-and-pop businesses, create content in manners that currently may be commonly only possible for large companies and/or at substantial cost and effort. Such systems may streamline content creation efforts effort; reduce the costs of performing modifications (and/or verifying that none are needed); and increase the speed of production, whether fully automated, semi-automated and/or outsourced.

In accordance with some embodiments, content creators may provide and/or generate input elements corresponding to one or more content elements. In the current disclosure, content originators and content curator may be referred to as content creators for denotational simplicity. The content creators may have provided and/or selected configurations including objectives for various input elements. Example objectives may include: “be cool”, “be persuasive”, “be professional”, “be authoritative”, etc. Based on these objectives, systems operating in accordance with various embodiments may generate feedback to the content creators. In accordance with several embodiments, feedback may be applied automatically. Feedback may additionally or alternatively be provided to the content creators in the form of one or more versions of the input content. For instance, feedback may be in the form of a new rendition of an audio input to which a subtle drum solo has been added in the background, and/or a set of several versions of such renditions. Content creators may be provided with identifications associated with the types of edits that were made. For example, a new version may include a notification stating “the length of the video was reduced by 5.7 seconds”. Content creators may be provided with options to inspect such edits (e.g., an option that says “show me the portions that were cut”).

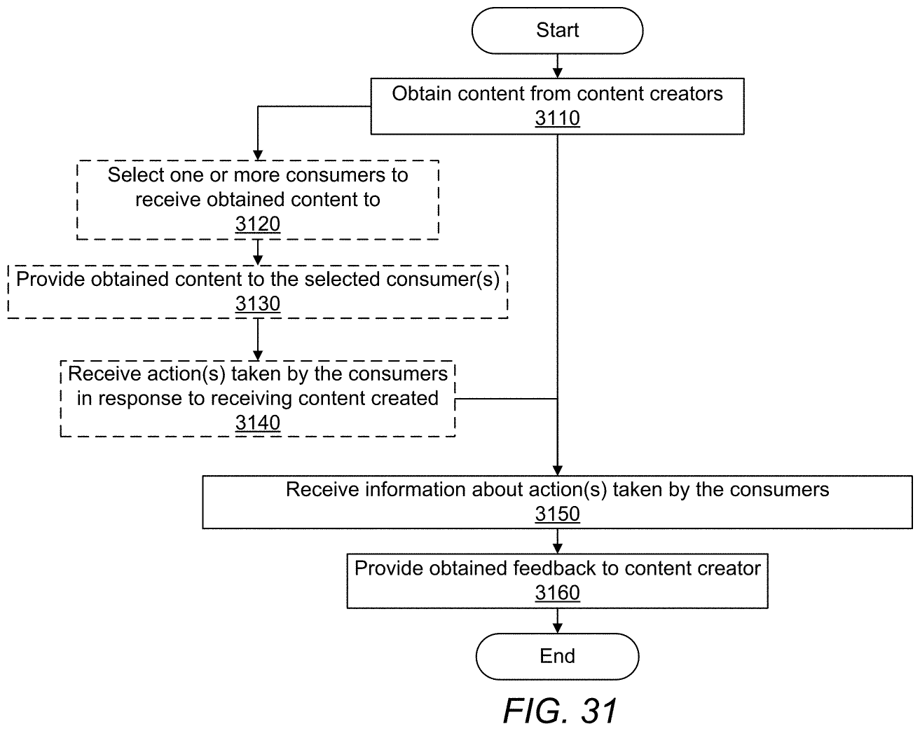

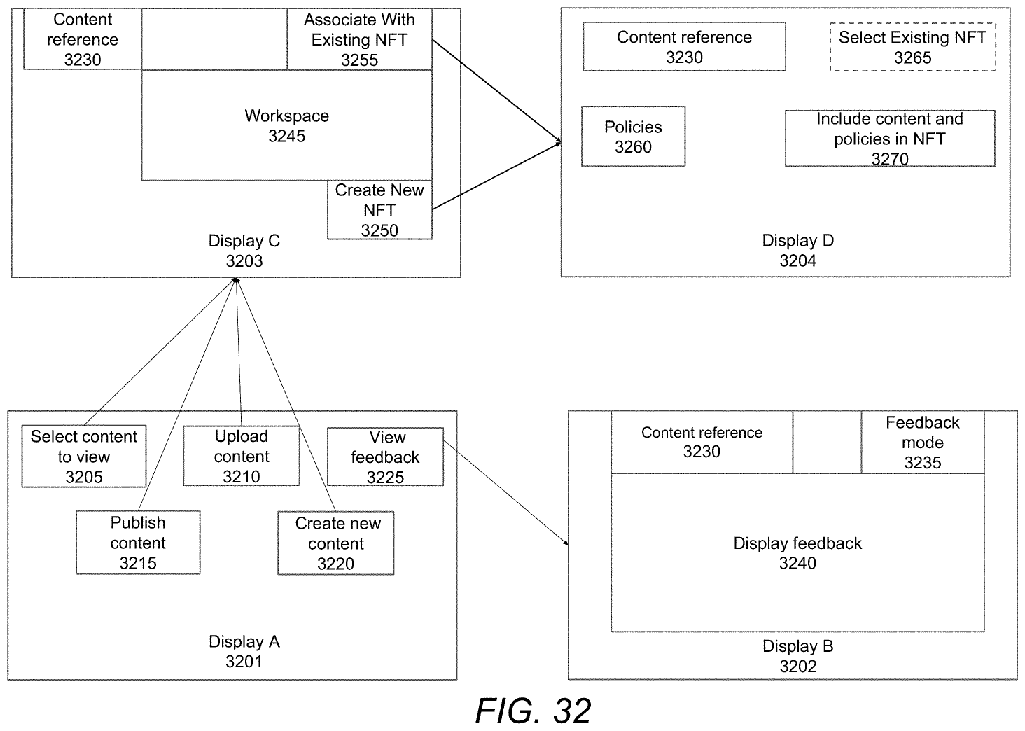

A flowchart conceptually illustrating a method for providing feedback to a content creators, in accordance with many embodiments of the invention, is illustrated in FIG. 31. Process 3100 obtains (3110) content from one or more content creators. Process 3100 receives (3150) information and/or data about action(s) taken by the consumers in response to receiving the content of the content creators. Process 3100 may receive the information, thereby obtaining feedback for the content, through modes including (but not limited to) machine learning and artificial intelligence.

In accordance with some embodiments of the invention, feedback to content creators may come at least in part from machine learning models trained on data from target groups. Feedback may come in multiple additional forms beyond direct feedback from people in target groups. In some cases, feedback data can come from actions by people on social media, including (but not limited to) the contents of highly-shared posts by people matching certain desired demographics. For instance, clustering algorithms may be applied to cluster color palettes used in visual content by “popular” Instagram™ consumers in the past month. Systems operating in accordance with some embodiments of the invention may use clustering algorithms to recommend trending color palettes to content creators. Additionally or alternatively, music information retrieval and machine listening techniques may be applied to analyze the background music in trending TikTok™ videos. Systems operating in accordance with several embodiments of the invention may use such techniques to inform content creators of the music used in more popular videos. For instance, systems may indicate that “popular” videos are currently using music that may be free of vocals, have tempos of between 120-160 beats per minute, and feature strong rhythm tracks.

Additionally or alternatively, models trained on other content creators' content could be used to provide recommendations and/or ranking among several alternative works by a content creators. For instance, systems operating in accordance with some embodiments may use neural network models trained to predict the number of shares to produce feedback. Example feedback may include “your Video B may be likely to produce more shares than your Video A and/or Video C, based on its editing style.”

Systems in accordance with some examples may incorporate multiple prospective recommendation systems. Models could be used to recommend and/or execute automatic edits to users' content. For instance, systems may incorporate transformer large language models with fine-tuning and/or few-shot learning on text content produced by one or more target groups. Systems may use such models to produce multiple candidate “translations” of content creators' original text into text that may be better received by target groups. Reception-based changes may be made by factors including (but not limited to) word choice, spelling, punctuation, emoji usage, etc. Additionally or alternatively, such models could be used to retrieve recommendations for content additions. For instance, systems assessing a song may use machine-learning-driven analysis of traits including (but not limited to) musical genre, rhythm, mood, and instrumentation to recommend music backing tracks (e.g., a video from a royalty-free music collection). Such recommendations may, in numerous embodiments, be based on similarity to music in recently trending videos.

Data for training models can, in several embodiments, come from social media and other publicly available sources including (but not limited to) text, graphic designs, and videos shared by conventional media organizations. In some instances, training data can also come from crowd-sourcing and/or focus group activities conducted with target groups, including (but not limited to) data collected from activities initially conducted to serve other content creators. For instance, systems may use data collected from a listening activity in which target consumers provide feedback on multiple versions of a creator's audio track. Such cases can be stored to help train future models of listener preference. The model in that example could be employed to provide automatic feedback to different audio creators in the future.

Process 3100 provides (3160) the obtained feedback to the one or more content creators. FIG. 31 also illustrates the option that, alternatively or additionally, process 3100 selects (3120) one or more consumers to provide the obtained content to. Process 3100 optionally provides (3130) providing the obtained content to the selected consumer(s). Systems in accordance with numerous embodiments of the invention may send the obtained content to the one or more consumers automatically and/or in response to user preferences. Process 3100 optionally receives (3140) the action(s) taken by the consumers in response to receiving the content created by the content creators.

The feedback to the content creators may be generated in response to data received from a group of entities representative of the one or more target groups. For example, a first target group may represent users, also referred to as consumers, who are labeled influencers and/or which have some pre-specified trait related to cultural awareness. A second target group may represent consumers who are considered politically correct, resulting in one or more sets of feedback, which may be combined by the system to the extent that they are not contradictory. In accordance with numerous embodiments, contradictory indications may be labeled for content creators to resolve. Resolution attempts may include (but are not limited to) selecting proposed options, modifying content and obtaining new feedback, and/or by keeping the version(s) associated with the input content element(s). Such attempts may be performed on given aspects of input content, where multiple aspects may be provided feedback that may be selected and/or used for other edits by the content creators.

In accordance with certain embodiments, target groups may be determined by automated analysis of actions associated with collections of content consumers. Such actions may include (but are not limited to) interactions with content, memberships in groups and organizations, interaction between content creators and/or consumers, social connections between consumers, and more. Interactions with content may include (but are not limited to) purchases, recommendations, likes, dislikes, comments, shares, retweets, content references, forwards of content, markups of content, and responses to surveys.

Some consumers may be aware of being part of a target group. For example, a consumer may have explicitly applied for a membership associated with the group and/or otherwise have been asked to offer their views on one or more subjects. Such consumers may be associated with demographic information provided with (and/or on behalf of) the consumers and/or content creators, which may be used by systems to select the consumers. For example, when content creators want the view a specific demographic (e.g., college-educated women in their forties), the group membership may be determined at least in part based on demographic information associated with consumers who have opted into the system and provided and/or allowed the use of their demographic information.

Some consumers may not be aware of being part of a target group. Such target groups may include consumers posting content on TikTok™, users that retweet a selected political message on Twitter™, users who generate a Facebook™ post including profanities, etc. In some instances, group membership may be obtained from the associated organizations, whereas in other instances, it may be obtained through other means, e.g., public references to such content, where one example source of public references may be an online newspaper.

User group membership may be determined by digital wallet-related information including (but not limited to) the actions of the consumers, the contents of their wallets, and/or by other information accessible from user wallets of consumers. Additionally or alternatively, digital wallets may determine user profiles based on access to content and/or identify one or more groups associated with users' observed behavior. In accordance with many embodiments, membership data may be conveyed by wallets to service providers associated with the determination of target groups. Conveying membership data may be done without conveying any of the data underlying the determination of group membership, such as the exact contents of a given wallet and/or the exact browsing behavior of a user. Group membership may be conveyed in privacy-preserving manners, analogously to how requests may be conveyed in U.S. Provisional Patent Application No. 63/275,713, titled “User-Specific Evolution, Spawning and Peeling,” filed Nov. 4, 2021; U.S. Provisional Patent Application No. 63/270,386, titled “Secure Sharing of Token Assets,” filed Oct. 21, 2021; and U.S. Provisional Patent Application No. 63/270,092, titled “Protection Against Token-Based Malicious Scripts,” filed Oct. 21, 2021, the disclosures of which are incorporated by reference herein in their entireties.

For systems operating in accordance with some embodiments, feedback may be generated from data associated with one or more target groups. Feedback may, in some cases, be obtained without submitting any part of the input content to the target groups. For example, a profile of popular consumers can be created, systems may determine what emojis are trending up in this group, and the relevant uses of emojis are determined. Such determinations can, for example, be based on the content to which expressed emojis are related. In some cases, systems may create machine learning (ML) models identifying specific actions (e.g., the use of emojis) in groups of popular consumers, in order to provide feedback to the content creators. Alternatively or additionally, models can be created associated with groups that may be considered the opposite of the target group. In contrast to the above example, systems may assess a group of unpopular consumers and/or unsuccessful content creators. Such models can be used to determine whether any portion of the content of the content creators may be associated with behavior that may be expressed by the opposite group. Based on feedback associated with selected groups, feedback may be generated and provided to the content creators.

In accordance with several embodiments, feedback may be generated based on reactions of members of target groups provided at least portions and/or versions of the input content. For example, two content versions can be distributed to two groups of consumers selected from a target group by randomly assigning a content version to each member of the target group, and sending the selected version to each selected member. A member may be able to observe the content received through modes including (but not limited to) rendering on his and/or her screen, viewing in a pair of augmented reality (AR) glasses, listening to the content on a loudspeaker and/or a headset, etc. Users may interact with the content through ways including (but not limited to) playing the content up to a maximum number of times (e.g., 100); interrupting the playing of content; providing comments and/or ratings of the content; clicking like buttons, etc.

Based on what consumers receiving one content version do, scores may be created for each content version. Alternatively or additionally, comparisons may be made between content versions. In accordance with several embodiments, scores may include three dimensions: a first dimension identifying how many consumers played the content at least ten times; a second dimension identifying how many consumers played the content in its entirety at least once; and a third dimension identifying the average rating given by the consumers, e.g., 4.3 stars on average. Two content versions may be compared based on the scores (e.g., along the three dimensions described above) and assessments may be made of what content may be preferred. Some consumers may identify their reasons for a score, such as “I loved the drum solo”, “this sounds monotonous”, “the colors were unpleasant”, etc. Reasons can be shared by selecting one or more options, and/or by free-text entry for which responses are parsed and automatically categorized based on keywords, such as “loved”, “hate”, “good”, “drum solo”, etc. AI and related techniques can be used to identify common feedback expressed in slightly different ways. For instance, pre-trained sentiment analysis models can be applied to distinguish between responses which are positive and negative. Alternatively or additionally, topic modeling techniques such as latent Dirichlet allocation and latent semantic analysis can be applied to identify themes within the positive and negative responses. Common feedback can then be presented to the content creators along with scores.

Content providers may request feedback in real-time, where user interfaces update as consumers provide feedback and perform actions. For example, some user interfaces may allow consumers to indicate how many likes they assign to a content version, interrupt the playback, indicate that they particularly liked one segment by pressing the “I like this part” button as the content may be played, etc. Systems operating in accordance with many embodiments may increase the number of consumers receiving the material until the content creators indicate. Feedback may be halted for example by using a button click, that indicates the provider does not need more feedback.

An example user interface to receive NFT feedback in accordance with certain embodiments of the invention, represented by the form of multiple possible display screens, is illustrated in FIG. 32. Content creators may utilize user interfaces to receive feedback from collections of reviewers of content belonging to target groups. user interfaces may be implemented in devices, including (but not limited to) smartphones, laptops, stationary computers, etc. Display A 3201 illustrates an example of a screen that may provide several options to users in the form of buttons and/or checkboxes. One option given by content selection buttons 3205 may enable users to select content to view. Content selection buttons 3205 may allow users to choose content through modes including (but not limited to) scroll lists, sub-screens, checkboxes, and new pages. Content selection buttons 3205 may allow users to choose content that already has been published, has been sent to consumers, and/or has received feedback. For user interfaces operating in accordance with numerous embodiments of the invention, content may be associated with identifiers including (but not limited to) reference numbers and titles.

User interfaces operating in accordance with several embodiments of the invention may allow users to select other actions. For example, upload content buttons 3210 may be used by users upon creating new content elements. Upload content buttons 3210 may be used to send content elements to users, upload content onto social media sites, and/or independently publish content. Another option may be “request feedback” buttons 3215. Users may select request feedback buttons 3215 after identifying content that has been and/or will be published. Request feedback buttons 3215 may result in content being marked and/or identified as actively requesting feedback. user interfaces may incorporate new content buttons 3220, which may direct users to screens (i.e., display C 3203) facilitating the creation of new content.

User interfaces may, Additionally or alternatively, incorporate view feedback buttons 3225. View feedback buttons 3225 may allow users to select and/or identify particular content, for which reviews can be displayed. In some examples, feedback may be displayed on independent screens and/or windows (i.e., display B 3202). In many instances, displays 3201, 3202, 3203, 3204 may exhibit the identity 3230 (e.g., identifier) of content being reviewed and/or altered. Additionally or alternatively, screens 3201 operating in accordance with numerous embodiments of the invention may provide options regarding how feedback can be exhibited. Feedback mode buttons 3235 and/or boxes may allow users to select different modes (e.g., scroll lists) through which feedback can be exhibited. Feedback may be exhibited in modes including (but not limited to) graphs, staples in different colors, animation, text, etc. Once users select feedback modes, the feedback can be illustrated accordingly in display areas 3240 of the screen 3202.

User interfaces in accordance with certain embodiments of the invention may enable users to mint NFTs based on content, update NFTs, review content, and/or associate NFTs with content. For example, users may review content including (but not limited to) new content 3220 that may be recently created, content that may be newly uploaded 3210, content for which users are requesting feedback 3215, and content that has been selected 3205 by users. In accordance with a number of embodiments, after selecting any of these buttons 3205, 3210, 3215, 3220, users may be directed to a screen (e.g., display C 3203) including workspaces 3245 to work on and/or review the content. On those screens 3203, user interfaces may implement options to associate 3255 the content with existing NFTs by clicking a button, box and/or icon. user interfaces may implement options allowing users to mint/create 3250 new NFTs from the content by clicking a button, box and/or icon. In accordance with some embodiments, users may mint derived NFTs based on content that are themselves NFTs.

Users, upon choosing to associate 3255 content with existing NFTs and/or create 3250 new NFTs, may be forwarded to another display (e.g., display d 3204) for minting NFTs. Users may be able to choose options to upload and/or select one or more policies 3260 to be associated with the content of the soon-to-be-minted NFT. In such screens, the relevant content may, again, be identified 3230. Users may, Additionally or alternatively, fetch and/or select 3265 existing NFTs to associate the new content with. For example, an existing NFT may be a biometric NFT that includes biometric data (e.g., fingerprint data) and can be utilized by users to prove their identities. New content may be associated with such a biometric NFT as a way of asserting access control rights, where the access control may be related to policies for the evolution of the content that may be uploaded and/or generated. Alternatively or additionally, new content may describe possible changes to the existing NFT, for example, and may indicate a possible evolution state for the NFT (e.g., with an art piece). Once users complete their intended changes, user interfaces may allow users to mint/update 3270 the NFT, in order to associate the new content and/or the new policies with the NFT before uploading, sending, and/or publishing it.

In example of a use case, Kirsten may want to publish content on a (social) media platform, it could be lyrics to a new and/or old song, a debate article in an online newspaper, an instruction video for maintaining a specific hairdo requiring different actions depending on type of hair which are inherently different. In the content, Kristen may want to refer to different people of different ethnicities, having specific features, having a certain (health) conditions (e.g., Down's syndrome, sexual orientation and/or anything that might be sensitive to the people to whom Kirsten refers). Kirsten may not be aware of what words and expressions that might be sensitive. Kirsten creates her content that she wants to publish, e.g., she types in text and/or uploads a video to a service provider. Kirsten may access this service provider by means of an app on her smartphone or via a web page using her laptop. Kristen may use the system functionality to create new content.

Kristen may then want to ascertain that her content may be politically correct before she actually goes ahead and publishes her content. This may cause a new screen and/or window to pop up where Kirsten may identify what type of feedback she wants to get. This has been exemplified above in various ways. In this illustrative example, Kirsten may type in and/or select that she wants feedback as to the political correctness of the text in her content. Subsequently, the request together with her desired type of content may be sent to the service provider.

Depending on how the method described herein may be implemented, and depending on the request, several actions may be taken by the service provider. One example may be that the service provider (e.g., one or more network nodes of the service provider) processes the obtained content from Kirsten, by means of one or more of, a machine learning system and an artificial intelligence system, thereby obtaining feedback for the content. The feedback in this example may list all words and/or formulations that are identified as possibly offensive and to give examples of alternative words and/or formulations that are considered to be politically correct. The feedback may be then provided to Kirsten. In another example, the service provider (e.g., one or more network nodes of the service provider) can select one or more consumers to provide Kirsten's content to. They may then provide Kirsten's content to the selected consumer(s).

The selected consumer(s) may then e.g., react to the content by identifying words and/or expressions that they find offensive and suggest alternative wordings and/or expressions. These actions are referred to as feedback. Once they are done, the selected consumer(s) may then send and/or provide their feedback to the service provider, which thus receives the feedback from the consumer(s). The service provider may then process the received feedback (which may also be referred to information and/or data about action(s) taken by the consumers in response to receiving the content of the content creator). Then the service provider may provide the feedback to Kirsten. In this manner, Kristen may then update her content according to the received feedback and publish it on her intended media platform. It may be pointed out that Kirsten may also associate her (original or) updated content that may be to be published on the intended media platform with an NFT before publishing. Associating content with NFT may entail arranging the content to be included in the NFT.

Target groups determined by systems operating in accordance with many embodiments of the invention may vary in form. Some target groups may include (but are not limited to) consumers attracted by given content creators (e.g., members of the creator's fanclub); consumers who do not belong to the content creator's target group, but were recruited by the system and were asked to participate; consumers having rated content from other content creators (e.g., one specified by the content creators, as producing content with a rating of at least 4 stars being given by the consumers), etc. In accordance with some embodiments, target groups may be selected using machine-learning-based approaches. Target groups may then be determined as including consumers who are not members of the creator's fan club but who appear in the same cluster(s) as members of the fan club as produced by a clustering algorithm that uses particular consumer features, for instance related to taste, demographics, engagement patterns, etc.

Content creators may have one or more windows in which they receive feedback on content from consumers belonging to these different target groups. Labels in the window may identify the demographics of each such group, e.g., “fans”, “teenage girls”, “pop lovers”, etc. Consumers may in some cases may be incentivized to provide feedback in forms including (but not limited to) being paid, being able to listen to pre-release versions, being allowed to buy NFTs of the content they reviewed, etc.

In one example, a content creator may write a job application and request feedback from a target group including hiring managers in the media industry. Consumers may provide suggestions such as “provide more details about your band”, “please include a snippet of a song”, “it does not say whether you are willing to relocate, please be clear about this”, etc. The creator may modify the application based on this feedback. The members of this target group may wish to participate because they can indicate an interest in the job applicant, and therefore get early access to highly skilled workers.

In accordance with many embodiments, consumers who provide feedback may be classified and/or identified. For example, consumers who correctly identify trends that are about to become noticeable can be considered “trend aware”, “trendsetters”, and/or “cool”. In some cases, target groups may be identified using quantitative criteria which may be made explicit and even tunable in user interfaces. For instance, “cool” may be defined for specific content creators as social media users located in North America, using primarily English, who at least three times in the past month has shared content that had fewer than 5000 previous shares at the time of sharing but later went on to have over 500,000 shares. In other cases, such target groups can be defined implicitly, by content creators, and/or by people maintaining and configuring the content style feedback system. In such cases, identification may be performed by hand-selecting a number of prototypical target consumers and automatically identifying other content creators who are similar using particular criteria. Similar social media followers may be identified through features including (but not limited to) their geographic region, the type of text and media content as assessed using natural language processing and/or multimedia analysis techniques, their number of social media followers and engagement patterns, etc.

In accordance with some embodiments, the content created by the content creators may include advertisements. Advertisements may include, but are not limited to ads merchandise (e.g., a product like make-up for men, home security such as burglar alarms), service, and/or human actions (e.g., the ice bucket challenge) that may trend on social media. Systems may indicate particular creators as consumers who promote similar products and/or human behavior to the content.

Alternatively or additionally, network nodes of systems operating in accordance with some embodiments may analyze created content and select consumers to which the content should be provided and/or presented. This can be done by using machine learning and/or AI. For example, in case of a burglar alarm, the network node and/or associated system may identify consumers including (but not limited to) those who have recently browsed for burglar alarms, those having frequently read news articles on house break-ins and/or robbery, consumers living in certain areas where house break-ins may be rather frequent, consumers within a specific income range and/or any combination. Such consumers may be likely to want to actually buy and install a home security alarm.

Systems operating in accordance with a number of embodiments (and/or network nodes) may select consumers through reviews of their wallets. Such reviews may include (but are not limited to) the browsing history and other personal profile information of wallet owners.

The determination of how well prospective advertisements perform with target groups can be based on explicit and/or implicit feedback. Implicit feedback may include the observation of their actions. Such consumers may be “normal” consumers known and/or believed to belong to given demographic groups. Demographic determinations may be based on past behavior and/or explicit statements of their demographics. Implicit feedback may also come from consumers who have opted in to be studied, wherein metrics may be collected from the consumers' browsers, wallets, and/or other system components. In such scenarios, reviews may be used to determine user responses to material, such as advertisements. The same type of device and/or application configurations can be used for other purposes. Studied consumers, in accordance with many embodiments, may be provided a benefit in return for being part of the target group. One such example benefit may be a 10% discount of products and/or services that such consumers buy for themselves.

In the case of the example of human actions, the network nodes and/or systems may identify influencers and/or persons who have participated in such actions before. For example, parties who performed the ice bucket challenge for charity, for media exposure, etc. may be identified. Such consumers may be considered likely to also perform the human actions associated with created content in order to make it spread and trend on social media. In such cases, network nodes and/or systems may provide content creators with feedback on the created content. As indicated above, feedback may come in forms including (but not limited to) the number of clicks on a link provided in the created content. In the earlier example, where the created content is an ad for home security, the relevant clicks of the link may direct consumers to a homepage on the internet of a home security alarm provider. Other examples of feedback may include (but are not limited to) the number of retweets, number of reposts, the number of times file uploads, etc. on a social media platform in which people perform the human action illustrated in the created content.

Methods performed in accordance with some embodiments of the invention may be performed by nodes, network nodes and/or systems for providing feedback to content creators. Nodes and/or network nodes may refer to one single physical node and/or several nodes. Thus in some examples, the method may be performed by several nodes in a distributed fashion. Hereinafter they may be just referred to generally as node(s).

Content creators may create content through user devices. The user devices may include, but are not limited to, one or more of a microphone, a speaker, a display, a touch screen, a keyboard/keypad, and/or processing means in the form of memory and a processor. The content creators may provide created content to the node(s) performing the method. The created content may be associated with, and/or include, NFTs. In accordance with some embodiments, nodes may include user devices and/or networks like the Internet.

Once content is received, nodes may determine the consumers to which the content should be provided in different ways. In accordance with numerous embodiments, the content creators may indicate to the nodes the consumers to which the content creators want the content to be provided. Alternatively or additionally, the analyzing and/or processing of the content may include employing machine learning techniques and/or artificial intelligence. For instance, natural language processing techniques could be used to analyze text input content and identify consumers who have recently generated and/or shared similar text content. Similarity may refer to content similar in content and/or language use, for example. Alternatively or additionally, nodes may determine the consumers based on the profiles of the content creators. Nodes may use any number of additional or alternative methods to determine and/or select the consumers to which the content should be provided. Several other examples of how the node may determine and/or select consumers are given above. Additionally or alternatively, the node may process the received content, e.g., by employing machine learning techniques and/or artificial intelligence, to generate feedback information to be provided to the content creators without the use of consumers.

Once the nodes have determined and/or selected the consumers to which the content should be provided, they may provide the content to the determined and/or selected consumers (e.g., as a link to the consumers).

The consumers may thus access the created content and optionally e.g., interact with, modify and/or change the content. Hereinafter, any type of action a consumer takes and/or fails to take when being provided with the content may be referred to as “action”. Example actions may include (but are not limited to) be how many likes they assign to a content version, interrupt the playback, indicate that they particularly liked one segment by pressing the “I like this part” button as the content may be played, etc. The method may also include the node receiving information and/or data about action(s) taken by the consumers with regard to the content. The method may also include providing feedback to the content creators based on the received information and/or data about action(s) taken by the consumers.

In some embodiments, a computer program may implement the relevant process. The computer program may include computer-readable code which, when run in a processing unit included in an arrangement in a network node, causes the node to perform the method as described herein. A processing unit may be included in the arrangement in the network node. For example, the processing unit may be a Digital Signal Processor (DSP). The processing unit may be a single Central Processing Unit, CPU. The processor may include general-purpose microprocessors; instruction set processors and/or related chips sets and/or special-purpose microprocessors such as Application Specific Integrated Circuits, ASICs. The processor may also include board memory for caching purposes. The computer program may be carried by a computer program product connected to the processor. The processing unit may be one or more units and perform different actions of procedures described herein.

The arrangement in the network node may also include an input unit for receiving signals from other entities and arrangements, and an output unit for providing signal(s) to other entities and arrangements. The input unit and the output unit may be arranged as an integrated entity. The input and output units may also include one or more interfaces. Furthermore, the arrangement in the node may include at least one computer program product in the form of a non-volatile memory. In some embodiments, the memory may include an Electrically Erasable Programmable Read-Only Memory (EEPROM), a flash memory and/or a hard drive. In many embodiments, a computer program product including the computer program can be provided. The computer program product may include code, which when executed in the processing unit in the arrangement in the network node causes the network node to perform the actions described herein.

The computer program product may include a computer-readable medium on which the computer program is stored. For example, the computer program product may, but is not limited to, a flash memory, a Random-Access Memory RAM, Read-Only Memory, ROM, and an EEPROM. The computer program modules described above could in alternative embodiments be distributed on different computer program products in the form of memories within the network node.

For example, the computer program product may be a flash memory, a Random-Access Memory RAM, Read-Only Memory, ROM, and/or an EEPROM, and the computer program modules described above could in alternative embodiments be distributed on different computer program products in the form of memories within the node.

Users, including (but not limited to) content creators, reviewers, administrators and consumers, with specific hardware and/or software (e.g., apps) can access systems configured in accordance with some embodiments of the invention. Such systems may be configured specifically to determine their responses to content and enable them to participate, in an effortless manner in being members of target groups used to assess content. For example, in some embodiments, users may have browsers which may be part of and/or connected to their wallet along with extra controls. One such control may be a button in the chrome of the wallet that enables the users to switch on a camera, automatically enabling the browser and/or a plugin associated with it to determine where the users focus on the screen, and determine how long the users observed various portions of the window of the browser. Such functionalities may be considered privacy intrusive for general applications, but may be provided on an opt-in basis to consumers who participate in one or more target groups.

In addition, chrome may provide users with buttons to indicate whether they would be interested in buying advertised products at a discount. Alternatively or additionally the users (i.e., consumers) may be able to share if they think the material may be interesting/thought-provoking/offensive/etc. Multiple consumers can use the same augmented browser and be distinguished from each other in an automated manner, e.g., by facial recognition methods associated with the augmented browser. The browser may also be allowed to access wallet contents to determine what the users (consumer) may be interested in, invests in, how they spend the money, etc. The users opting into this measurement and feedback collection method may obtain benefits, e.g., payments, discounts, the right to purchase products before they are available to others, etc.

Users can at any time turn off the measuring mode, which can disable at least some of the augmented functionality and enables the users to transact in a manner that may be not observed. The users may also configure systems to automatically switch to privacy-preserving mode under some user-specified contexts, e.g., when the users perform online banking to pay bills, if visiting a website that sells medication, etc. This type of browser can also be used by users/consumers who wish to have preference profiles built for them (e.g., to enable better product recommendations).

In accordance with various embodiments, machine learning elements may determine the vocabulary and readability score used by successful influencers associated with one or more products and/or concepts. In such contexts, success may be defined as, but is not limited to, at least a threshold number of views for a relevant post, at least a threshold number of followers, and/or at least a threshold number of conversions for a given post. Conversion types may include (but are not limited to) a sale, an action including (but not limited to) a click for more information, and/or a like, for example. Features like vocabulary may be defined in terms of the individual words, including mis-spellings, and their relative frequency. This frequency and the document readability score can then be compared to the frequency of the same words and readability score in other bodies of text. Applicable bodies of text for content in English may include but is not limited to English language used by the New York Times™ articles, English language used by People Magazine™ articles, and/or English language used by another set of influencers associated with another type of product. This may yield comparative term frequencies for each such word, and/or sequences of words.

Users (e.g., content creators) may wish to provide content that resonates with a given group of consumers, (e.g., as defined by the posts by successful influencers associated with a given product). In such cases, text provided by the content creators can be scored based on its content to determine whether it uses terms that are sufficiently common in this group and whether its readability may be similar to documents in this group. This may correspond to having relative word frequencies that exceed a specified threshold. Words that do not satisfy this criterion may be colored in a different way in a text editor accessible by the user. Words whose frequency may be below a second relative word frequency may be automatically replaced with a synonym that has a higher relative frequency, and/or flagged for users to address. Similarly, sentence lengths can be compared and anomalous sentences produced by the content creators highlighted and/or automatically modified. The content creators may be provided with one or more versions of the text and associated estimates of scores, where the scores indicate the degree of fit with the model built by scanning the corpus of texts. Multiple scores for different user/consumer groups can be provided for each text.

The content creators may select one or more works for additional scrutiny, which may include manual review by one or more target groups including consumers of indicated demographics. Related review techniques can be applied to other types of content, including (but not limited to) photos and/or segments of video. These can be scored through modes including (but not limited to) using machine learning components trained on content associated with selected groups of content.

Alternatively or additionally, content can be modified using automated filters including (but not limited to) scene cutting methods to make a scene shorter, sound effect filters that add and/or enhance audio, color modifiers that change portions of the content to other color ranges (e.g., warmer colors), and/or filters to enhance contrast. These modifications can be done according to models generated by applying machine learning to content associated with the selected groups of consumers. For example. this may include but is not limited to successful advertisers of shoes according to some criterion, successful influencers according to some criterion, and/or organizations of content provision selected by a user, admin and/or content curator/creator. Like in the text-based example above, one or more variants can be generated and compared using manual reviewers, as disclosed in multiple examples in this application.

Based on the feedback (or lack thereof) from the reviewers, the systems (and/or network nodes) may select one or more content versions and present these along with associated scores and comments derived from the manual reviews (from consumers), for the content creators to determine what version(s) to use. Content creators may generate two or more versions of the same content for different audiences (i.e., groups of consumers) this way.

In accordance with some embodiments of the invention, scripts may be used to process content, modify and/or suggest modifications, and optionally perform tests involving one or more groups of users/consumers providing feedback and/or reactions. Some portions of these scripts may be rule-based, and other portions may be based on machine learning elements that are trained based on past observations of users' behavior of consumer(s), including (but not limited to) likes, views, purchases, conversions and ratings. The scripts, and/or parts of them, can be encapsulated and distributed in the form of executable content of NFTs.

NFTs may require being executed at least in part in secure environments. One example of a secure environment may be a device that satisfies some hardware requirements, including (but not limited to) using Address Space Layout Randomization (ASLR), and another example may be an environment with a verified software environment (including (but not limited to) an environment where apps can only be downloaded according to some pre-specified rules, and/or where there may be an approved anti-virus system running). Content can also be encapsulated in digital rights management (DRM) containers, and processed in DRM environments. NFTs may carry DRM-protected material, and wallets may have and/or be associated with DRM-compliant engines, enabling the processing and use of DRM-protected content, including (but not limited to) scripts. Consumers may acquire rights to use content, including script-based content, by subscribing to DRM-based services, purchasing and/or renting NFTs, and/or otherwise license-protected content. Such content may be associated with rules that cause the reporting of use. Reported use may occur for purposes of billing and royalty determination. Content may include, but is not limited to dictionaries of terms and associated usage frequencies for various target groups; scripts for accessing services (including (but not limited to) centralized scripts which may be periodically updated based on newly observed patterns); and manual review services in which users/consumers belonging to selected target groups implicitly and/or explicitly provide feedback on material provided by users.

In accordance with a number of embodiments, Term Frequency Inverse Document Frequency (TFIDF) techniques may be used in combination with techniques including (but not limited to) sentiment analysis, sentence length analysis, and other natural language processing (NLP) and machine learning techniques. These techniques may be used to score inputs that may include (but are not limited to) text, emojis, hyperlinks, images, audio files and videos, NFT references, and functional elements like advertisements. The scoring may trigger actions including (but not limited to) those described elsewhere in this disclosure, including (but not limited to) manual review, feedback to content creators, etc.

Certain embodiments of the invention may include reporting beacons associated with content, causing the reporting of the usage of the content to be generated. The reporting may be provided to the content owner and/or a proxy thereof, and may be in the form of, but not limited to a log, a summary, a recommendation, a comparison with another content element in terms of one or more predicates, where one example predicate may be the conversion rate for a given target group.

Techniques operating in accordance with many embodiments of the invention may be used by content distributors (e.g., nodes) wishing to determine whether content may be optimized for the intended audiences. Such content distributors may be different from the content creators and/or content curators. For example, content distributors may be advertising portals. The goal of such entities may be to optimize some criteria, including (but not limited to) the conversion rate. An example of conversion may be a click-through. Another example may be a purchase resulting from the view of a commercial. The content distributors may engage in, but are not limited to assessing content, generating one or more versions of the content in a manner described herein, and providing such versions to content owners.

Systems and techniques directed towards obtaining NFT feedback through social media platforms, in accordance with some embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 31-32 can be utilized within any of the NFT platforms described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for generating enhanced content comprising:
receiving at least one input;
assessing a history comprising at least one content element, at least one content modification descriptor, and at least one user action descriptor;
determining at least one transformation based on the history;
applying the at least one transformation to the at least one input, resulting in at least one output; and
generating a token, based on the at least one output, wherein the generation is performed by at least one of minting and modification of data associated with the token.

2. The method of claim 1, wherein an input comprises at least one of an image, a video, an audio segment, and a text segment.

3. The method of claim 1, wherein an output comprises at least one of an image, a video, an audio segment, and a text segment.

4. The method of claim 1, wherein one or more transformations is selected from the group consisting of a selection of a content element, an edit of a content element, and a generation of a content element.

5. The method of claim 1, wherein the history is stored as a set of one or more records, wherein a record comprises at least one of a content element, a content modification descriptor, and a user action.

6. The method of claim 5, wherein a content descriptor is generated from a result of computational analysis of one or more inputs.

7. The method of claim 5, wherein a content modification descriptor is a description of a transformation.

8. The method of claim 5, wherein a user action is selected from a group consisting of a like, a dislike, and a use of content.

9. The method of claim 1, wherein the determining is performed, at least in part, by an algorithm selected from the group consisting of an artificial intelligence (AI) algorithm, an optimization algorithm, a reinforcement learning algorithm, and a supervised learning algorithm.

10. The method of claim 6, wherein the computational analysis of the input is a process selected from the group consisting of computer vision, machine listening, and text analysis.

11. The method of claim 1, wherein the transforming is performed at least in part using a process selected from the group consisting of an artificial intelligence (AI) method, a machine learning (ML) method, a generative adversarial network (GAN) method, a Style Transfer method, and a variational autoencoder method.

12. The method of claim 11, wherein the machine learning method is selected from the group consisting of a deep neural network, a transformer, and a convolutional neural network.

13. The method of claim 1, wherein the at least one user action descriptor is determined for the at least one output, based on a user indication.

14. The method of claim 13, wherein the user indication is received using a user interface.

15. The method of claim 1, wherein a user action descriptor is determined based on an action by one or more other users on a social media platform.

16. The method of claim 15, wherein the action is selected from the group consisting of a like, a share, a follow, and a comment.

17. The method of claim 1, wherein the token is a non-fungible token (NFT) comprising at least a portion of an output.

18. The method of claim 5, wherein the record comprises a reference to an NFT.

19. The method of claim 1, wherein at least a portion of the at least one output is conveyed to a social network.

20. The method of claim 19, wherein the conveyance is performed using an application programming interface (API).
